(19) United States
(12) Patent Application Publication
(10) Pub. No.: US 2009/0307224 A1
(43) Pub. Date: Dec. 10, 2009

(54) APPARATUS AND METHOD FOR COMMUNICATING, ACCESSING, ORGANIZING, AND/OR MANAGING, INFORMATION IN A NETWORK ENVIRONMENT

(76) Inventors: Archit A. Amin, Bernardsville, NJ (US); Deepak A. Amin, Bernardsville, NJ (US)

Correspondence Address: KLAUBER & JACKSON, 411 HACKENSACK AVENUE, HACKENSACK, NJ, 07601, US

(21) Appl. No.: 12/483,006

(22) Filed: Jun. 11, 2009

Related U.S. Application Data
(63) Continuation-in-part of application No. 12/269,314, filed on Nov. 12, 2008.
(60) Provisional application No. 60/987,396, filed on Nov. 12, 2007.
(60) Provisional application No. 61/108,542, filed on Oct. 26, 2008.

(51) Int. Cl. G06F 15/16; G06F 17/30

(52) U.S. Cl. 707/9; 709/206; 707/102; 707/E17.032; 707/E17.005

(57) ABSTRACT

A computer-implemented method, including creating a communication record for a task, a project, or a project task, storing the communication record in a database or a memory device, processing a request transmitted from a first user computer or first communication device or processing a request transmitted from a second user computer or second communication device, wherein the request contains a request by a user to access the communication record or information contained in the communication record, or a request by the user to perform an operation or function on or regarding information contained in the communication record, and if the user is an authorized user, providing the user with access to the communication record or to information contained in the communication record, or allowing the user to perform the operation or function on or regarding the information contained in the communication record.

### RELATED APPLICATIONS

This is a continuation-in-part application of co-pending U.S. patent application Ser. No. 12/269,314, filed Nov. 12, 2008 and entitled “APPARATUS AND METHOD FOR COMMUNICATING, ACCESSING, ORGANIZING AND/OR MANAGING, INFORMATION IN A NETWORK ENVIRONMENT”, which in turn, claims the benefit of priority of U.S. Provisional Patent Application Ser. No. 60/987,396, filed Nov. 12, 2007, and entitled “TASK-CENTRIC COMMUNICATIONS SYSTEM”, and U.S. Provisional Patent Application Ser. No. 61/108,542, filed Oct. 26, 2008, and entitled “TASK-CENTRIC COMMUNICATIONS SYSTEMS”. The subject matter and teachings of all of the above recited patent applications are hereby incorporated by reference herein in their entirety.

### FIELD OF THE INVENTION

The present invention pertains to an apparatus and method for communicating, accessing, organizing, and/or managing, information in a network environment and, in particular, to an apparatus and method for communicating, accessing, organizing, and/or managing, information in a network environment which provides for the efficient and effective organization and management of communications and/or messages transmitted between individuals which facilitates enhanced organization, access, and accountability, regarding same.

### BACKGROUND OF THE INVENTION

Individuals and organizations rely on the ability to effectively communicate ideas and/or messages to others in virtually all aspects of everyday life. Forms of communications involving telephone calls, electronic mail (e-mail) messages, instant messaging messages, facsimile (fax) transmissions or messages, and/or other modes of communications, are typically used by individuals and businesses to communicate ideas and/or messages.

One major problem with the above listed, as well as other types of, communication modes lies in the fact that each communication or message is typically a separate and/or an isolated event. Therefore, with the exception of a one-time or a single communication or message, any previous or subsequent communications, messages, or dialog, which depend upon, or which require multiple communications or messages, requires that the sending and/or receiving individuals or entities must organize and/or manage his, her, or its, its own communications or messages in order to accomplish some task or goal which may be the subject of the communications, messages, or dialog.

For example, a dialog between two or more individuals who are attempting to communicate ideas or who are attempting to accomplish a task or goal, based wholly or partly on e-mail messages sent between these individuals, typically requires that each individual be responsible for knowing when messages are sent, the content of the message, and, in some instances, when a response is needed or appropriate.

One need only access his or her e-mail “in-box” to know that he or she can often find a multitude of e-mail messages which have to be sifted through in order to locate a message which may pertain to a particular task or project in which the individual can be involved or interested. In the case of telephone calls, instant messages, and/or fax messages, which messages also are typically isolated occurrences, these messages typically require that the individual be able to mentally connect these messages with other previous or subsequent messages which may pertain to a given task or project.

The present invention overcomes the shortfalls of existing communication platforms and systems by providing an apparatus and method for communicating, accessing, organizing, and/or managing, information in a network environment as described herein.

### SUMMARY OF THE INVENTION

The present invention pertains to an apparatus and method for communicating, accessing, organizing, and/or managing, information in a network environment which overcomes the shortfalls of the prior art.

The present invention can be utilized in order to create, organize, and/or manage, messages which are sent between individuals or organizations by defined tasks or assigned tasks, by projects related to those defined tasks or assigned tasks, by project tasks related to those projects, and/or any other messages or communications. The present invention can be utilized by individuals or by an organization in order to organize and/or manage messages sent by and/or between individuals or organizations so that these messages, and any information contained therein, can be communicated, accessed, organized, and/or managed, by any individual or individuals in an efficient and effective manner.

The present invention provides an effective and efficient means by which a stream of messages can be formed, updated, and/or maintained, which may result from, or which may relate to, a single message between individuals, a defined task or assigned task which can be created to address, or in response to, a message, a stream of messages sent by and/or between individuals which relate to, or result from, the defined task or assigned task, a project or projects which may result from a defined task or an assigned task, and/or a project task or project tasks which may relate to, or which may result from, the project task or project tasks. The present invention can also be utilized to manage any stream or streams of messages which may not be related to any assigned task or defined task, any project, or any project tasks.

By providing an organized system and method by which messages can be organized, updated, and/or managed, the present invention provides an effective and efficient communications system and platform which facilitates enhanced communications between individuals, enhanced communication organization and efficiency, and enhanced accountability among individuals.

The present invention can be utilized by and between any number of users or individuals to communicate and/or to recognize an initial message which can result in a need for a defined task or an assigned task to address a subject of the message. In response to the need for a defined task or an assigned task, a task stream can be created which can be utilized to organize and manage any and/or all subsequent messages which address that task. The initial message can be the basis for creating the defined task or the assigned task. The defined task or assigned task can then be the basis for creating a project which needs to be accomplished in order to perform the defined task or the assigned task, and similarly, the project can, in turn, be the basis for creating one or more project tasks.

Messages which pertain to the defined task or the assigned task, the project or projects related to the defined task or the assigned task, the project task or project tasks, the project talk, and/or the messages, can then be organized into a respective message stream or “stream” which can then be communicated, accessed, organized, and/or managed, by any respective user, individual, or organization, involved in the defined task or assigned task, the project or projects, or the project task or project tasks.

The ability to communicate, access, organize, and/or manage, these respective streams provides for enhanced communication efficiency and facilitates enhanced accountability in managing and performing the respective defined task or the assigned task, the project or projects relating to the defined task or the assigned task, and the project task or project tasks relating to a project.

The present invention can also be utilized in order to allow users and individuals to track messages, defined tasks or assigned tasks, projects, and/or project tasks, more efficiently and effectively.

The present invention can also be utilized in connection with, and/or can be adapted to be utilized in connection with, communicating, accessing, organizing, and/or managing, with electronic mail (e-mail message) messages, instant messaging messages (“instant messages”) and/or any other type or form of electronic messages or communications techniques.

The present invention can be utilized as a communication platform by and between individuals, family members, friends and social communities, as well by businesses and organizations of any size or type.

The apparatus of the present invention can include one or more communications servers or computers, or a set, or any number of sets of, servers or computers. A server can include one or more computers or computer systems and can be equipped to serve as an e-mail server or any other appropriate communications server. The server can also be programmed to perform any and/or all of the functions and functionality described herein as being performed and/or as being provided by the present invention.

A server or computer, or a set of servers or computers, utilized in connection with the present invention, can store any of the data, information, or messages, described herein in any centralized and/or de-centralized manner.

The apparatus can also include any number of user computers or devices, which can be any computer or communication device which can be utilized by a user or an individual to utilize the present invention as described herein. The user computer or device can be a personal computer, a laptop computer, a hand-held computer, a wireless telephone, a cellular telephone, or a personal digital assistant, and/or can be any other wired or wireless computer or communication device.

The present invention can be utilized in connection with any suitable communications network, system, or platform. For example, the present invention can be utilized on or over the Internet and/or the World Wide Web, an Intranet or Intranets, or a combination of the Internet and/or the World Wide Web and an Intranet or Intranets. The communications network or platform can also be, or can include, any local area network or any wide are network, a public switched telephone network, and/or any other suitable communications network and/or wireless communications network.

The present invention can be designed to create and utilize certain defined relationships between and among the various messages, defined tasks or assigned tasks, projects, and project tasks, described herein. Any and/or all communications can begin with a message being sent from one user or individual to one or more other users or individuals. The message can contain text of the message or message subject matter which can be referred to herein as a message detail (also referred to as a “message detail unit” or “MDU”).

The message or MDU derived from the message can be typically the first or initial communication in what may become a stream of messages or MDUs. The sender, the receiver, or any other user or individual who receives the message, can decide whether a defined task or an assigned task should be created as the result of the message or in order to deal with the subject matter of the message. If a defined task or an assigned task is desired to be created then such a defined task or an assigned task is created, and any and/or all information regarding the first or initial message, and the creation of the defined task or the assigned task, will be stored in an appropriate manner. Any new e-mail message can be added to an existing stream as a message data unit or MDU.

A manager or a head can then be assigned to manage or head up the defined task or the assigned task. In the present invention, every defined task or assigned task which is created can be assigned a task manager or a task head. Any user or individual who sends, receives, or views, the first or initial message can determine whether the defined task or the assigned task is to be created.

The present invention can utilize any appropriate hierarchy in order to define relationships between defined tasks or assigned tasks, projects, project tasks, messages, and/or project talk. For example, a first or initial message or MDU can be the most basic information and can be the starting point for any stream created by the present invention. A stream can be created for a task, a project, a project task, a message, and/or project talk. A task, a project, or a project task, can also be created directly from, or as the result of, a message or an MDU.

If a defined task or an assigned task is created, any user or individual who sends, receives, or views, the first or initial message, or who sends, receives, or views, any message creating the defined task or the assigned task, can decide whether a project or projects should be created to accomplish the defined task or the assigned task.

If a project is to be created, then a manager or head will be assigned to manage or oversee the project. In the present invention, it is desirable, though not required, that every project which is created can or should have a project manager or a project head. Any or all information regarding the creation of the project can be stored in any appropriate device or location upon the creation of the project.

Any user or individual, or the project manager or project head, who sends, receives, or views, a message creating the project can decide whether, and which, project tasks are to be created to accomplish the project. If a project is to be created, then a manager or head will then be assigned to manage or oversee the project. If a project task is determined to be created, then such a project task can be created, and any and/or all information regarding the creation of the project task can also be stored in an appropriate device or location. Typically, if a project task is created, then a project task manager or a project task head can be assigned to manage or oversee the project task.

Any and/or all information regarding any messages or replies thereto, which result in the creation of the above referenced messages, defined tasks or assigned tasks, projects, project tasks, and/or project talk, can be stored in any appropriate device or location.

At any time during any communications regarding any defined task or assigned task, any project, any project task, any message, and/or any project talk, a new defined task or assigned task, a new project, and/or a new project task, can, in turn, be created in response to any message or MDU sent by any of the users or individuals involved in any communications or messages regarding the created defined task or assigned task, any project, or any project task, any message, and/or any project talk.

In an enterprise organization, for example, user or individual relationships to other users or individuals can be defined by either a manager-aid relationship, where one party is a manager of the aid, and/or a peer relationship, where parties are only peers to one another. One of the attributes which can be defined when a user or individual is initially introduced into the system is the user relations criteria which can be used to define the relationship between the user or individual and other users or individual whom that user or individual will be working with on a day-to-day basis. Relationships between users or individuals can be defined, re-defined, changed, created, or dissolved, at any time.

In the present invention, all users or individuals need not be on-line at the same time in order to view a message(s) or a message record(s) being viewed by other users or individuals. Rather, a user or individual can access the server at any time and retrieve a message(s) or a message record(s) at any time and from any location via any suitable user computer or device.

The user or individual can view a message or message record for any message, defined task or assigned task, project, and/or project task, described herein in a screen session or sessions via the user computer or device. The user or individual can also view any number of messages or message records for any number of the messages, defined tasks or assigned tasks, projects, project tasks, messages, and/or project talk, described herein, in multiple sessions with the user computer or device.

A stream, which can be a stream for a task, a project, a project task, a message, and/or project talk, can consist of a header and a string or chain of connected message detail units (MDUs) which are associated with that header, in the order of most recent message detail unit (MDU) to earliest message detail unit (MDU).

The present invention can be utilized to create a defined task or an assigned task from a message or an MDU. A defined task or an assigned task can originate from a message or an MDU sent from one user or individual to one or more other users or individuals. A user or individual (“the sending user or individual”) can generate and send an e-mail message to one or more other users or individuals (“the receiving user(s) or individual(s)”). The e-mail message can contain any subject matter. The e-mail message may simply contain a greeting or a message between friends, or it can contain subject matter which may require or need attention, such as, for example, a recognized need to perform a task, such as a work-related task, such as in a business setting.

Any one or more of the sending user or individual or the receiving user(s) or individual(s) can determine whether or not to create a defined task or an assigned task to address the task or, in other words, to convert the subject matter of the message or MDU to a defined task or an assigned task (hereinafter, “the task”). The creation of the task can be performed in any appropriate manner.

Information regarding the e-mail message or MDU, the subject matter of the e-mail message or MDU, the sender of the e-mail message or MDU, the receiver or receivers of the e-mail message or MDU, the text of the e-mail message or MDU, and information regarding whether a task is to be created, can be stored in the respective server through which the e-mail message or MDU is provided.

The server can determine whether or not a task has been created or, to put it in other words, whether the subject matter of the e-mail message or MDU has been converted to a task. The server can also determine that no task was created from the e-mail message or MDU, and the present invention will create a communication record for the e-mail message or MDU and any response or responses thereto. The communication record containing the e-mail message or MDU and any response or responses thereto will then be stored in the server, in a database of or associated with same, and/or in an external database.

If a task is created from the e-mail message or MDU, or that the subject matter of the e-mail message or MDU has been “converted to a task”, the present invention can create a communications record for the task and can create and store any information regarding any task assignment associated with the task. The communication record containing the task or task assignment can then be stored. A task manager or head for the task can be assigned to the task and other information regarding same can also be stored. Information regarding any and/or all users or individuals who are to be involved in performing the task, and the relationship(s) between them, can also be stored in the communications record for the task. Information regarding a goal of the task, a start date, a completion date, and/or a deadline, associated with the task, can also be stored in the communication record for the task.

The present invention can determine, from information obtained from an e-mail message or MDU, from any response(s) thereto, from any other information provided by any appropriate user(s) or individual(s), and/or from any previously defined rule or rules concerning task execution, whether or not any additional assignments are required to execute the task. If it is determined that an additional assignment, or multiple assignments, needs to be performed, then the apparatus can create and store a project record which is created to address the additional assignment or each assignment of the multiple assignments.

Information regarding a project head and any information regarding any and/or all users or individuals who are to be involved in performing the project, and the relationship(s) between them, can also be stored in the communications record for the project. Thereafter, the user(s) or individual(s) assigned to the task will perform his/her/their respective assignment to execute and complete the task. Any e-mail messages or MDUs which are transmitted by, or received by, the user(s) or individual(s) assigned to the task can also be organized together in streams which can also be stored.

The present invention can also be utilized in order to create or establish a messaging platform for a task, which can include the creation of, and the development and/or propagation of, a stream for the task. In such an application, upon a creation of a task, a communication record for the task can be created with information regarding same, including, but not limited to, information regarding the task manager or head, information regarding any and/or all users or individuals who are to be involved in performing the task, and the relationship(s) between them, and/or information regarding a goal of the task, a start date, a completion date, and/or a deadline, associated with the task.

This information can also be stored in the communication record for the task. Any message, messages, or MDUs, associated with the task, such as the message or MDU from which the task was created or the subject matter of same which was “converted to a task”, and any response or responses to same, can also be stored in the communication record for the task. Thereafter, the apparatus of the present invention can also create or initiate the stream for the task or task stream.

As e-mail messages or MDUs are generated and transmitted to, from, or between, any of the users or individuals assigned to the task, the present invention can, for each e-mail message, generate a message detail unit (MDU) corresponding to the e-mail message, and the MDU can be linked to, or inserted into, the stream for the task. An MDU or multiple MDUs can be added to the stream for the task until the task is completed or until the cessation of any e-mail messages or MDUs associated with the task. Each time the stream for a task is updated to include a new MDU, the updated stream can be stored.

Any and/or all streams created by the present invention, including streams for any and/or all defined tasks or assigned tasks, projects, project tasks, project talk, and/or messages, described herein, can be created, updated, and stored, in any appropriate manner.

The present invention can also be utilized to update any stream for any of the tasks, projects, project tasks, project talk, and/or messages, described herein.

The apparatus of the present invention, upon receiving an e-mail message sent from a sending user or individual, and before transmitting the e-mail message to a receiving user(s) or individual(s), can process information regarding the e-mail message and generate an MDU associated with the e-mail message. Thereafter, the stream for the respective defined task or assigned task, project, project task, project talk, and/or message, can be identified and the newly generated MDU can be added thereto.

The resulting updated stream can thereafter be stored and can be available for accessing and viewing by any authorized user or individual.

The present invention can also record any information regarding any message or MDU acknowledgement(s) or non-acknowledgements by any one or more users or individuals indicating that they respectively have either acknowledged or failed to acknowledge receiving an MDU in a stream.

The present invention can also be utilized in order to process e-mail messages, to generate an MDU therefrom, and to update an appropriate stream, for any streams for any of the herein-described defined tasks or assigned tasks, projects, project tasks, project talk, and/or messages.

The present invention can also be utilized in order to provide an efficient and effective means by which to communicate, access, organize, and/or manage, information in a network environment. Any user or individual involved in an enterprise, organization, group, and/or any other relation or association with others, can utilize the present invention to communicate with others, access pertinent information in an organized and efficient manner, organize his or her communications, and/or manage his or her communications and/or interaction with other users or individuals.

Messages, including e-mail messages, and streams which can be task-based, project-based, project task-based, project talk-based, or which can be miscellaneous messages between users or individuals, can be easily accessed, viewed, responded to, and/or otherwise addressed, in a simple an easy manner.

The ease and simplicity provided by the present invention can be utilized to provide for improved and more organized communication efficiencies and effectiveness, while promoting more organized information dissemination and accountability among users and individuals.

The present invention can also be utilized to allow users or individuals to access and act upon messages and information contained therein. A user or individual can access the information provided by the present invention via any suitable user computer or device. Once obtaining access to the apparatus of the present invention, the user or individual can request a particular stream (“stream request”) for any defined task or assigned task, a project, a project task, a message, and/or project talk, which he or she is interested in accessing.

The present invention can process the user's or individual's stream request and transmit the requested stream to the user computer or device. Thereafter, the user or individual can view the stream and decide whether or not he or she desires to add a message in the form of an MDU to the stream. If the user or individual desires to add to or to update the stream, such as when responding to a message or MDU or communicating a new message, the user or individual will generate and transmit a new e-mail message to a recipient or recipients and, thereafter, transmit the new e-mail message to the apparatus of the present invention for processing. The user or individual can, instead of, or in addition to adding a new MDU to the stream, can decide to create a new task from the stream, add a reminder request regarding the task which is the subject to the stream, and/or provide information regarding whether or not the task which is the subject to the stream can be completed.

The present invention can either receive a new e-mail message or determine that the user or individual has exited the stream without adding a new e-mail message. If a new e-mail message is received, then that can be determined to mean that the user or individual desired to add an MDU to the stream.

If a new MDU is to be added to the stream, an appropriate MDU can be generated from and in response to the new e-mail message. The MDU can then be added to the stream so as to update same, and the updated stream can be stored.

The present invention can also provide the user or individual with a screen showing tasks, projects, project tasks, project talk, and/or messages, which need to be viewed and/or responded to by the user or individual.

If it is determined that the user or individual desires to create a new task from the stream, a new task can be so created. If it is determined that a reminder has been requested, a reminder will be provided in accordance with the user's or individual's instructions. If it is determined that a task is expected to be completed, then information regarding same can be stored. Thereafter, the task can be completed or efforts regarding same can conclude unless the subject of the task is revisited.

In the present invention, any e-mail message which can originate from outside an enterprise, company, group, or association, can be sent to, and stored in the e-mail “in-box” of a user or individual. The user or individual can, at any time, access and/or view the externally originated e-mail message(s). The user or individual can also, at any time, incorporate an externally originated e-mail message into an existing stream as an MDU. The user or individual can also create a new defined task or assigned task, a new project, a new project task, or a new message stream, in response to the externally originated e-mail message. The user or individual can also send a copy of any type of e-mail message(s) described herein into two or more streams.

The present invention can also be utilized in order to take notes or minutes during a meeting between users or individuals and can create an assigned task or defined task directly from the notes or minutes. In this manner, the present invention can be used to create defined tasks or assigned tasks from meeting notes or minutes. These tasks can be stand alone tasks or project tasks of a new or existing project.

The present invention can also be utilized in order to provide a user or individual with the ability to access recently visited streams of any type or kind.

A user or individual can also access any and/or all of the streams of, or associated with, any and/or all of the defined tasks or assigned tasks, projects, project tasks, project talk, and/or messages, for which he or she is responsible or involved. The user or individual can also access any and/or all of the streams of or associated with any and/or all of the defined tasks or assigned tasks, projects, project tasks, project talk, and/or messages, for which any aid of the user or individual is responsible or involved.

The present invention can also be utilized in order to allow a user or individual to, at any time, access any and/or all of the streams of or associated with any and/or all of the defined tasks or assigned tasks, projects, project tasks, project talk, and/or messages, in existence in his or her enterprise, company, group, or association. Any user or individual described herein can be assigned any number of e-mail addresses with which to utilize the present invention.

Any user or individual, can also request, and/or be provided with, periodic reminder messages for any of the defined tasks or assigned tasks, projects, project tasks, project talk, and/or messages, described herein. A user or individual can create a reminder message for himself or herself as well as for any other user(s) or individual(s). A reminder message can also be set up to generate an MDU or MDUs which can be inserted into, or otherwise added to, any of the herein-described streams.

The present invention can also be utilized in conjunction with security features which dispense with the need for a network administrator. With regard to messages, tasks, projects, project tasks, and/or project talk, users or individuals may need to have access to other common sharable information. The present invention can be utilized in conjunction with security features which can include utilizing authorized access levels and/or privileges to allow a user or individual to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with the present invention, along with the ability for a user or individual, who has a certain authorized access level, or certain privileges, to be able to control the access levels and/or privileges of others in the enterprise, company, group, or association.

A user or individual having a certain authorization level and/or privileges can also pass along and/or define an authorization level, or a lower level of authorization, or can pass along and/or define his or her privilege rights, or lesser privilege rights, to another user or individual.

Authorization levels and privileges can also include the ability of a user or individual to, in turn, pass along these authorization levels, or a lower authorization level(s), and/or privilege rights, or lesser privilege rights, to another user or individual, with authorization levels and privileges being defined or assigned throughout a communication infrastructure or platform in the enterprise, company, group, or association. In this manner, the need for a centralized network administrator can be dispensed with.

The present invention can be utilized to provide any of the herein-described users or individuals with access to any number of features and functionality. The present invention can provide a user or individual with the ability to access any and/or all of the features and functionality, capable of being provided by the present invention, via a home page which can be accessed via the user computer.

The user or individual can access any features or functionality by interacting with and/or navigating the home page.

Any user(s) or individual(s) described herein as using the present invention can register with, or be registered with any apparatus, server, user computer, or any other device utilized in connection with the present invention. Any user or individual can, for example, be registered using a username and/or a password.

The user or individual can also register with, or can be registered with, a physical or biometric proof of identity which proof of identify can be or can include the user's or individual's thumb print or thumb print information, the user's or individual's eye retinal scan or retinal scan information, and/or any other data or information unique to the user or individual which can be input via an input sensory device. Any of the user computers described herein can be equipped with a thumbprint reader or scanning device, a retinal scanning device, or any other suitable input sensory device for obtaining data or information from, and unique to, the user or individual.

The user or individual can login or log-on to, or sign-on to, any apparatus or device of the present invention such as by entering a username and/or a password and/or the user or individual can enter a unique identifier such as his or her thumbprint, retinal scan, or other personal data or information.

Upon a successful login or log-on, or sign-on, the present invention can process information regarding the user or individual and can gather any needed information regarding privileges information and/or relations information. User or individual privileges information and/or relations information can be stored in, and can be updated, by any authorized person, user, or individual, in any apparatus or device used in connection with the present invention at any time.

The present invention can gather any information necessary or crucial for ascertaining the user's or individual's privileges, ascertaining or setting the user's or individual's community or enterprise, the user's or individual's user-to-user or individual-to-individual relations information, and/or any other data or information corresponding to or regarding the user or individual.

The present invention can also perform a query of current information regarding the user or individual and can ascertain any present cue or cues pertaining to the user or individual. A cue is information regarding the user's or individual's ability to access information from, and use the present invention, and/or instructions or action items which the user or individual may or must follow or address. A cue(s) can also be any one and/or more of indications such as a word(s), number(s), sound(s), highlighted information, blinking information or indications, and/or colors or colored indications which can be used to provide information to the user or individual regarding a subject with which the user or individual needs to address. After being provided with such a cue, the user or individual can choose to address same by following a corresponding route as indicated by the cue.

The information ascertained from or regarding a cue(s) associated with the user or individual can be utilized to provide the user with access to, and with the ability to interface with, certain functionality provided via the homepage of the present invention.

The present invention can provide the user or individual with a homepage which can provide the user or individual with the ability to access any and/or all of the features and functionality provided by the present invention. If there are any cues associated with the user or individual, these cues, or indications or information relating or corresponding thereto, can also be provided to the user or individual on or via the homepage.

The present invention can also determine or ascertain whether or not the user or individual wants to attend to performing any action or actions pertaining to or relating to addressing any cue or cues provided to him or her via the homepage. If it is determined that the user or individual does not want to attend to performing any action or actions pertaining to or relating to addressing any cue or cues provided to him or her, then the user or individual can be provided with the option of whether or not to work on the homepage. The present invention can determine whether or not the user or individual wants to work on the home page and, if it is determined that the user or individual wants to work on the homepage, the user or individual can perform any action or actions on or via the homepage. If it is determined that the user or individual does not want to work on the home page, then the user or individual can log-off or sign-off from the apparatus or device of the present invention.

The user or individual can also desire to perform a specific task or tasks by selecting a specific task or tasks from the homepage that he or she wants to perform or work on. The user or individual can select and access any appropriate menu option or any page or pages related to the selected menu option in order to perform any task or tasks, and perform the desired task or tasks. The present invention can continuously check to see if any cue(s) associated with the user or individual exist or have been created and can provide the user or individual with information regarding any such cue(s). Any of the herein-described cue(s) associated with, or provided to, the user or individual can also be addressed by the user or individual as desired.

The user or individual can navigate about the homepage or any menu option(s) in order to perform any task or tasks and/or to attend to any cue or cues. The present invention can also be utilized to control user or individual access to any of the messages, tasks, projects, project tasks, and/or project talk, and/or files or folders containing or relating to same, which are described herein.

The users or individuals may also need to have access to other common sharable information. The present invention can also be utilized in conjunction with security features which can include utilizing authorized access levels and/or privileges to allow a user or individual to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with the present invention.

The present invention can also provide a user or individual, who has a certain authorized access level, or certain privileges, with the ability to control the access levels and/or privileges of others in the enterprise, company, group, or association. These herein-described security features, and other features or functionality relating thereto, of the present invention can also be referred to herein as “Tagged Authorized Chain Link Privileges” or “TACL”. Further, “Tagged Authorized Chain Link Privileges” or “TACL” can be defined herein to be features, functionality, or privileges, pertaining to a user's or individual's ability to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with present invention, along with the ability of a user or individual, who has a certain authorized access level, or certain privileges, to control the access levels and/or privileges of others in the enterprise, company, group, or association.

A user or individual can access and perform tasks relating to the TACL functionality via the homepage described herein. In this regard, the user or individual can initiate the TACL functionality via the homepage by selecting, for example, a TACL File/Folders option on the homepage.

The user or individual can access or initiate the TACL functionality via the homepage. The present invention can gather any and all information related to a Default Folder or Directory in or for which the user or individual has been assigned privileges and the user or individual can be provided with the TACL File(s)/Folder(s) Main Page on his or her user computer. The user can then perform any TACL related tasks via the TACL File(s)/Folder(s) Main Page. The TACL File(s)/Folder(s) Main Page can list all content of one or more folders on which the user or individual can work or perform a task or an operation. The user or individual can perform any desired task(s) or operation(s) involving any file(s) or folder(s) via the TACL File(s)/Folder(s) Main Page.

The TACL File(s)/Folder(s) Main Page can provide the user or individual with access to numerous features and functionality of the present invention. For example, the TACL File(s)/Folder(s) Main Page can be linked to, and can provide the user or individual with access to, a TACL Folders Page, a Folder Navigation Page, an Upload Local Files Page, a Share Privileges Page, a Modify Chain Link Page, a Download TACL File Page, an Object Stream Page, an Objects Shortcut Page, a Files Remove Page, a Lock/Reserve Files Page, a Release/Unreserve Files Page, a Tag Count Security Page, or an Administrative Privileges Page.

The TACL Folders Page can be used by the user or individual to create, rename, or delete, a TACL folder or TACL folders. The Folder Navigation Page can be used by the user or individual to navigate to different TACL folders. The Upload Local Files Page can be used by the user or individual to upload a local file or files to a TACL folder or TACL folders. The Share Privileges Page can be used by the user or individual to give, grant, or set, privileges to other users or individuals depending upon the user's or individual's own privileges. The Modify Chain Link Page can be used by the user or individual to modify a privilege or privileges further down a chain link from where the user's or individual's privileges start to link. The Download TACL File Page can be used by the user or individual to download a file or files from a TACL folder or TACL folders to a private area or any other area specified by the user or individual.

The Object Stream Page can be used by the user or individual to communicate with other users or individuals who are using the object's stream. The Objects Shortcut Page can be used by the user or individual to create a shortcut to a selected file or files. A shortcut is a link which can allow a user or individual to navigate to a folder or file more quickly and easily. The Files Remove Page can be used by the user or individual to remove a file or files from any privileged TACL folder or folders.

The Lock/Reserve Files Page can be used by the user or individual to lock a file or files from modification or deletion. The Release/Unreserve Files Page can be used by the user or individual to release reserved objects. The Tag Count Security Page can be used by the user or individual to place, and have a greater amount of security on, a file or files or on a folder or folders by marking an object or objects to be accessible only through an approval of more than one users or individuals. Lastly, the Administrative Privileges Page can be used by an administrator to modify a chain of rights between a user or users and an object or objects.

Upon a selection by a user or individual to work with the TACL Folders functionality from the TACL File(s)/Folder(s) Main Page, the present invention can gather any and all information relating to the user or individual regarding existing privileges the user or individual has regarding any existing TACL folders and provide a TACL Folders Main Page to the user computer. The user or individual can then select to either exit from the TACL Folders Main Page or to create, rename, or delete, a folder. If the user or individual has selected to create a new folder, a new TACL folder can be created, the user or individual can assign a name to the TACL folder, and information regarding a new chain link associating the user or individual with the newly created TACL folder, indicating that the user or individual is the start of the chain for the TACL folder, can be stored.

The user or individual can also select to delete a TACL folder and, assuming that the user or individual is authorized to do so, the present invention will delete the TACL folder and any chain link information related to the TACL folder. The user of individual can also select to rename a TACL folder and the present invention can process information for renaming the TACL folder. The user or individual can also select to bring back or re-activate a previously deleted TACL folder and the present invention can bring back or re-activate the previously deleted TACL folder.

The Folder Navigation functionality enables a user or individual to navigate from folder to folder. A user or individual can be assigned or granted the appropriate and proper privileges to perform any of the folder navigation tasks provided by the present invention. The user or individual, selecting to work with the Folder Navigation functionality from the TACL File(s)/Folder(s) Main Page, can select to navigate from the folder in which he or she is working to another folder which he or she specifies. The user or individual can navigate from one folder to another folder within a current folder or can navigate from one folder to another folder.

The present invention can gather information related to the folder to which the user or individual desires to move or navigate and any relevant, or all of the, privileges associated with the user or individual. The present invention can assess the user's or individual's eligibility to move to, or to navigate to, the selected folder and can determine whether or not the user or individual is eligible, or has the sufficient privileges, to move to, or to navigate to, the selected folder. If it is determined that the user or individual is eligible, or has the sufficient privileges, to move to or navigate to the selected folder, then the present invention can gather information regarding the folders, files, or objects, which the user or individual is eligible to view or to access and provide the user or individual with the link(s) for accessing each folder. The user or individual can then access the folder and perform any desired task.

If the user or individual is determined to be ineligible, or lacks the required privileges, to access the selected folder, the present invention can provide a warning message to the user or individual warning him or her that they are ineligible or lack the privileges to access the selected folder.

The user or individual can also be assigned or be granted the appropriate and/or proper privileges to perform any of the upload files tasks provided by the present invention. The user or individual can select to work with the Upload Files functionality from the TACL File(s)/Folder(s) Main Page. The present invention can gather information related to the user's or individual's privileges relating to the Upload Files functionality and can provide the user or individual with the Upload Files Main Page on the user's or individual's user computer.

The user or individual, assuming that he or she has sufficient privileges, can select a file or files and a destination TACL folder to which the file or files are to be uploaded. The file or files which the user selects for uploading the TACL folder can be local files on the user's or individual's user computer or can be stored on an external device which is accessible to the user or individual. The ability or privilege of the user or individual to upload a file or files to the TACL folder can be referred to herein as a “write-to” privilege.

The present invention can determine if the file or files to be uploaded are new files or if they already exist in the destination TACL folder. If it is determined that the file or files to be uploaded do not already exist in the destination TACL folder, then the new file or files can be uploaded to the destination TACL folder. The user or individual can also be provided with the option to give or assign other users or individuals with access rights to the destination TACL folder with the same folder file access rights to the uploaded file or files.

If it is determined that the file or files already exists in the destination TACL folder, then the present invention can determine if the file or files have been reserved by another user of individual and, if so, the present invention can send the user or individual a message indicating that the file or files are currently reserved by another user or individual and that the user or individual will not be allowed to upload the file or files at that time.

If it is determined that the file or files have not been reserved by another user or individual, then the present invention can determine whether or not the file or files have been modified by another user or individual since a last download of the file or files by the user or individual. If it is determined that the file or files have been modified by another user or individual, then the present invention can provide the user or individual with a notification message notifying the user or individual that a file or files have been updated by a different user or individual since it or they were last updated by the user or individual. The user or individual can also be notified of, or be instructed to investigate, any potential problem(s) with the file or files, such as a modification made by a last user or individual.

The user or individual can also select to upload the file or files to the TACL folder as the latest current version(s) of the file or files. The present invention can also determine if the user or individual has selected to upload the file or files to the TACL folder as the latest current version of the file or files. If it is determined that the user or individual has selected to upload the file or files to the TACL folder as the latest current version of the file or files, then the file or files can be uploaded to, and stored in, the destination TACL folder as the newest version of the file of files, and any older file or files can be relayed back one version count.

If it is determined that the file or files have not been modified by another user or individual, then the file or files can be uploaded to, and stored in, the destination TACL folder as the newest version of the file or files, and any older file or files will be relayed back one version count.

The Shared Privileges functionality pertains to allowing a user or individual to access a file(s) or folder(s), which can also be referred to as an object(s). Depending upon whether a user or individual has supervisory privileges, the user or individual can grant certain rights regarding an object(s) to another user or individual and/or grant rights to the privilege to grant rights and/or privileges to other users or individuals. The present invention can gather information related to the user's or individual's Shared Privileges functionality privileges relating to a selected TACL file/folder/object and gather information relating to the selected TACL file/folder/object's access information, such as, for example, chain link information on all the users or individuals currently privileged for the selected TACL file/folder/object, and the user's or individual's supervisory position, if any, regarding the selected TACL file/folder/object.

The user or individual can also be provided with a Shared Privileges Main Page which can be displayed on the user's or individual's user computer and which can provide information to the user or individual regarding existing privileges regarding the selected TACL file/folder/object. The Shared Privileges Main Page can also contain information for allowing the user or individual to set or remove privileges for the selected TACL file/folder/object to or from other users or individuals, as well as provide information such as information regarding an item or privilege to be set or established, current users or individuals who have privileges regarding the selected TACL file/folder/object, each user's or individual's privilege origin (such as chain link information regarding who granted the link, the privilege level, or when it was granted, etc.) and a level of privilege for each user or individual.

The Share Privileges Page can also be used by the user or individual to add a link for or corresponding to another user or individual.

The present invention can also determine whether or not the user or individual has any supervisory privilege to grant another user or individual a privilege or privileges to or regarding the selected TACL file/folder/object and, if it is determined that the user or individual does have supervisory privilege to grant another user or individual a privilege or privileges to or regarding the selected TACL file/folder/object, then the user or individual can add and/or select another user(s) or individual(s) to a list of privileged users or individuals for the selected TACL file/folder/object, can set or grant, change, modify, or remove, a privilege for privileges of another user(s) or individual(s) regarding the TACL file/folder/object, or can grant a user(s) or individual(s) the ability to grant access privileges to the selected TACL file/folder/object.

Any privileges granted, changed, modified, or removed, can be dictated by the user's or individual's supervisory level and/or any privileges pertaining thereto. The present invention can also be programmed such that, if a privilege is taken away from a particular user or individual, then any other users or individuals (the linked users or individuals) who are granted privileges to access the selected TACL file/folder/object by that user or individual will also lose that linked privilege.

The Modify Chain Link functionality enables a user or individual to modify chain link information or privileges regarding another user or individual on a select file or object. Only chain link information of a user or individual who is directly or indirectly given chain link privileges from another user or individual, and who wants to perform the modifying operation (hereinafter “the modifying user or individual), may be modified.

The present invention can gather information regarding all users or individuals and chain link information related to a file or object. A Chain Link Privileges Page can be provided to the modifying user or individual via the user computer. The Chain Link Privileges Page can provide information regarding all chains that the modifying user or individual is part of and all other users or individuals on those chains for the file or object. If the modifying user or individual has company, corporate, or full, privileges, then all chains can be listed on the Chain Link Privileges Page regardless of whether or not the modifying user or individual is part of a chain or chains.

The modifying user can select another user or individual (not himself or herself) on a particular chain. The present invention can provide to the user computer a listing of all chains that include the selected user or individual, provided that the user or individual is down the chain link from the modifying user or individual. The listing can be displayed on or via the user computer and the modifying user or individual can select to modify the selected user's or individual's privileges on the chain.

If it is determined that the modifying user or individual has selected to modify the selected user's or individual's privileges on the chain, then the selected user or individual and the rest of the users or individuals (if any) following that selected user or individual on the chain is/are taken out of, or removed from, the chain link and a new bifurcation of the chain link will be created or will occur which will list the selected user or individual, and the rest of the chain of users or individuals, including any bifurcations, that may have been removed, next to where the modifying user or individual is on the same chain.

The modifying user or individual can also modify a privilege or privileges of the selected user or individual on the chain. If the privilege or privileges is or are less than previously provided to or by the selected user or individual, then all of the other user(s) of individual(s) following the selected user or individual in the link will have his/her/their privilege or privileges on the chain modified or set to be equal to or less than the new privilege or privileges setting for the selected user or individual.

Chain Links can be designed such that it does not matter if a user or individual is listed on two different chains or is listed on one chain more than once. If and when a privilege change is made regarding a selected user or individual, the modifying user or individual can be provided with information regarding all of the selected user's or individual's chain link occurrences and can be able to modify a privilege or privileges regarding any one or more of these chain link occurrences. If there is more than one occurrence of the selected user or individual for a file of object, then all work performed by the modifying user or individual can follow any access protocol of the chain link with the most privilege or privileges for the selected user or individual. In the case where there exists a tie for access, such as when each of two occurrences have a same level of access privilege, then the oldest level of access privilege can be deemed to be the de facto level of access privilege.

If a selected user or individual is tagged (or added) to a chain link(s) on a file or object, and if the selected user or individual is already on some chain link somewhere else for the selected file or object, then the modifying user or individual can be provided with a warning that the selected user or individual already exists with a specified access privilege. If the modifying user or individual is not content with the selected user's or individual's privilege and wants to increase same, then the modifying user or individual can add a second occurrence from his or her own chain link. Also, if the modifying user or individual tags another selected user or individual, then the added link will be to that chain link next to the modifying user or individual. An old link, although remaining intact, may not be used as the de facto link and a new higher privilege can be dictated to be what controls in the Modify Chain Link functionality.

A modifying user or individual may not be allowed to decrease a privilege level or an access level of a user or individual who is not managed by the modifying user or individual or given a high enough privilege in the first place. Instead, only a manager or some other user or individual up the chain from the selected user or individual may be able to effect such a modification.

The Download TACL files functionality can be used by the user or individual to download a TACL file into the user's or individual's private or local directory or area. The user or individual can select the Download TACL Files functionality from the TACL File(s)/Folder(s) Main Page and can select the file the user or individual wants to download into his of her private or local directory or area. The present invention can gather all information related to the selected file and provide the Download TACL Files Main Page to the user's or individual's user computer.

The user or individual can select the local directory/folder for downloading the selected TACL file(s). The user or individual can also select to modify the selected TACL file(s).

The present invention can determine whether or not the user of individual has the necessary privilege or privileges to modify the selected TACL file(s). If it is determined that the user or individual does not have the necessary privilege or privileges to modify the selected TACL file(s), then the user or individual will be so notified and will be prompted to select to download the selected TACL file(s) for read-only viewing via the user computer. The selected TACL file(s) can be downloaded, for read-only viewing, to the user computer. If it is determined that the user or individual does have the necessary privilege or privileges to modify the selected TACL file(s), then the present invention will determine whether or not the selected TACL file(s) is marked as being reserved by some other user or individual.

If it is determined that the selected TACL file(s) is not marked as being reserved by some other user or individual, then the present invention will mark the selected TACL file(s) as Locked/Reserved and the selected TACL file(s) is downloaded to the user computer and the local directory in the user computer. The user or individual can provide a reason for locking/reserving the selected TACL file(s) which can be stored by the present invention and which can be provided to a next user or individual who attempts to download the selected TACL file(s) for modification.

If it is determined that the selected TACL file(s) is marked as being reserved by some other user or individual, then a notification of the reservation is provided to the user or individual via the user computer. The user or individual can also investigate as to why the selected TACL file(s) is reserved and can make a request of the reserving user or individual to make the selected TACL file(s) available to the user or individual for modification or can notify the reserving user or individual of a need for modifying the selected TACL file(s). For example, the reserving user or individual can be requested to unlock or release the selected TACL file(s).

The user or individual can select to download the selected TACL file(s) by receiving same as a read-only download. The present invention can also determine whether or not the user or individual wants to download the selected TACL file(s) for read-only download viewing. If it is determined that the user or individual wants to download the selected TACL file(s) for read-only download viewing, the user or individual can be so notified and can be prompted to select to download the selected TACL file(s) for read-only download viewing.

The Object Stream functionality pertains to a user or individual access flow for a file/folder/object's stream that allows communication with other users or individual's regarding that file/folder/object. The present invention can gather information regarding the user or individual and the files/folders/objects the user or individual has privileges to or for or has access to or for. The user or individual can select the object stream which he or she desires to access or with or on which he or she desires to work.

The Object Shortcut functionality allows a user or individual to create a shortcut to a TACL folder. The user or individual can select the Object Shortcut functionality from the TACL File(s)/Folder(s) Main Page and the file or object for which the user or individual wants to utilize the Object Shortcut functionality. The user or individual selects the file(s) or object(s) for which he or she wants to create a shortcut to a TACL folder and the user or individual can select the TACL folder in which the shortcut reference will be put into for the selected file(s) or object(s), and the shortcut can be created in the TACL folder for the selected file(s) or object(s).

The Remove File(s) functionality allows a user or individual to remove a file(s) from a TACL folder. The user or individual can select a file(s) for removal from a TACL folder and can select to work with the Remove File(s) functionality from the TACL File(s)/Folder(s) Main Page. The present invention can gather information related to the file(s) and to the privileges of the user or individual seeking to work with and/or to remove same. The present invention can determine whether or not the user or individual has sufficient privileges to remove the file(s) and/or can determine whether or not the file(s) is locked. If it is determined that either the user or individual does not have sufficient privilege to remove the file(s), or if it is determined that the file(s) is locked, then nothing is done with respect to the file(s) and the user or individual is notified of the reason, such as, for example, that the user or individual lacks sufficient privileges to remove the file(s) or that the file is locked and, therefore, cannot be removed.

If it is determined that the user or individual does have sufficient privilege to remove the file(s) and that the file(s) is not locked, then the file(s) is removed from the TACL folder. The removal of the file can be effectuated by the listing of the file(s) being removed from the “file content list” for the TACL folder and by adding the listing of the file(s) to a “files deleted list” or a “deleted files list”. The removed or deleted file is not deleted or expunged, but rather, it can be deleted from a “file content list” and can be placed on the “files deleted list” or the “deleted files list”.

The removed or deleted file(s) can be available to be brought back or re-activated back into use at any time. If it should be desired to undelete the deleted file(s), the file(s) can be accessed from the “files deleted list” or the “deleted files list” and can be moved back into a TACL folder by adding the file(s) to the “file content list” for the TACL folder or for another TACL folder. The user or individual seeking to undelete a file(s) is typically required to have the privileges needed to undelete the file(s) and the user or individual must be included in the chain link associated with the file(s).

The Lock/Reserve Files functionality allows a user or individual to lock or reserve a file(s) from being changed by another user or individual. A user or individual can also utilize the Lock/Reserve Files functionality when downloading or uploading a file or the user or individual can simply decide to lock up the file. The user or individual can select a file for lock or reserving and selecting to work with the Lock/Reserve Files functionality from the TACL File(s)/Folder(s) Main Page. The present invention can gather all information related to the file and to the privileges of the user or individual seeking to work with same.

The present invention can determine whether or not the file is in an unlocked state and, if so, whether or not the user or individual has the privileges or the sufficient privileges to lock or reserve the file. If it is determined that the file is not in an unlocked state, so that the file is determined to be in a locked state, or that the user or individual does not have the privileges or the sufficient privileges to lock or reserve the file, then either the locked state of the file will remain unchanged and the user or individual will be notified via the user computer that the file is in a locked state or the user or individual will be notified via the user computer that he or she lacks the privilege or privileges to lock or reserve the file.

If it is determined that the file is in an unlocked state and that the user or individual has the privileges or the sufficient privileges to lock or reserve the file, then the user or individual can set the file for Lock or Reserve so as to prevent access to the file by others.

The Release/Unreserve Files functionality allows a user or individual to release or unreserve a file(s) from being locked or reserved thereby allowing a user or individual with privileges to access the file(s) to do so. The user or individual can select a file for release or unreserving and can select to work with the Release/Unreserve Files functionality from the TACL File(s)/Folder(s) Main Page. The present invention can gather all information related to the file and to the privileges of the user or individual seeking to work with same. The present invention can determine whether or not the user or individual is the person who locked or reserved the file in the first instance, the manager of the user or individual, or an administrator. If it is determined that the user or individual is not the person who locked or reserved the file in the first instance, is not the manager of the user or individual, or is not an administrator, then the file will remain locked with its locked status remaining unchanged.

If it is determined that the user or individual is the person who locked or reserved the file in the first instance, is the manager of the user or individual, or is an administrator, then the user or individual can unlock, release, or unreserve, the file so that the file will then be available for others to access or use.

The Tag Count Security functionality allows a user or individual to establish or set up a greater Tag Count Security on a file, folder, or object, so as to provide more security in providing or granting access to the file, folder, or object, to other users or individuals. A tag count quantity can be used to signify or represent the amount of appropriately privileged users or individuals, including company, corporate, or administrative, users or individuals which would be necessary or desired to allow, or to give or grant permission to another user or individual to have or gain access to the file, folder, or object.

The user or individual can select the Tag Count Security functionality from the TACL File(s)/Folder(s) Main Page and the file, folder, or object, the user or individual selects (“the selected file, folder, or object”) for performing a Tag Count Security operation. The present invention can gather information related to the selected file, folder, or object. The present invention can also provide the Tag Count Security Page to the user's or individual's user computer.

The present invention can determine whether or not the user or individual has the appropriate privilege or privileges to set a tag count on or regarding the selected file, folder, or object. If it is determined that the user or individual does not have the appropriate privilege or privileges to set a tag count on or regarding the selected file, folder, or object, then the present invention can provide a message to the user computer notifying the user or individual that he or she does not have the appropriate privilege or privileges to set a tag count on or regarding the selected file, folder, or object.

If it is determined that the user or individual does have the appropriate privilege or privileges to set a tag count on or regarding the selected file, folder, or object, then the present invention will determine whether or not the tag count for the selected file, folder, or object, is currently set at the lowest level, which, for example, can be a Tag Count of “1”. If it is determined that the tag count for the selected file, folder, or object, is currently set at the lowest level, which can, for example, be taken to be a “1”, then the user or individual is allowed to, and can, set the Tag Count for the selected file, folder, or object, to a greater value which in a preferred embodiment, can, for example, be a “2” or a higher number. The new Tag Count can be selected so that it is not greater than the total amount or total number of users or individuals with company, corporate, or full administrative, privileges for the selected file, folder, or object.

If it is determined that the tag count for the selected file, folder, or object, is not currently set at the lowest level, then the user or individual can set an intermediary field to a new Tag Count value. The present invention can determine whether or not there are enough users or individuals with the same intermediary field values for the selected file, folder, or object. If it is determined that there are enough users or individuals with the same intermediary field values for the selected file, folder, or object, then the Tag Count Security value for the selected file, folder, or object, can be set to the value which was previously set by the user or individual.

If it is determined that there are not enough users or individuals with the same intermediary field values for the selected file, folder, or object, then the user or individual will be notified, via a message provided to his or her user computer, that there are not enough users or individuals with sufficient privileges who have requested a change to be made to the Tag Count value.

The Tag Count for a selected file, folder, or object, can be for reading and/or for modifying the selected file, folder, or object. There can also be a Tag Count for reading, and a separate Tag Count for modifying, the selected file, folder, or object, as there may be a need or desire to approve a user's or individual's ability to modify the selected file, folder, or object, but not necessarily a need or desire for the user or individual to read the selected file, folder, or object. In such an instance, if the reading Tag Count is higher than the modifying Tag Count, then the modifying Tag Count will be set to the higher level of the two.

The Administrative TACL Privileges functionality can be used by an individual or user to give out or to grant, or to modify, privileges for a user(s) or individual(s) for a selected file, folder, or object. The user or individual utilizing the Administrative TACL Privileges functionality can be an administrator who is authorized to give out or grant any privilege to any user or individual regarding a selected file, folder, or object.

The user or individual, who can be an administrator, can select to work with the Administrative TACL Privileges functionality from the TACL File(s)/Folder(s) Main Page and can select the file, folder, or object, the user or individual selects (“the selected file, folder, or object”) for which the administrator user or individual wants to administer or effect a privilege change.

The user or individual can utilize the present invention to a add a link for or corresponding to another user or individual. The user or individual can access the server via the user computer and transmit information to the server for adding a link for or corresponding to the other user or individual. The server can receive, process, and store, the information for adding the link for the other user individual. The server can then add the link for the user or individual, and the added link will allow the other user or individual to have to or to access a file, folder, or object.

The present invention can gather information related to the selected file, folder, or object, and can also provide the Administrative TACL Privileges Page to the administrator user's or individual's user computer. The Administrative TACL Privileges Page can provide a listing of the current privileged users or individuals of the selected file, folder, or object.

The present invention can ascertain whether the administrator user or individual wants to give or grant a privilege to another user or individual, not yet so privileged, for the selected file, folder, or object. The present invention can determine whether or not the administrator user or individual wants to give or grant a privilege to another user or individual, not yet so privileged, for the selected file, folder, or object.

If it is determined that the administrator user or individual wants to give or grant a privilege to another user or individual, not yet so privileged, for the selected file, folder, or object, then the administrator user or individual can give, grant, or provide, a privilege or privileges to the user or individual by adding the user's or individual's username to the list of privileged users or individuals for the selected file, folder, or object, and by specifying and adding information regarding the privilege level for the added user or individual on the list of privileged users or individuals for the selected file, folder, or object. This addition of the added user or individual gives rise to, or starts, a chain link privilege for the added user or individual.

Any time an administrator user or individual adds a user or individual to the list of usernames privileged for a selected file, folder, or object, the addition can give rise to or start a chain link privilege with that user or individual being the first user or individual on the chain link. A selected file, folder, or object, can have many chain links as an administrator user or individual can give or grant privileges to more than one user or individual for that selected file, folder, or object.

If it is determined that the administrator user or individual does not want to give or grant a privilege to another user or individual, not yet so privileged, for the selected file, folder, or object, then the administrator user or individual can select to modify or remove or delete a user's or individual's privilege or privileges regarding the selected file, folder, or object.

A modification, removal, or deletion, of a user's or individual's privilege or privileges regarding a selected file, folder, or object, can effect all users or individuals down the chain link from the user or individual. In the alternative, the administrator user or individual can sever the chain link and start another chain with a next user or individual on the chain being a first person on the chain, without affecting the next user's or individual's privilege or privileges. It is also possible that there may be more than one such next user or individual as the user or individual whose privilege was modified, removed, or deleted, may have given or provided privileges to more than one other user or individual bifurcating the chain, in which case the administrator user or individual would be starting a separate chain with each bifurcation.

The present invention can also determine whether or not the administrator user or individual selected to modify or remove or delete a user's or individual's privilege or privileges regarding the selected file, folder, or object. If it is determined that the administrator user or individual selected to modify or remove or delete a user's or individual's privilege or privileges regarding the selected file, folder, or object, then the administrator user or individual can modify, remove, or delete, any privilege or privileges of the user or individual with regard to the selected file, folder, or object. Thereafter, the present invention can modify, remove, or delete, any privilege or privileges given or granted by the user or individual to any other users or individuals in a nested manner, or otherwise, and the chain link can be modified for the selected file, folder, or object, or the present invention can create new chains keeping users or individuals down the chain intact, so that the resulting privileges and chains can be consistent with the modifications, removals, or deletions, made by the authorized user or individual.

The User Relation Module functionality can be used by an administrator or other authorized individual in order to configure or define a user's or individual's relation(s) with another user(s) or individual(s). The user or individual can select to work with the User Relation Module functionality from the TACL File(s)/Folder(s) Main Page. The administrator or authorized individual can be provided with the User Relation Page on his or her user computer. The present invention can gather information regarding any users or individuals who are authorized to utilize the present invention and the administrator or other authorized individual can also select to add, modify, or delete, any user relationship or individual relationship.

The present invention can determine whether or not the administrator or authorized individual has selected to add, modify, or delete, any user relationship or individual relationship. If it is determined that the administrator or authorized individual has selected to add, modify, or delete, any user relationship or individual relationship, then the administrator or authorized individual can select the user or individual relationship which is to be added, modified, or deleted.

The administrator or authorized individual can also select the user or individual and can be provided with information regarding that user's or individual's relationship(s) within the committee. The administrator or authorized individual can select another committee in or with which the user's or individual's relations or relationships are to be added, modified, or deleted. The administrator or authorized individual can, in addition, also select a different user or individual for whom he or she wants to add, modify, or delete, a relationship or relationships.

The administrator or authorized individual can also be provided with the Committee Relations Page for that committee which provides information showing the users or individuals on that committee and, for each user or individual, that user's or individual's relations with other users of individuals in that committee. The administrator or authorized individual can select the user or individual and can be provided with information regarding that user's or individual's relationships in that committee. The administrator or authorized individual, after viewing the user's or individual's relationships, can then add, modify, or delete, any of the user's or individual's relationships in that committee. The administrator or authorized individual can also select to perform tasks for adding, modifying, or deleting, any relationships for any other committee.

Any additions, modifications, or deletions, made with regard to any user or individual can also effect any relations of any other user(s) or individual(s) who have a relationship with that user or individual.

### BRIEF DESCRIPTION OF THE DRAWINGS

In the Drawings:

FIG. 1 illustrates a preferred embodiment of the apparatus of the present invention in block diagram form;

FIG. 2 illustrates a preferred embodiment relationship between the various messages, defined tasks or assigned tasks, projects, and project tasks, described herein as being utilized in connection with the apparatus of FIG. 1;

FIG. 3 illustrates a block diagram illustrating a preferred embodiment hierarchy of the relationship between a project manager or project head and a project task head;

FIG. 4 illustrates a simple one-way relationship which may be defined from one user or individual to another in utilizing the apparatus of FIG. 1;

FIG. 5 illustrates a more complicated relationship between users or individuals who utilize the apparatus of FIG. 1;

FIG. 6 illustrates an example of a view of a display screen of the user computer used in connection with the apparatus of the present invention showing numerous sessions open and available to the user or individual via the user computer;

FIG. 7 illustrates a diagram of an example stream which is utilized in connection with the apparatus and method of the present invention;

FIG. 8 illustrates an example of a diagram of a project task stream platform that can be used in completing a project, showing a project header, project task streams, and a project talk stream;

FIG. 9 illustrates a preferred embodiment example of a defined task or an assigned task header or a project header utilized in the respective streams of FIGS. 7 and 8;

FIG. 10 illustrates a preferred embodiment example of a message detail unit (MDU);

FIGS. 11A and 11B illustrate a preferred embodiment method for using the apparatus of FIG. 1 to create a defined task or an assigned task from a message;

FIG. 12 illustrates a preferred embodiment method of utilizing the apparatus of FIG. 1 in order to create or establish a tasking platform which can be utilized in connection with the present invention;

FIG. 13 illustrates a preferred embodiment method for utilizing the apparatus of FIG. 1 to update the stream;

FIG. 14 illustrates a preferred embodiment method for utilizing the apparatus of FIG. 1 to access and act upon a message or messages and information contained therein;

FIG. 15 illustrates an example of a screen shot used for providing information to a user or individual which can be provided via the user computer;

FIGS. 16A and 16B illustrate a preferred embodiment method for allowing a user or individual to access any the features and/or functionality described herein as being provided by the apparatus and method of the present invention, in flow diagram form;

FIGS. 17A and 17B illustrate a preferred embodiment method of utilizing the apparatus and method of the present invention to allow a user or individual to perform a task or tasks using the TACL functionality, in flow diagram form;

FIGS. 18A and 18B illustrate the features of the apparatus and method of the present invention which can be accessed via the TACL File(s)/Folder(s) Main Page;

FIGS. 19A, 19B, and 19C illustrate a preferred embodiment operation of the TACL Folders functionality of the apparatus 100 and method of the present invention, in flow diagram form;

FIGS. 20A and 20B illustrate a preferred embodiment operation of the Folder Navigation functionality of the apparatus and method of the present invention, in flow diagram form;

FIGS. 21A, 21B, and 21C illustrate a preferred embodiment operation of the Upload Files functionality of the apparatus and method of the present invention, in flow diagram form;

FIGS. 22A and 22B illustrate a preferred embodiment operation of the Shared Privileges functionality of the apparatus and method of the present invention, in flow diagram form;

FIGS. 23A and 23B illustrate a preferred embodiment operation of the Modify Chain Link functionality of the apparatus and method of the present invention, in flow diagram form;

FIGS. 24A, 24B, and 24C illustrate a preferred embodiment operation of the Download TACL Files functionality of the apparatus and method of the present invention, in flow diagram form;

FIG. 25 illustrates a preferred embodiment operation of the Object Stream functionality of the apparatus and method of the present invention, in flow diagram form;

FIGS. 26A and 26B illustrate a preferred embodiment operation of the Object Shortcut functionality of the apparatus and method of the present invention, in flow diagram form;

FIG. 27 illustrates a preferred embodiment operation of the Remove File(s) functionality of the apparatus and method of the present invention, in flow diagram form;

FIG. 28 illustrates a preferred embodiment operation of the Lock/Reserve Files functionality of the apparatus and method of the present invention, in flow diagram form;

FIG. 29 illustrates a preferred embodiment operation of the Release/Unreserve Files functionality of the apparatus and method of the present invention, in flow diagram form;

FIGS. 30A, 30B, and 30C illustrate a preferred embodiment operation of the Tag Count Security functionality of the apparatus and method of the present invention, in flow diagram form;

FIGS. 31A and 31B illustrate a preferred embodiment operation of the Administrative TACL Privileges functionality of the apparatus 100 and method of the present invention, in flow diagram form; and

FIGS. 32A and 32B illustrate a preferred embodiment operation of the User Relation Module functionality of the apparatus and method of the present invention, in flow diagram form.

### DESCRIPTION OF THE PREFERRED EMBODIMENTS

The present invention pertains to an apparatus and method for communicating, accessing, organizing, and/or managing, information in a network environment. In particular, the apparatus and method of the present invention can be utilized in order to create, organize, and/or manage, messages sent between individuals or organizations by defined tasks or assigned tasks, projects related to those defined tasks or assigned tasks, project tasks related to those projects, project talk, and/or messages. The apparatus and method of the present invention can be utilized by users or individuals or by an organization in order to organize and/or manage messages sent by and between users, individuals, or organizations, so that these messages, and any information contained therein, can be communicated, accessed, organized, and/or managed, by any user(s) or individual(s).

The apparatus and method of the present invention provides an effective and efficient means by which a stream of messages can be formed which may result from, or which may relate to, a single message between individuals, a defined task or assigned task which can be created to address, or be in response to, a message, a stream of messages sent by and between individuals which relate to, or which result from, the defined task or assigned task, a project or projects which may be created by, or which may result from, a defined task or an assigned task, and/or a project task or project tasks which relate to, or which result from, a project. Project talk and other messages can also be organized into streams.

By providing an organized means by which messages can be organized and/or managed, the apparatus and method of the present invention provides an effective and efficient communications system and platform which facilitates enhanced communications between users and individuals, enhanced organization communication and efficiency, and enhanced accountability among users and individuals who utilize the apparatus and method of the present invention.

As and for an illustrative example, the apparatus and method of the present invention can be utilized by and between any number of users or individuals in an enterprise, a company, an organization, a group, or an association, in order to communicate an initial message which can recognize and/or result in a creation of a defined task or an assigned task which needs to be performed in order to address a subject of the initial message or a subsequent message.

In response to the need for a defined task or an assigned task, a task stream can be created which can be utilized to organize and/or manage any and/or all subsequent messages which address that defined task or assigned task. The initial message, or any subsequent message, can be the basis for creating the defined task or the assigned task. The defined task or assigned task can then be the basis for creating a project which needs to be performed or accomplished in order to perform the defined task or the assigned task. Similarly, the project can, in turn, be the basis for creating one or more project tasks.

Messages which pertain to the defined task or the assigned task, to the project or projects related to the defined task or the assigned task, to the project task or project tasks, and/or to project talk, can then be organized into, or linked together, into a respective stream of messages which can be communicated, accessed, organized, and/or managed, by any respective user, individual, or organization, involved in the defined task or assigned task, the project or projects, the project task or project tasks, or the project talk.

The ability to communicate, access, organize, and/or manage these respective streams provides for enhanced communication efficiency and facilitates enhanced accountability in managing and performing the respective defined task or the assigned task, the project or projects relating to the defined task or the assigned task, and the project task or project tasks relating to a project.

The apparatus and method of the present invention can also be utilized in order to allow users or individuals to track messages, defined tasks or assigned tasks, projects, project tasks, and/or project talk, more efficiently and effectively.

It is important to note that, while, for illustration purposes, a specific hierarchy is described herein which relates a defined task or assigned task, a project, a project task, and/or project task, to one another, any appropriate form or hierarchy can be used. Also, any project task can, in turn, be the basis for creating a new or an additional defined task or assigned task, which, in turn, can result in a new project and new project tasks which result from the new or additional defined task or assigned task. Further, any task, project, project talk, or message, can be the basis for creating a new defined task or assigned task, a new project, and/or a new project task.

Further, the terms or phrases “defined task or assigned task”, “project”, “projects”, “project task”, and “project tasks” are selected and used herein merely for convenience and these terms or phrases can be replaced by any other suitable terms or phrases in describing the present invention, and/or any hierarchy of streams which are created, organized, and/or managed, by the apparatus and method of the present invention.

In a preferred embodiment, the apparatus and method of the present invention is described in connection with communicating, accessing, organizing, and/or managing, e-mail communications, and the information contained therein, in a network environment. It is important to note, however, that the apparatus and method of the present invention can also be utilized in connection with, and/or can be adapted to be utilized in connection with, communicating, accessing, organizing, and/or managing, instant messaging messages (“instant messages”) and/or any other forms of electronic messages or electronic transmissions.

The apparatus and method of the present invention can also be utilized as a communication platform by and between individuals, family members, friends, and social communities, as well as businesses and organizations of any type, kind, or size. The apparatus and method of the present invention can also be utilized in connection with an enterprise, company, organization, group, or association, located with a single physical facility or in connection with an enterprise, company, organization, group, or association, having any number of remotely located facilities.

For purposes of the description which follows, the following terms or phrases are defined as follows:

“Message” means any information communicated, in text form from one individual or user to one or more individuals or users.

“Message Detail or Message Detail Unit (MDU)” means any single message text sent in a single message.

“Stream” means a string or chain of message details between individuals or users which relate to a same subject or header information.

“Defined Task or Assigned Task” means an assignment communicated by, or resulting from, a message or messages, a message detail or message detail unit (MDU), or a stream, having a goal or objective, a start date, a due date or completion date, and/or an assigned leader.

“Project” means an undertaking that has a goal or an objective and which requires or results in the creation of one or more related project tasks for accomplishing the goal or objective.

“Project Tasks” means an undertaking having a goal or objective which relates to a project.

“Project Talk” means a single message or stream which relates to a specific project, but which is not itself a defined task or an assigned task.

“Committee” means a generalized grouping or community of individuals or organizations which may be responsible for, or have an interest in, a defined task or an assigned task, a project or projects, a project task or project tasks, project talk, or a message or messages.

“Direct Associates” means those colleagues or individuals with whom an individual or user of the present invention may work with on a day-to-day or other basis within a committee or community. The user or individual may have a different set of Direct Associates in each committee or community.

“Head or Manager” means a user or individual assigned to accomplishing, or overseeing, the accomplishing of, a defined task or an assigned task, or a project.

“Message Author” means the user or individual who initiates a message, a stream, or a defined task or an assigned task.

“Enterprise” means an institution or an organization having one or more operating locations.

Applicant hereby incorporates by reference herein, in their entirety, the subject matter and teachings of U.S. patent application Ser. No. 12/269,314, filed Nov. 12, 2008 and entitled “APPARATUS AND METHOD FOR COMMUNICATING, ACCESSING, ORGANIZING AND/OR MANAGING, INFORMATION IN A NETWORK ENVIRONMENT”.

Applicant also hereby incorporates by reference herein, in their entirety, the subject matter and teachings of U.S. Provisional Patent Application Ser. No. 60/987,396, filed Nov. 12, 2007, and entitled “TASK-CENTRIC COMMUNICATIONS SYSTEM”. Applicant also hereby incorporates by reference herein, in their entirety, the subject matter and teachings of U.S. Provisional Patent Application Ser. No. 61/108,542, filed Oct. 26, 2008, and entitled “TASK-CENTRIC COMMUNICATIONS SYSTEMS.

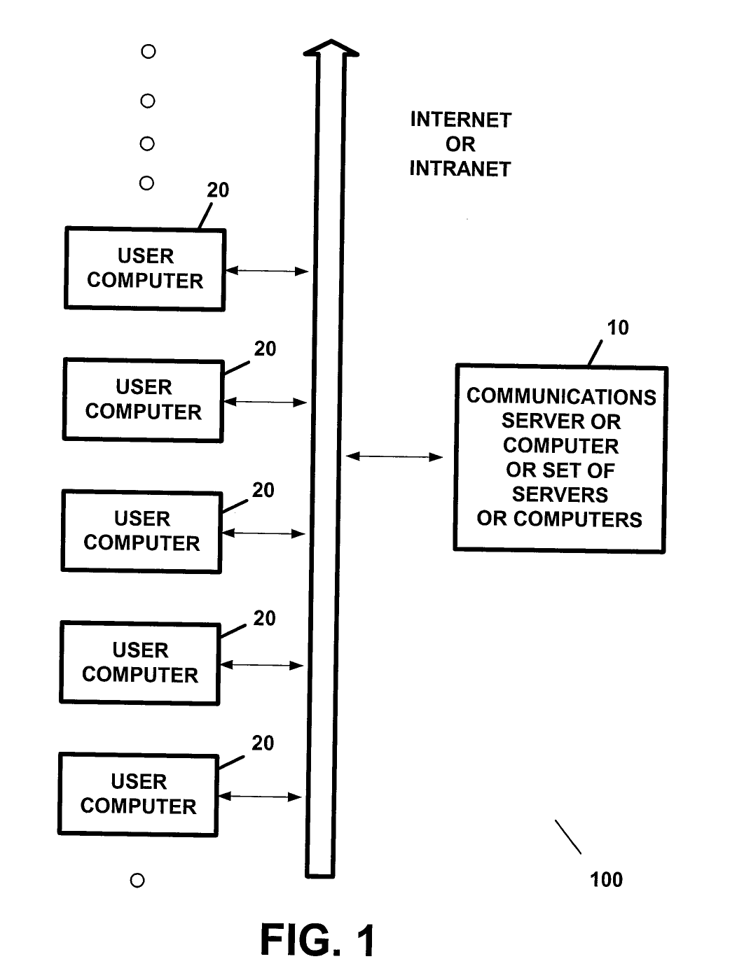

FIG. 1 illustrates a preferred embodiment of the apparatus of the present invention, which is designated generally by the reference numeral 100, in block diagram form. With reference to FIG. 1, the apparatus 100 includes one or more communications servers or computers 10 or a set, or any number of sets of, servers or computers 10 (hereinafter “server” or “server 10”). In the preferred embodiment, the server 10 can include one or more computers or computer systems and can be equipped to serve as an e-mail server or as any other suitable communications computer or network computer which can perform the functionality of the present invention as described herein.

In the preferred embodiment, the server 10 can be programmed to perform all of the functions and functionality described herein as being performed and/or as being provided by the apparatus 100 and method of the present invention. In addition, any server 10 or set of servers or computers utilized in connection with the apparatus 100 can store any of the data, information, streams, or messages, described herein. Further, any server 10 or set of servers or computers utilized in connection with the apparatus 100 can store any of the data, information, streams, or messages, described herein in any centralized and/or de-centralized manner.

Any number of servers 10 can be utilized in the apparatus 100 of the present invention.

With reference once again to FIG. 1, the apparatus 100 also includes any number of user computers or devices 20 (hereinafter “user computer” or “user computer 20”). In a preferred embodiment, each user computer 20 can be, or can include, any computer or communication device which can be utilized by a user or an individual in using the apparatus 100 and method of the present invention as described herein. In a preferred embodiment, the user computer 20 can be a personal computer, a laptop computer, a hand-held computer, a wireless telephone, a cellular telephone, or a personal digital assistant, and/or can be any other wired or wireless computer or communication device. Any number of user computers 20 can be utilized in the apparatus 100 of the present invention, and any user or individual can use any number of user computers 20.

With reference once again to FIG. 1, the apparatus 100 can be utilized in connection with any suitable communications network or platform. For example, in a preferred embodiment, the apparatus 100 and method of the present invention can be utilized on or over the Internet and/or the World Wide Web, on or over an Intranet or Intranets, and/or on or over any other suitable communications network, and/or on or over any combination of the Internet and/or the World Wide Web and an Intranet or Intranets or other communications network or platform. The communications network or platform can also be, or can include, any local area network or any wide are network, a public switched telephone network, and/or any other suitable communications network and/or any wireless communications network.

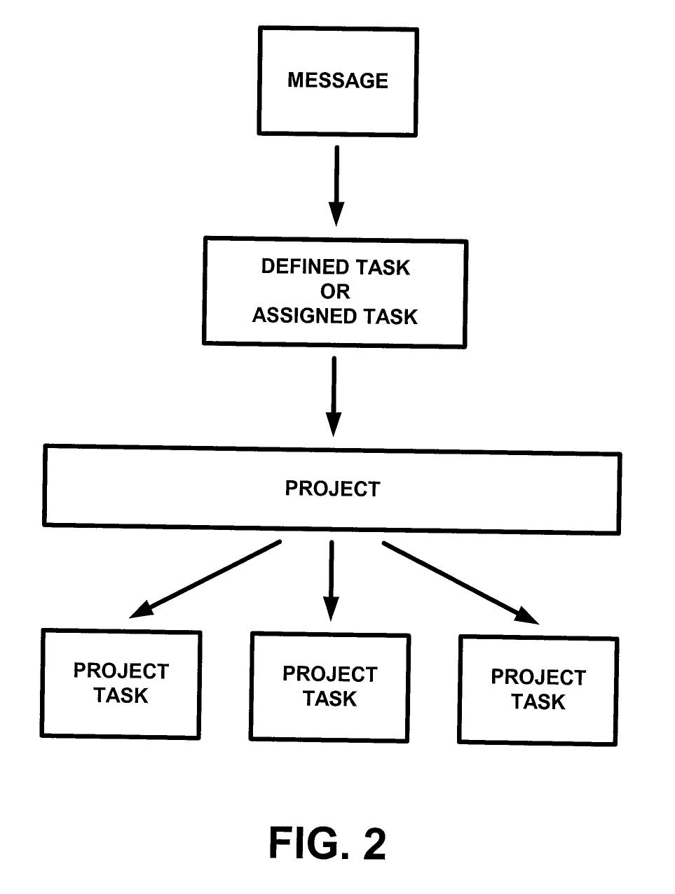

FIG. 2 illustrates a preferred embodiment relationship between the various messages, defined tasks or assigned tasks, projects, and project tasks, described herein as being utilized in connection with the apparatus 100 of the present invention. With reference to FIG. 2, any and/or all communications begins with a message sent from one user or individual to one or more other users or individuals. The message contains a message detail or a message detail unit (MDU) which includes the subject matter or text of the message.

As noted above, the message is the first or initial communication in what may become a stream of messages. In the preferred embodiment, the sender, the receiver, or any user or individual who receives the message can decide whether a defined task or an assigned task should be created from, or as the result of, the message. Once a defined task or an assigned task is determined to be created, then such a defined task or an assigned task is created as shown in FIG. 2, and any and/or all information regarding the first or initial message, information regarding the creation of the defined task or the assigned task, and/or information regarding the defined task or assigned task, will be stored in the server 10, in a database associated with the server 10, and/or in an external database.

In the preferred embodiment, a manager or a head can then be assigned to manage or oversee the defined task or the assigned task. In a preferred embodiment, every defined task or assigned task which is created will have a task manager or a task head assigned thereto. Any user or individual who sends, receives, or views, the first or initial message can determine that the defined task or the assigned task should be created.

It is important to note that, in the hierarchy of FIG. 2, the first or initial message is the starting point for any resulting stream created by and stored by the apparatus 100 of the present invention. It is also important to note that a stream for a task, a project, a project task, project talk, or a message, can also be created directly from, or as the result of, a message.

If a defined task or an assigned task is created, any user or individual who sends, receives, or views, the first or initial message, or who sends, receives, or views, any message creating the defined task or the assigned task, can decide whether a project or projects should be created in order to accomplish the defined task or the assigned task. If a project is to be created, then a manager or a head will be assigned to manage or oversee the project. In a preferred embodiment, each project created will have a project manager or a project head assigned thereto. Once a project is determined to be created, then such a project is created as shown in FIG. 2, and any or all information regarding the creation of the project, and/or information regarding the project, will be stored in the server 10, in a database associated with the server 10, and/or in an external database.

Thereafter, any user or individual, or the project manager or project head, who sends, receives, or views, the message creating the project can decide whether, and what, project tasks are to be created in order to accomplish the project. If a project is created, then a manager or a head will then be assigned to manage or oversee the project. If a project task is determined to be created, then such a project task is created as shown in FIG. 2, and any or all information regarding the creation of the project task, and/or any information regarding the project task will also be stored in the server 10, in a database associated with the server 10, and/or in an external database. Once a project task is to be created, then a project task manager or project task head will then be assigned to manage or oversee the project task.

Any and/or all information regarding any messages or replies thereto which result in the creation of the above referenced defined tasks or assigned tasks, projects, project tasks, messages, and/or project talk, will be stored in the server 10, in a database associated with the server 10, and/or in an external database.

At any time during any communications regarding any of the above defined tasks or assigned tasks, projects, project tasks, messages, and/or project talk, a new defined task or assigned task, a new project, a new project task, project talk, and/or a new message, can be created in response to any other message sent by any of the users or individuals involved in any communications or messages regarding the created defined task or assigned task, the project, the project task, the message, and/or the project talk.

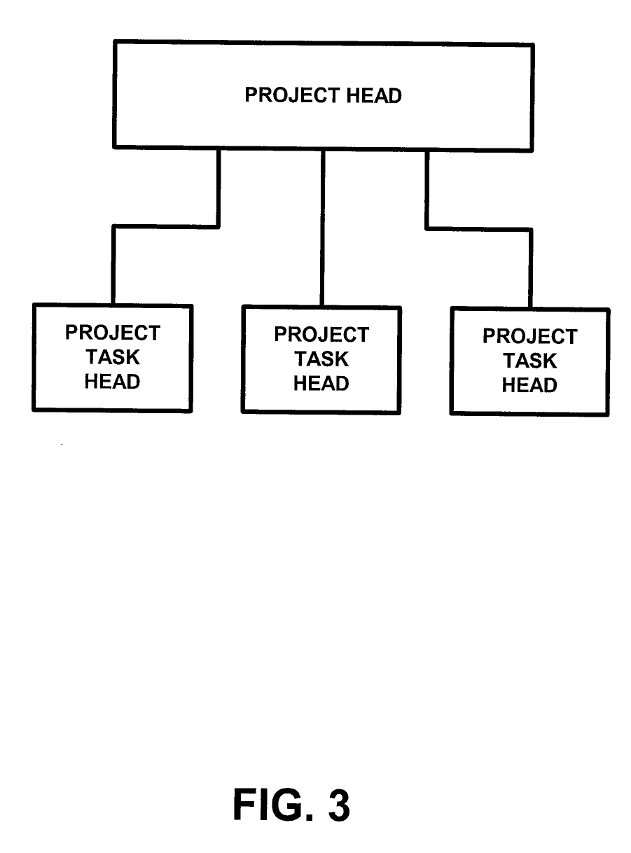

FIG. 3 illustrates a block diagram of a preferred embodiment hierarchy of a typical relationship between a project manager or project head and a project task head. With reference to FIG. 3, the Project Manager or Project Head oversees one or more Project Task Heads.

In a preferred embodiment of the present invention used, for example, in an enterprise organization, user or individual relationships to other users or individuals can be defined by either a manager-aid relationship, where one party is a manager of the other, an aid, and a peer relationship in which the parties are only peers to one another. In a preferred embodiment, one of the criteria attributes defined when a user or individual is initially introduced into the system is the user relations criteria which defines the relationship between the user or individual vis-à-vis other users or individual (also referred to as “Associates”) whom that user or individual may be working with on a day-to-day basis.

In a preferred embodiment, relationships between users or individuals can be defined, re-defined, changed, created, or dissolved, at any time, and by any authorized person.

In a preferred embodiment, the above-described user relations can become that of a “direct associate” within a defined committee while all other associates of the enterprise can then be considered to be “non-direct associates”. For almost every user or individual, there can exist, or be assigned, at least one “manager” (supervisor) relationship. To the managing user or individual, an added user or individual can be considered to be an “aid” or an assistant or helper, and that aid can, in turn, serve as another user's or individual's manager.

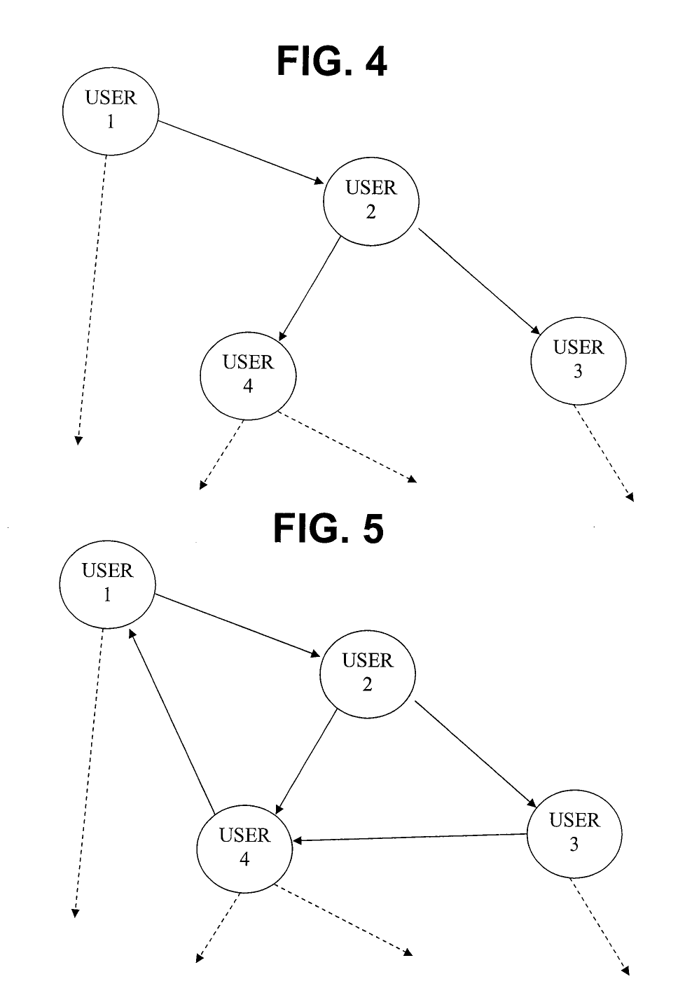

FIG. 4 illustrates a simple one-way relationship which may be defined from one user or individual to another as shown by arrows which depict a manager to aid relationship with the aid being on the receiving end of the respective arrowhead.

In a preferred embodiment, a manager-aid relationship can be used to determine or to define a user's or an individual's ability to assign a defined task(s) or an assigned task(s), a project(s), or a project task(s), to other users or individuals.

FIG. 5 illustrates a more complicated relationship between users or individuals which can also be established wherein an aid to one manager can also be a manager to the manager of his or her manager. It should be noted that a relationship between users or individuals can be reversed depending upon the committee, the defined task or assigned task, the project, or the project task.

In a preferred embodiment, all users or individuals may not or need not be on-line with the apparatus 100 at the same time in order to view a message(s) or a message record(s) which may be being viewed by other users or individuals. Rather, a user or individual can also access the server 10 at any time and retrieve a message(s) or a message record(s) at any time and from any location via any suitable user computer 20.

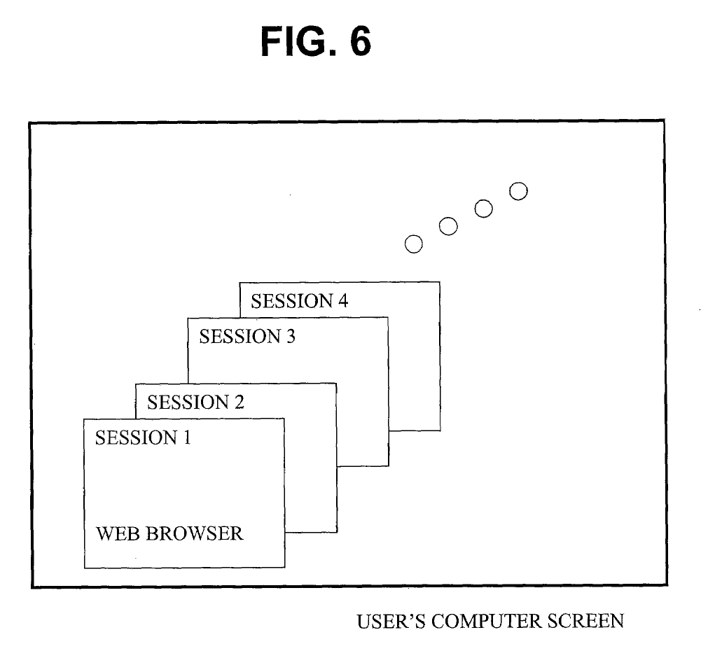

In a preferred embodiment, the user or individual can view a message or message record for any message, defined task or assigned task, project, project task, and/or project talk described herein in a screen session or sessions via the user computer 20. In a preferred embodiment, the user or individual can also view any number of messages or message records for any number of the messages, defined tasks or assigned tasks, projects, project tasks, and/or project talk, described herein in multiple sessions via the user computer 20. FIG. 6 illustrates an example of a view of a display screen of a user computer 20 showing numerous sessions being open and available to the user or individual via the user computer 20.

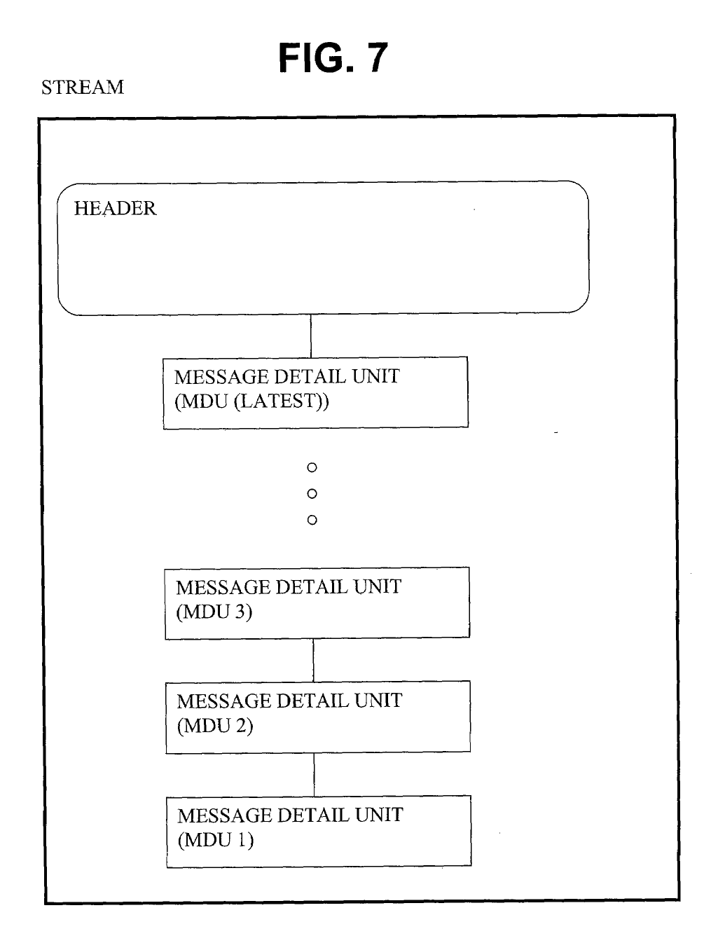

FIG. 7 illustrates a diagram of an example stream which is utilized in connection with the apparatus 100 and method of the present invention. With reference to FIG. 7, the stream consists of a header and a string or chain of connected message detail units (MDUs) associated with that header, in the order from the most recent message detail unit (MDU) to the earliest message detail unit (MDU).

In a preferred embodiment, users or individuals involved with or authorized to receive one MDU may not necessarily be involved with or authorized to receive all MDUs within a given stream. Instead, a user or individual may only view a portion of the stream dealing with a particular task, project, or project task, for which he or she is involved. A task stream can be provided with information regarding a specific goal, a start date, a deadline, and a head assigned to accomplish the specific goal as shown in FIG. 7.

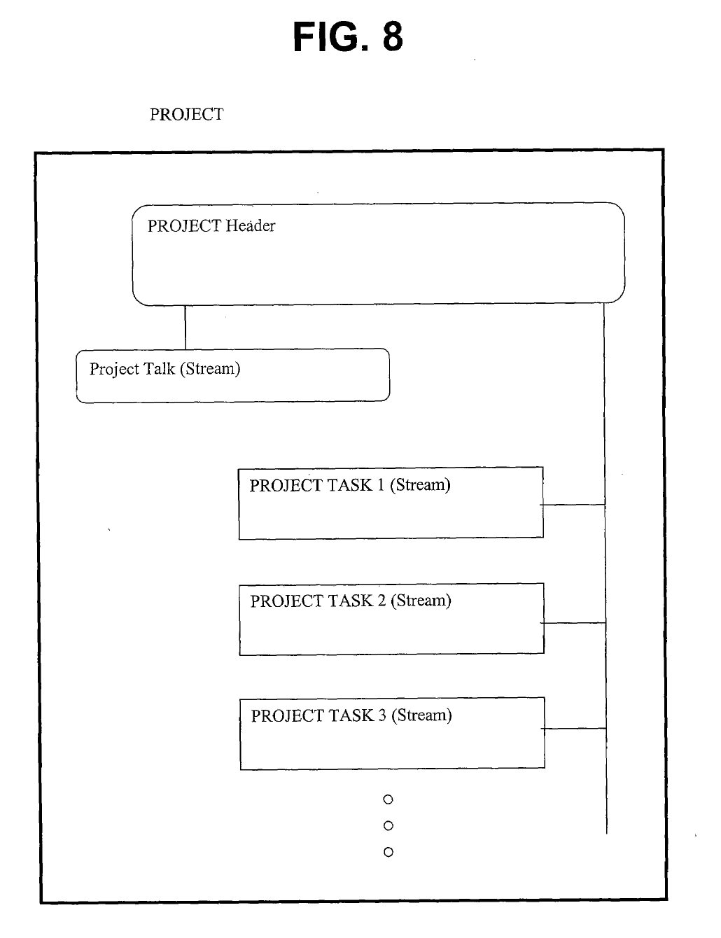

In a preferred embodiment, a task stream may exist by itself among other unrelated task streams or within a project which may be listed among other related project task streams as illustrated in FIG. 8. FIG. 8 illustrates an example diagram of a Project task Stream platform that can be used in completing a Project, showing a Project Header, Project Task Streams, and a Project Talk stream.

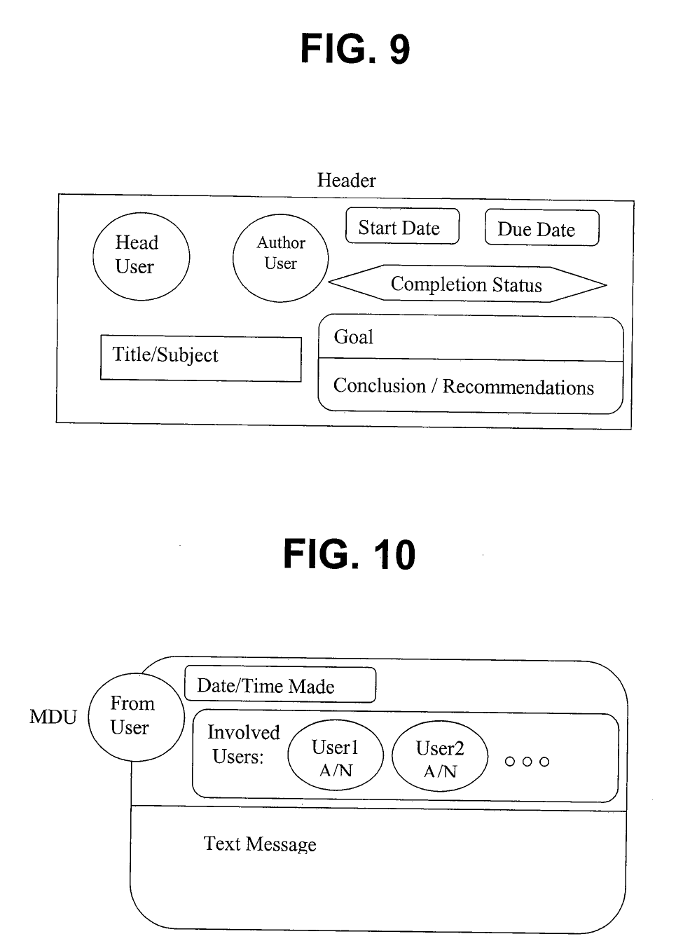

FIG. 9 illustrates a preferred embodiment example of a defined task header or an assigned task header or a project header utilized in the respective streams of FIGS. 7 and 8. With reference to FIG. 9, the header includes information regarding a Head User, an Author User, a Start Date, a Due Date, a Completion Status, a Title/Subject, a Goal, and/or a Conclusion/Recommendation. The header can also include any other information deemed appropriate or necessary.

FIG. 10 illustrates a preferred embodiment example of a Message Detail Unit (MDU). In the embodiment of FIG. 10, the MDU contains information regarding the From User, the Date/Time Made, the Involved Users (User 1 A/N), (User 2 A/N), etc., and the Text Message, and/or can include any other information deemed appropriate or necessary. It is important to note, that the notation “A/N”, as used herein, refers to a user's acknowledgement or failure to acknowledge the MDU.

Any of the herein-described information contained in any of the respective headers can be selected in any appropriate manner by any authorized party, and information, such as, for example, start dates and due dates, can also be selected and/or defined relative to the start dates and/or due dates of other and/or related defined tasks or assigned tasks, projects, and/or project tasks.

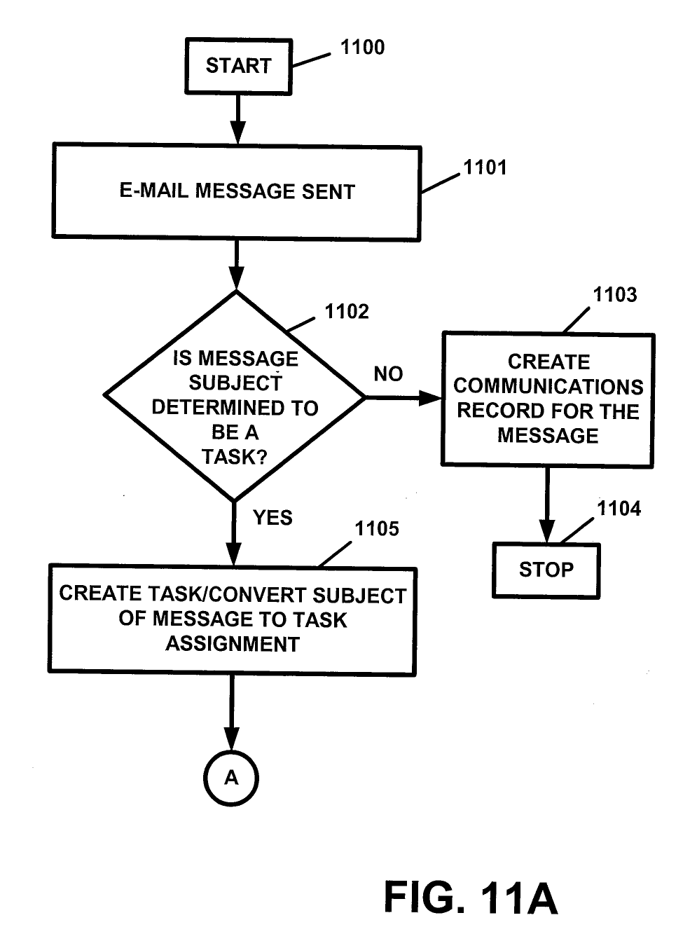

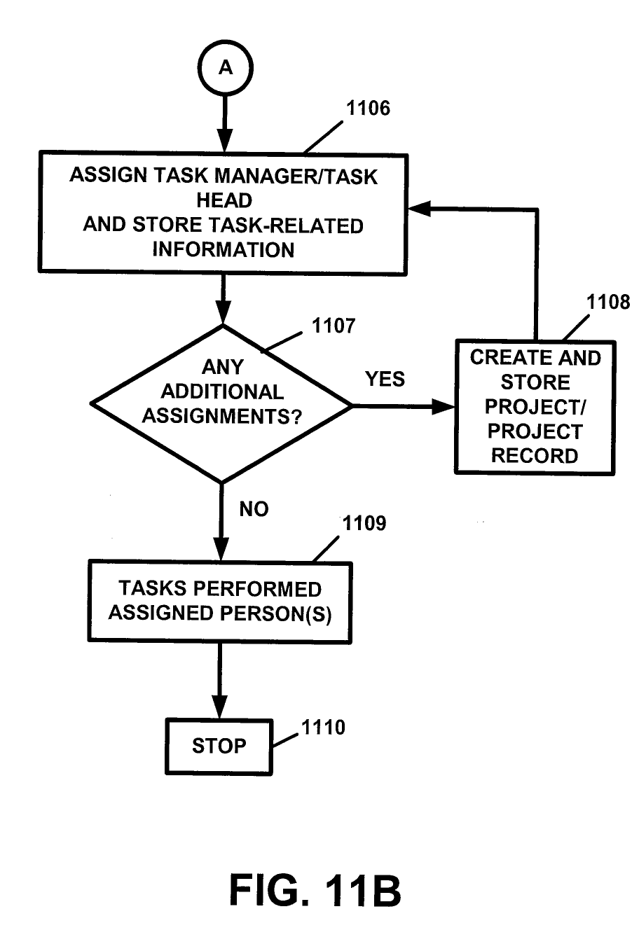

FIGS. 11A and 11B illustrate a preferred embodiment method for using the apparatus 100 of the present invention to create a defined task or an assigned task from a message. In a preferred embodiment of the present invention, a defined task or an assigned task can originate from any message from one user or individual to one or more other users or individuals.

With reference to FIGS. 11A and 11B, the operation of the apparatus 100 commences at step 1100. At step 1101, a user or individual (“the sending user or individual”) can generate and send an e-mail message to one or more other users or individuals (“the receiving user(s) or individual(s)”). The e-mail message can contain any subject matter. For example, the e-mail message can simply contain a greeting or message between friends. The e-mail message can also contain subject matter which may require or need attention, such as, for example, a recognized need to perform a task, such as in a business or enterprise setting.

At step 1101, any one or more of the sending user or individual or the receiving user(s) or individual(s) can determine whether or not to create a defined task or an assigned task to address the subject matter of, or in, the message. In this manner, subject matter of a message can, in a sense, be “converted” into a defined task or an assigned task (hereinafter, “the task”). The creation of the task can be performed in any appropriate manner, such as, for example, by selecting a “Create Task” box or button in or on the e-mail message or a header of the e-mail message. Information regarding the e-mail message, the subject matter of the e-mail message, the sender of the e-mail message, the receiver or receivers of the e-mail message, the text of the e-mail message, and information regarding whether a task is created, are stored in the respective server 10 in which the e-mail message is stored and from which it was retrieved or transmitted.

At step 1102, the server 10 will determine whether or not a task has been created or, to put it in other words, whether the subject matter of the e-mail message has been converted into a task. If, at step 1102, the server 10 determines that no task was created from the subject matter of the e-mail message, the operation of the apparatus 100 will proceed to step 1103 and the server 10 will create a communication record for the e-mail message and any response or responses thereto. The communication record containing the e-mail and any response or responses thereto will then be stored in the server 10, in a database of or associated with same, and/or in an external database.

Thereafter, the operation of the apparatus 100 will cease at step 1104.

If at step 1102, it is determined that a task was created from the subject matter of the e-mail message, or that the subject matter of the e-mail message has been converted into a task, the operation of the apparatus 100 will proceed to step 1105 and the server 10 will create a communications record for the task and create and store any information regarding any task assignment associated with the task. At step 1105, the communication record containing the information regarding the task and the task assignment will then be stored in the server 10, in a database of or associated with same, and/or in an external database.

At step 1106, an authorized user or individual can provide and/or the server 10 can assign and store information regarding the task manager or task head for the task from information regarding the user or individual who has been assigned to the task, such as from information entered into or contained in any appropriate field in a reply e-mail message, or from information regarding the user or individual who is to be automatically assigned, such as from the user's or individual's assigned responsibilities in the organization. At step 1106, the information regarding the task manager or task head will be stored in the server 10, in a database of or associated with same, and/or in an external database. At step 1106, information regarding any and/or all users or individuals who are to be involved in performing the task, and the relationship(s) between these users or individuals (e.g. head, manager, aid, or peer) can also be stored in the communications record for the task in the server 10, in a database of or associated with same, and/or in an external database.

At step 1106, information regarding a goal of the task, a start date, a completion date, and/or a deadline, associated with the task can also be stored in the communication record for the task in the server 10, in a database of or associated with same, and/or in an external database.

At step 1107, the server 10 can determine from information obtained from the e-mail message, from any response(s) thereto, from any other information provided by any appropriate user(s) or individual(s), and/or from any previously defined rule or rules concerning task execution, whether or not any additional assignments are required to execute the task. If at step 1107, it is determined that an additional assignment, or multiple assignments, needs to be performed, then the operation of the apparatus 100 will proceed to step 1108 and a project record will be created and stored for a project which is identified to be created to address the additional assignment or each assignment of the multiple assignments.

Thereafter, the operation of the apparatus 100 will proceed to step 1106 and the server 10 will, in response to information provided by a user or individual or information stored in the server 10, store information regarding the project manager or project head for the project from information regarding the user or individual who has been assigned to the project, such as from information entered into or contained in an appropriate field in a reply e-mail message, or from information regarding the user or individual who is to be automatically assigned, such as from the user's or individual's assigned responsibilities in the organization. At step 1106, the information regarding the project manager or project head will also be stored in the server 10, in a database of or associated with same, and/or in an external database.

At step 1106, information regarding any and/or all users or individuals who are to be involved in performing the project, and the relationship(s) between these users or individuals (e.g. head, manager, aid, or peer) can also be stored in the communications record for the project in the server 10, in a database of or associated with same, and/or in an external database. Thereafter, the operation of the apparatus 100 will proceed once again to step 1107 and the operation of the apparatus 100 will continue.

If, at step 1107, it is determined that no additional assignment needs to be performed, then the operation of the apparatus 100 will proceed to step 1109. At step 1109, the user(s) or individual(s) assigned to the task will perform his/her/their respective assignment(s) to execute and complete the task. Any e-mail messages, and any message detail units (MDUs), transmitted by or received by the user(s) or individual(s) assigned to the task, can be organized together in streams and can be stored in the communications record associated with the task in the server 10, in a database of or associated with same, and/or in an external database. Thereafter, the operation of the apparatus 100 will cease at step 1110.

At any time throughout the above-described process, any authorized user or individual, who has been assigned to the task or otherwise, can access and retrieve any messages or streams associated with the task.

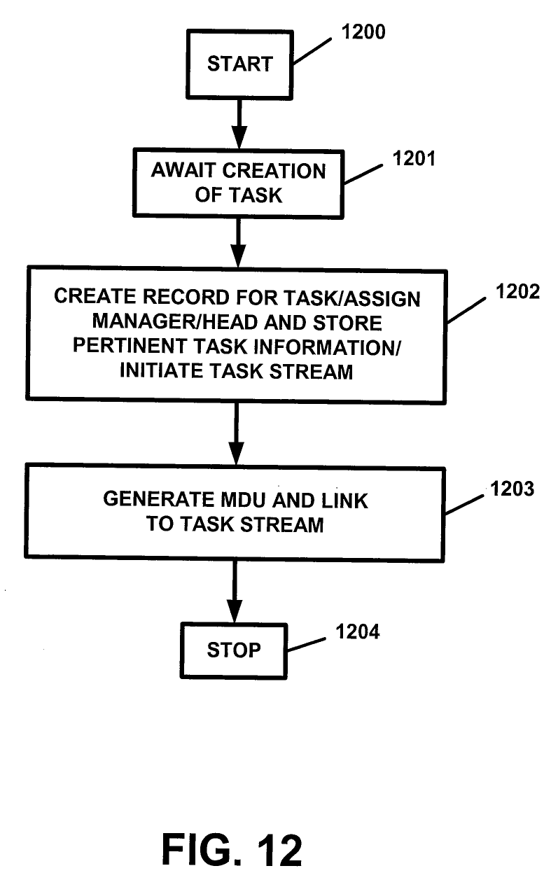

FIG. 12 illustrates a preferred embodiment method of utilizing the apparatus 100 of the present invention in order to create or establish a tasking platform for a task, which, in a preferred embodiment, can include the creation of, and the development and/or propagation of, a stream for the task (“task stream”). With reference to FIG. 12, the operation of the apparatus 100 commences at step 1200. At step 1201, the apparatus 100 will await the creation of a task.

Upon the creation of the task, the operation of the apparatus 100 will proceed to step 1202 and a communication record for the task will be created with information regarding same, including, but not limited to, the information regarding the task manager or task head, information regarding any and/or all users or individuals who are to be involved in performing the task, and the relationship(s) between these users or individuals (e.g. head, manager, aid, or peer, etc.), and/or information regarding a goal of the task, a start date, a completion date, and/or a deadline, associated with the task, can also be stored in the communication record for the task in the server 10, in a database of or associated with same, and/or in an external database.

At step 1202, any message or messages associated with the task, such as the message from which the task was created or the subject matter of which was converted into the task, and any response or responses to same, can also be stored in the communication record for the task in the server 10, in a database of or associated with same, and/or in an external database. At step 1202, the server 10 will also create or initiate the stream for the task (“task stream”).

At step 1203, as e-mail messages are generated and transmitted to, from, or between, any of the users or individuals assigned to the task, and/or as well as any other users or individuals, the server 10 will, for each e-mail message, generate a message detail unit (MDU) corresponding to the e-mail message and link the MDU to the stream for the task. The operation at step 1203 will continue with an MDU or multiple MDUs being added to the stream for the task until the task is completed or until the cessation of any e-mail messages associated with the task. Each time the stream for a task is updated to include a new MDU the updated stream will be stored in the server 10, in a database of or associated with same, and/or in an external database.

Upon completion of the task, or upon the cessation of e-mail messages associated with the task, the operation of the apparatus 100 will cease at step 1204.

It is important to note that any and/or all streams created by the apparatus 100 of the present invention, including streams for any and all defined tasks or assigned tasks, any projects, any project tasks, any project talk, and/or any messages, described herein, can be created, updated, and stored, in the manner described herein with reference to the method described in FIG. 12.

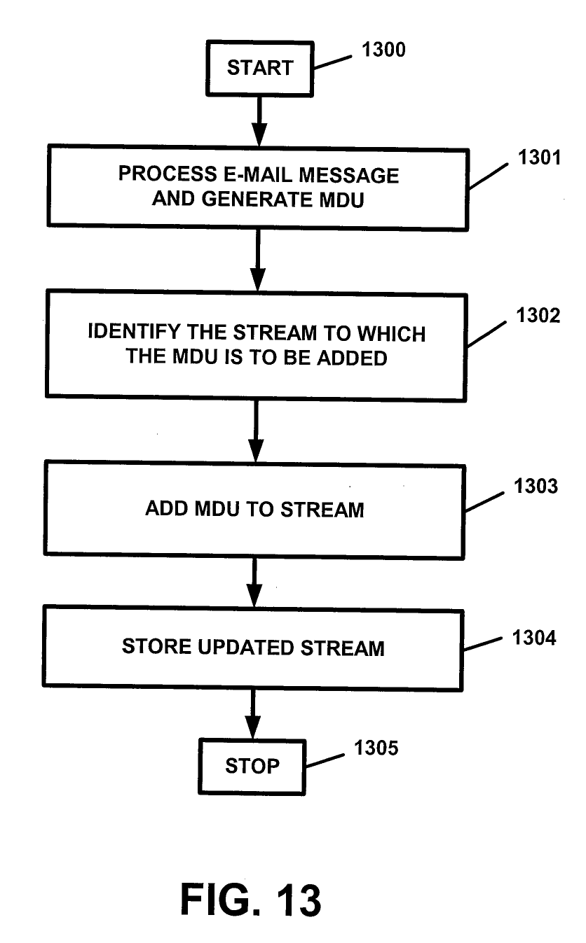

FIG. 13 illustrates a preferred embodiment method for utilizing the apparatus 100 of the present invention to update a stream for any of the defined tasks or assigned tasks, projects, project tasks, project talk, and/or messages, described herein. The method of FIG. 13 describes a preferred embodiment method for performing the stream updating which is described hereinabove as being performed at step 1203 of the preferred embodiment of FIG. 12.

With reference to FIG. 13, the operation of the apparatus 100 commences at step 1300. At step 1301, upon receiving an e-mail message which is sent from a sending user or individual, and before transmitting the e-mail message to a receiving user(s) or individual(s), the server 10 will process information regarding the e-mail message and will generate an MDU associated with the e-mail message. At step 1302, the server 10 will identify the stream, for the respective defined task or assigned task, project, project task, project talk, or message, which is to be updated so as to include the newly generated MDU.

At step 1303, the server 10 will update the identified stream by adding the newly generated MDU to same. Thereafter, at step 1304, the updated stream will be stored in the server 10, in a database of or associated with same, and/or in an external database. At step 1304, the updated stream is available for accessing and viewing by any authorized user or individual.

At step 1304, the server 10 can also, in a preferred embodiment, record information regarding whether or not any one or more users or individuals have acknowledged receiving the new MDU in the stream. Thereafter, the operation of the apparatus 100 will cease at step 1305.

It is important to note that the above method can be utilized to process e-mail messages, generate an MDU, and update the appropriate stream, for any streams for any of the herein-described defined tasks or assigned tasks, projects, project tasks, project talk, and/or messages.

The apparatus 100 and method of the present invention provides an efficient and effective means by which to communicate, access, organize, and/or manage, information in a network environment. Any user or individual involved in an enterprise, organization, group, association, and/or any other relationship with others can utilize the apparatus 100 of the present invention to communicate with others, access pertinent information in an organized and efficient manner, organize their communications, and/or manage their communications and/or interaction with other users or individuals.

Streams, which can be task-based, project-based, project task-based, project-talk-based, or message-based, can be easily accessed, viewed, responded to, and/or otherwise addressed, in a simple an easy manner. The ease and simplicity provided by the apparatus 100 and method of the present invention facilitates improved and more organized communication efficiencies and effectiveness, while promoting a more organized dissemination of information and fostering greater accountability among users and individuals who use the present invention.

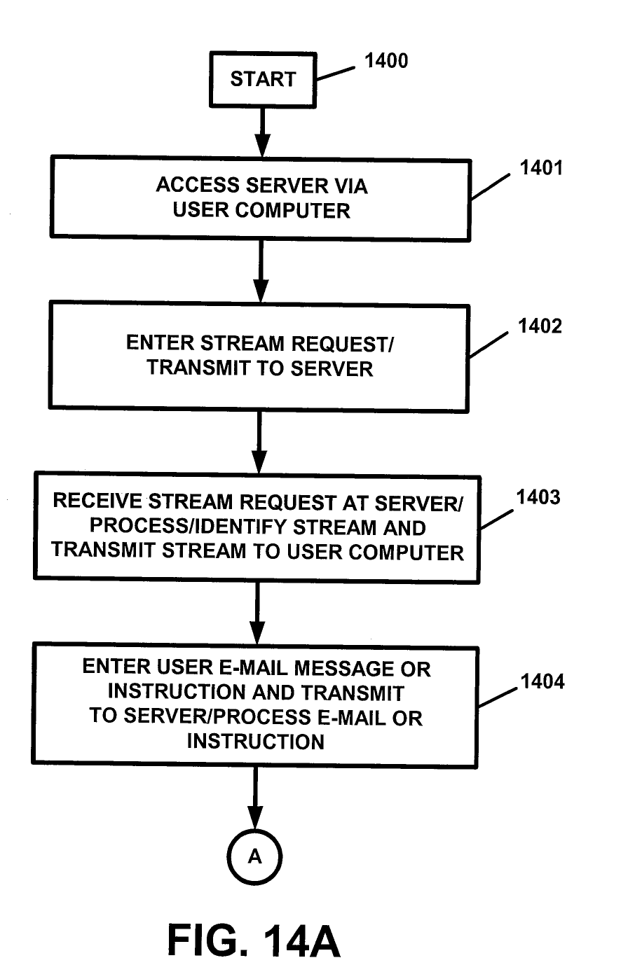

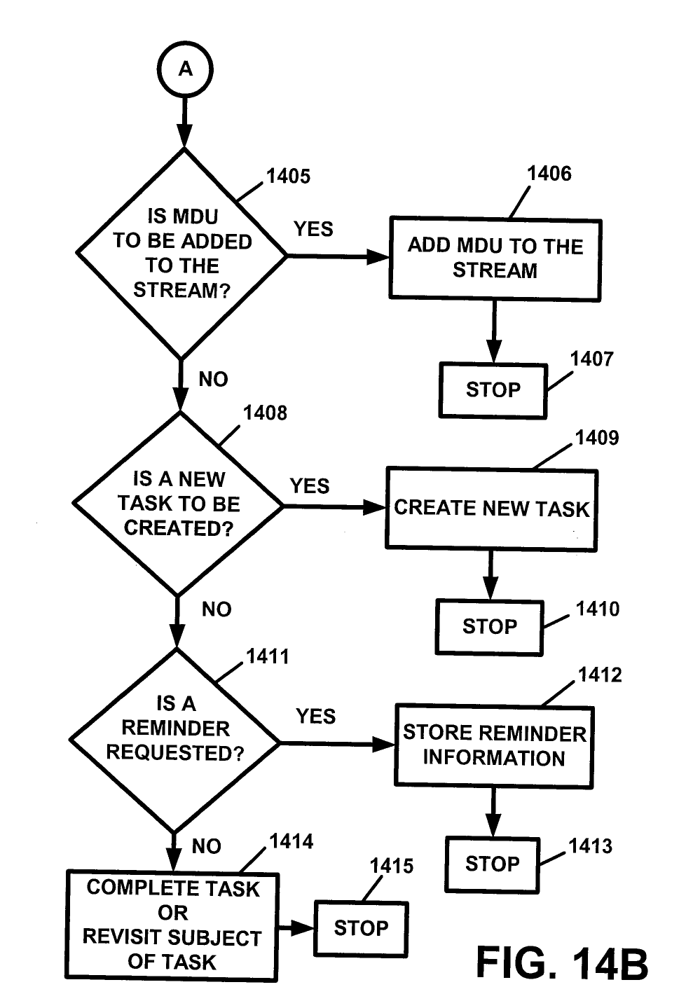

FIG. 14 illustrates a preferred embodiment method for utilizing the apparatus 100 and method of the present invention to access and act upon messages and information contained therein. With reference to FIG. 14, the operation of the apparatus 100 commences at step 1400. At step 1401, a user or individual can access the server 10 via a user computer 20. In a preferred embodiment, the user or individual may be required to provide a password or some other form of identification to gain authorized access to the information stored at the server 10. Once obtaining access to the server 10, the user or individual can, at step 1402, request a particular stream (“the stream request”) for any defined task or assigned task (“task”), any project, any project task, any project talk, and/or any message, which he or she is interested in accessing.

At step 1402, the stream request is transmitted from the user computer 20 to the server 10. At step 1403, the server 10 will receive and process the stream request, identify the requested stream for the identified task, project, or project task, project talk, and/or message, and transmit the requested stream to the user computer 20.

At step 1404, the user or individual can view the stream and decide whether or not he or she desires to add a message in the form of a new MDU to the stream. If the user or individual desires to add to, or to update, the stream, such as by responding to a message or by communicating a new message, the user or individual will generate a new e-mail message to a recipient or recipients and transmit the new e-mail message to the server 10 for processing in a manner consistent with the present invention.

At step 1404, instead of, or in addition to, adding a new MDU to the stream, the user or individual can decide to create a new task from the stream and/or to add a reminder request regarding the task which is the subject of the stream, and/or the user or individual can simply decide to complete the task which is the subject of the stream.

If, at step 1404, the user or individual decided to add a new MDU to the stream, then the new e-mail message can be generated by the user or individual and can be transmitted to the server 10. Similarly any instruction to create a new task from the stream, or to add a reminder request regarding the task which is the subject of the stream, can be transmitted to the server 10 at step 1404.

At step 1404, the server 10 will either receive the new e-mail message or determine that the user or individual has exited the stream without adding a new e-mail message. If a new e-mail message is received, then the server 10 will recognize the receipt of the new e-mail message to mean that the user or individual desired to add a new MDU to the stream.

At step 1405, the server 10 will determine, based on the user or individual response, whether a new MDU is to be added to the stream. If, at step 1405, it is determined that a new MDU is to be added to the stream, the operation of the server 10 will proceed to step 1406. At step 1406, the server 10 will generate the appropriate MDU in response to the new e-mail message, add the MDU to the stream so as to update the stream, and store the updated stream. The updated stream can be stored in the server 10, in a database of or associated with same, and/or in an external database. Thereafter, the operation of the apparatus 100 will cease at step 1407.

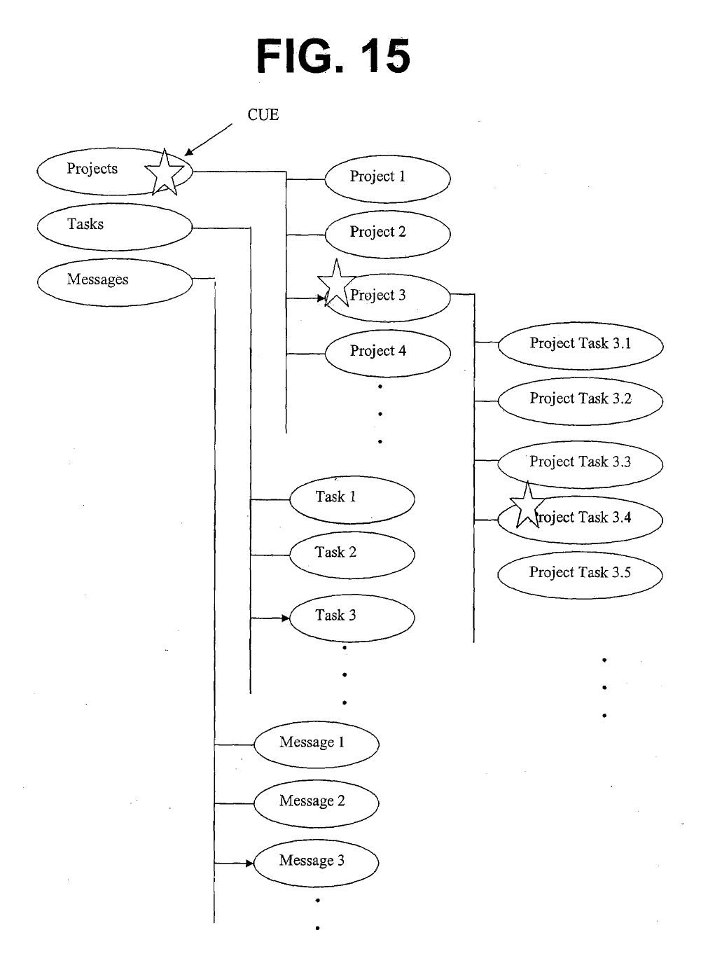

In another preferred embodiment, the user or individual, upon accessing the server, can be provided with a screen showing tasks, projects, project tasks, and/or messages, which need to be viewed and/or responded to by the user or individual. FIG. 15 illustrates an example screen shot of the display screen of the user computer 20 displaying to the user or individual the respective tasks, project(s), project task(s), and/or message(s), in or with which the user or individual is associated and/or otherwise deemed to be included. Any task, project, project task, and/or message, pertaining to the user or individual which may be available for viewing by the user or individual or which may be deemed important or required for the user or individual to view can be denoted by a cue, flag, or other indication, such as, for example, the star shown in FIG. 15. Thereafter, the user or individual can elect to access and view the pertinent message or messages.

With reference once again to FIG. 14, if at step 1405, the server 10 determines that the user or individual did not desire to add a new MDU to the stream, the operation of the apparatus 100 will proceed to step 1408. At step 1408, the server 10 will determine whether the user or individual has instructed the server 10 to create a new task from the stream. If at step 1408, the server 10 determines that the user or individual has instructed that a new task be created from the stream, then the operation of the apparatus 100 will proceed to step 1409 and a new task will be created in a manner described herein with reference to FIGS. 11A and 11B. Thereafter, the operation of the apparatus 100 will cease at step 1410.

If, at step 1408, the server 10 determines that a new task is not to be created, then the operation of the apparatus 100 will proceed to step 1411, and the server 10 will determine whether or not a reminder was requested regarding the task which is the subject of the stream. If at step 1411, it is determined that a reminder has been requested, the operation of the apparatus 100 will proceed to step 1412 and information regarding the reminder will be stored in the server 10, in a database of or associated with same, and/or in an external database, and the reminder will be provided in accordance with the user's or individual's instructions. Thereafter, the operation of the apparatus 100 will cease at step 1413.

If at step 1411, it is determined that a reminder has not been requested, the operation of the apparatus 100 will proceed to step 1414 and the task will either be completed by the user or individual, or, if not completed, the subject of the task can be revisited with a new message or a new MDU being subsequently added to the stream for the task. Thereafter, the operation of the apparatus 100 will cease at step 1415.

In another preferred embodiment, the apparatus 100 and method of the present invention can be used, in a manner similar to and/or analogous to the preferred embodiments described herein, in connection with instant messaging messages and instant messaging systems.

In any and/or all of the embodiments described herein, an e-mail message which originates from outside an enterprise, company, group, or association, can be sent to the “in-box” of a user or individual. The user or individual can, at any time, access and/or view the externally originated e-mail message. The user or individual can also, at any time, incorporate the externally originated e-mail message into an existing stream as a new MDU. The user or individual can also create a new defined task or assigned task, a new project, a new project task, new project talk, or a new message, in response to the externally originated e-mail message. The user or individual can also send a copy of any type of e-mail message described herein into two or more streams.

In any and/or all of the embodiments described herein, the apparatus 100 can also be utilized in order to take notes or minutes of or during a meeting between users or individuals and for creating an assigned task directly from these notes or minutes. In this manner, the apparatus 100 can be used to create defined tasks or assigned tasks from meeting notes or minutes. These defined tasks or assigned tasks can be stand alone tasks or project tasks of a new or existing project.

In any and/or all of the embodiments described herein, the apparatus 100 can also be utilized in order to provide a user or individual with the ability to access recently visited streams.

In any and/or all of the embodiments described herein, a user or individual can also access any and/or all of the streams of, or associated with, any and/or all of the defined tasks or assigned tasks, projects, project tasks, project talk, and/or messages, which he or she is or may be responsible for or in which he or she is or may be involved. The user or individual can also access any and/or all of the streams of, or associated with, any and/or all of the defined tasks or assigned tasks, projects, project tasks, project talk, and/or messages, in which any aid of the user or individual is or may be responsible for or is or may be involved.

In any and/or all of the embodiments described herein, the apparatus 100 can also be utilized in order to allow an authorized user or individual to, at any time, access any and/or all of the streams of, or associated with, any and/or all of the defined tasks or assigned tasks, projects, project tasks, project talk, and/or messages, which are in existence in his or her enterprise, company, group, or association, for which the user or individual is authorized.

In any and/or all of the embodiments described herein, any user or individual described herein can be assigned any number of e-mail addresses with which he or she can utilize the apparatus 100 and method of the present invention.

In still another embodiment, any user or individual, can request, and/or can be provided with, periodic reminder messages for any of the defined tasks or assigned tasks, projects, project tasks, project talk, and/or messages, or streams for same, described herein. In a preferred embodiment, a user or individual can create reminder message for himself or herself as well as a reminder message for any other user(s) or individual(s). In any and/or all of the embodiments described herein, a reminder message can be set up to generate an MDU or MDUs which can be inserted into or otherwise added to any of the herein-described streams.

In any and/or all of the embodiments described herein, the apparatus 100 and method of the present invention can also be utilized in conjunction with security features which dispense with the need for a network administrator. With regard to messages, tasks, projects, project tasks, and/or project talk, users or individuals may need to have access to other common sharable information. The apparatus 100 and method of the present invention can be utilized in conjunction with security features which can include utilizing authorized access levels and/or privileges to allow a user or individual to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with the apparatus 100 and method of the present invention, along with the ability for a user or individual, who has a certain authorized access level, or certain privileges, to be able to control the access levels and/or privileges of others in the enterprise, company, group, or association.

In a preferred embodiment, a user or individual having a certain authorization level and/or privileges can also pass along and/or define an authorization level, or a lower level of authorization, or can pass along and/or define his or her privilege rights, or lesser privilege rights, to another user or individual.

In a preferred embodiment, authorization levels and privileges can also include the ability of a user or individual to, in turn, pass along these authorization levels, or a lower authorization level(s), and/or privilege rights, or lesser privilege rights, to another user or individual, with authorization levels and privileges being defined or assigned throughout a communication infrastructure or platform in the enterprise, company, group, or association. In this manner, the need for a centralized network administrator can be dispensed with.

The apparatus 100 and method of the present invention can be utilized to provide any of the herein-described users or individuals with access to any number of features and functionality which are capable of being provided by the apparatus 100 and method of the present invention. In a preferred embodiment, the apparatus 100 and method of the present invention can provide a user or individual with the ability to access any and/or all of the features and functionality, capable of being provided by the apparatus 100 and method of the present invention, via a home page which can be accessed via the user computer 20.

The user or individual can access any feature(s) or functionality provided by the apparatus 100 and method of the present invention by interacting with and/or by navigating a home page.

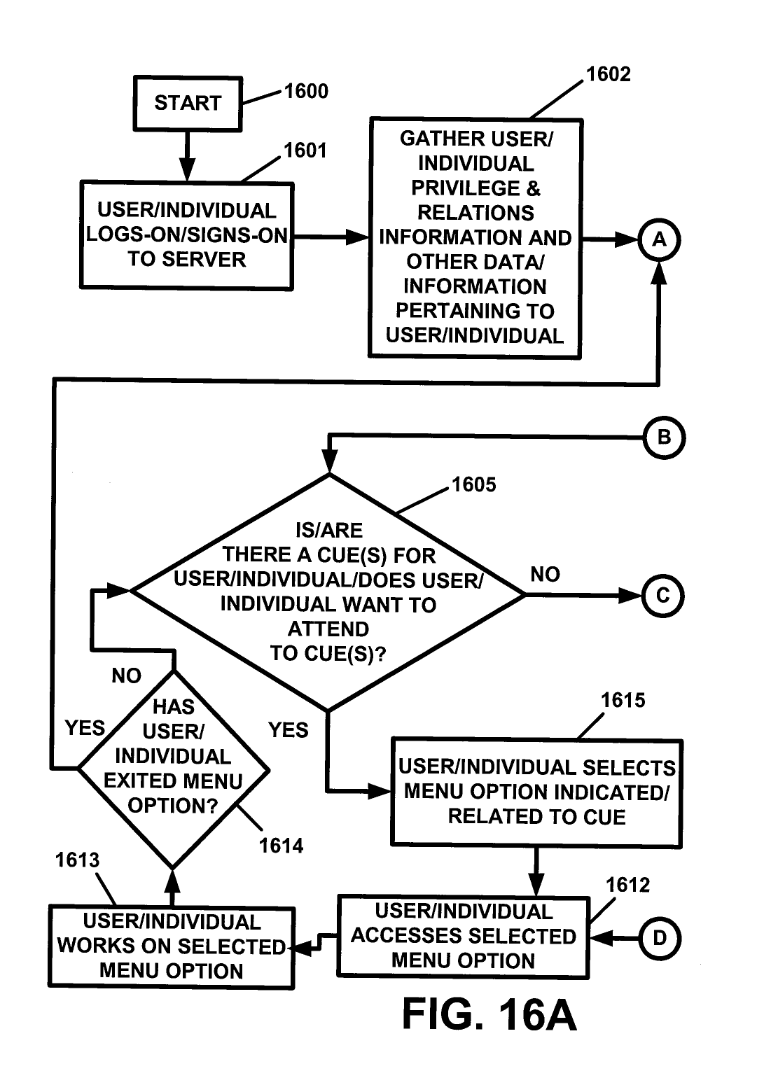

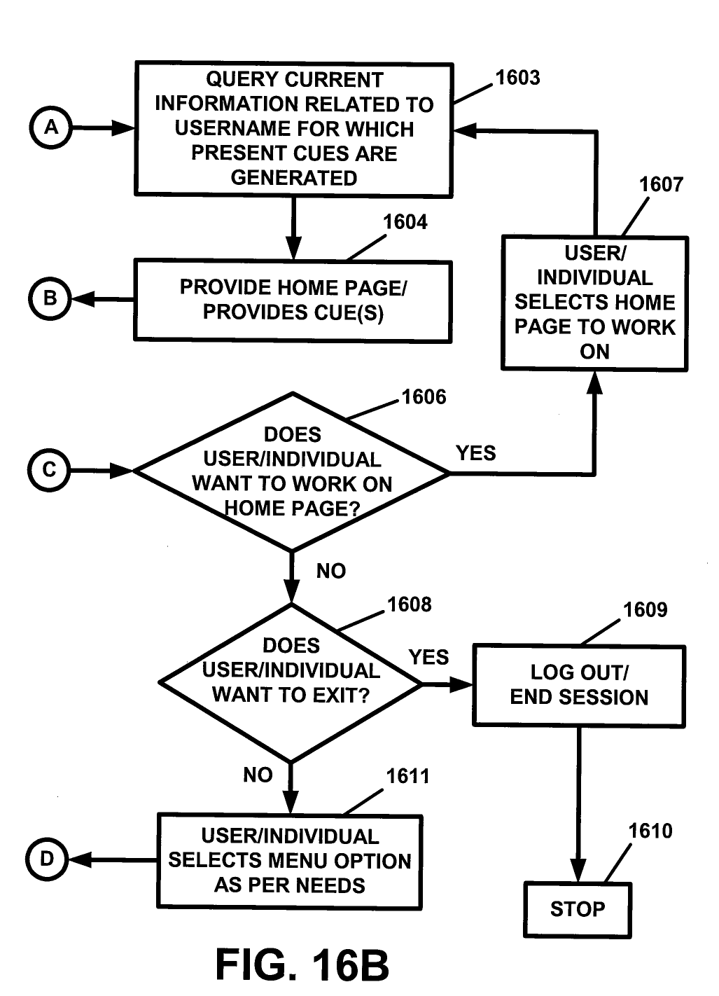

FIGS. 16A and 16B illustrate a preferred embodiment method for allowing a user or individual to access any the features and/or functionality described herein as being provided by the apparatus 100 and method of the present invention, in flow diagram form. Any user(s) or individual(s) described herein as using the apparatus 100 and method of the present invention can register with, or can be registered with, the apparatus 100, a server 10, a user computer 20, or any other device utilized in connection with the apparatus 100 and method of the present invention. For example, any user or individual can register with, or can be registered with, the apparatus 100, a server 10, a user computer 20, or any other device utilized in connection with the apparatus 100 and method of the present invention, such as by providing or assigning a username and/or a password for the user or individual.

In another embodiment, the user or individual can also register with, or can be registered with, a physical or biometric proof of identity or identification means which, for example, can include, but not be limited to, the user's or individual's thumb print or thumb print information, the user's or individual's fingerprint or fingerprint information, the user's or individual's eye retinal scan or retinal scan information, and/or any other data or information unique to the user or individual and/or which can be input via an input sensory device. In this regard, any of the user computers 20 described herein can, for example, be equipped with a thumbprint reader or scanning device, a retinal scanning device, or any other suitable input sensory device for obtaining data or information from, and/or unique to, the user or individual.

With reference to FIGS. 16A and 16B, the operation of the apparatus 100 commences at step 1600. At step 1601, the user or individual, via a login or sign-in page, can access the apparatus 100 and can login or log-on to, or sign-in to, the server 10 via the user computer 20. The user or individual can login or log-on to, or sign-on to, the server 10 by entering a username and/or a password and/or the user or individual can enter a unique identifier such as his or her thumbprint, retinal scan, or other personal data or information unique to the user or individual. At step 1601, the server 10 will receive and process the user's or individual's login or log-on, or sign-on, information, and if the user or individual is a registered or authorized user or individual, the operation of the apparatus 100 will proceed to step 1602. If, at step 1601, the user or individual is determined to not be a registered or authorized user or individual, then the operation of the apparatus 100 will not proceed and the apparatus 100 will await a next login or log-on, or sign-on, attempt.

Upon a successful login or log-on, or sign-on, to the server 10, the server 10 will process information regarding the user or individual and will gather information regarding privileges information and/or relations information associated with the user or individual and which are stored in the server 10, in the database of or associated with same, and/or in an external database. It is important to note that user or individual privileges information and/or relations information can be stored in the server 10, in the database of or associated with same, and/or in an external database, at any time and/or can be updated, by any authorized person, user, or individual.

At step 1602, the server 10 can gather any information necessary or crucial for ascertaining the user's or individual's privileges, ascertaining or setting the user's or individual's community or enterprise, the user's or individual's user-to-user or individual-to-individual relations information, and/or any other data or information corresponding to or regarding the user or individual.

At step 1603, the server 10 will then perform a query of current information regarding the user or individual, which can be stored in the database of or associated with the server 10, or in any other external or other database, and can ascertain any present cue or cues pertaining to the user or individual. A cue, in the preferred embodiment, is or can be information regarding the user's or individual's ability to access information, the user's or individual's ability to use the apparatus 100, and/or instructions or action items which the user or individual may or must follow or address. A cue(s) can also be any one and/or more of indications such as a word(s), a number(s), a sound(s), highlighted information, blinking information or indications, and/or colors or colored indications, which can be used to provide or convey information to the user or individual regarding a subject with which the user or individual needs to attend to when using the apparatus 100.

Examples of cues can include, but are not limited to, indications regarding a “New Message” indication, a “Flag” indication, a “Waiting for Me” indication, a “Waiting for Other(s)” indication, a “Task Idle too long” indication, an “Auto Generated Reminder” indication, and/or a “Task(s) Overdue” indication. After being provided with such a cue, the user or individual can choose to address same by following a corresponding link or route as indicated by the cue.

The information ascertained regarding cues associated with the user or individual can then be utilized to provide the user or individual with access to, and with the ability to interface with, certain functionality provided via the homepage of the apparatus 100.

At step 1604, the server 10 will then provide the homepage to the user computer 20 utilized by the user or individual. The homepage will provide the user or individual with the ability to access any and/or all of the features and functionality provided by the apparatus 100 of and method of the present invention. At step 1604, if there are any cues associated with the user or individual, these cues, or indications or information relating or corresponding thereto, will also be provided to the user or individual on or via the homepage.

At step 1605, the server 10 will determine whether or not the user or individual wants to attend to performing any action or actions pertaining to or relating to addressing any cue or cues provided via the homepage. If, at step 1605, it is determined that the user or individual does not want to attend to performing any action or actions pertaining to or relating to any cue or cues provided via the homepage, then the operation of the apparatus 100 will proceed to step 1606 and the user or individual will be asked if he or she wants to work with or on the homepage.

At step 1606, the user or individual can then enter a response indicating whether or not he or she wants to work on the homepage. At step 1606, the server 10 will determine whether or not the user or individual wants to work on the home page. If, at step 1606, it is determined that the user or individual wants to work on the homepage, then the operation of the apparatus 100 will proceed to step 1607 and the user or individual can perform any action or actions on or via the homepage. Thereafter, the operation of the apparatus 100 will proceed to step 1603 and the server 10 will again perform a query of current information regarding the user or individual, which can be stored in the database of or associated with the server 10, or in any other external or other database, and can ascertain any present cue(s). Thereafter, the operation of the apparatus 100 will again proceed to step 1604.

If, at step 1606, it is determined that the user or individual does not want to work on the home page, then the operation of the apparatus 100 will proceed to step 1608 and the user or individual will be asked whether or not he or she wants to log-off or sign-off from the server 10 and exit the system of the apparatus 100. At step 1608, the server 10 will receive and process the user's or individual's response and determine whether or not the user or individual wants to log-off or sign-off from the server 10 and exit the server 10 and, therefore, the system of the apparatus 100 or, if not, whether or not the user or individual wants to perform a specific task or tasks. If, at step 1608, it is determined that the user or individual wants to log-off or sign-off from the server 10, then the operation of the apparatus 100 will proceed to step 1609 and the user's or individual's user computer 20 will be logged-off or signed-off by and from the server 10. Thereafter, the operation of the apparatus 100 will cease at step 1610.

If, at step 1608, it is determined that the user or individual does not want to log-off or sign-off from the server 10, then the operation of the apparatus 100 will proceed to step 1611 and the user or individual can select a specific task or tasks from the homepage that he or she wants to perform or work on. After the user or individual enters his or her response or selection at step 1611, the operation of the apparatus 100 will proceed to step 1612 and the user or individual can select and access any appropriate menu option or any page or pages related to the selected menu option. Thereafter, the operation of the apparatus 100 will proceed to step 1613 and the user or individual can perform any task or tasks he or she desires to perform. Any work performed by the user or individual can be stored by the server 10 in a database of or associated with the server 10 or in any external database.

Once the user or individual has completed the task or tasks he or she desires to perform at step 1613, he or she can either exit the menu option or perform any additional task or tasks, such as, for example, address any cue or cues requiring his or her attention.

At step 1614, the server 10 will determine whether or not the user or individual has exited the menu option. At step 1614, the server 10 can also perform a processing routine to determine whether or not any cue or cues remain for the user or individual or whether or not any new cue or cues have been created. If, at step 1614, it is determined that the user or individual has exited the menu option, then the operation of the apparatus 100 will proceed to, or return to, step 1603 and the server 10 will once again perform a query of current information regarding the user or individual, which can be stored in the database of or associated with the server 10, or in any other external database, and can ascertain or identify any present or existing cue or cues pertaining to the user or individual. Thereafter, the operation of the apparatus 100 will proceed in the manner described above from step 1603.

If, at step 1614, it is determined that the user or individual has not exited the menu option, then the operation of the apparatus 100 will proceed to, or return to, step 1605 and the server 10 will once again determine whether or not the user or individual wants to attend to performing any action or actions pertaining to or relating to any cue or cues provided to him or her on the homepage or a current menu option which may be selected by the user or individual. Thereafter, the operation of the apparatus 100 will proceed in the manner described above from step 1605. If, at step 1605, it is determined that the user or individual wants to attend to performing any action or actions pertaining to or relating to any cue or cues provided to him or her on the homepage, then the operation of the apparatus 100 will proceed to step 1615 and the user or individual can select the specific menu option as indicated by any cue. Thereafter, the operation of the apparatus 100 will proceed to step 1612 and the operation of the apparatus 100 will proceed as described herein.

In the above-described manner, the user or individual can navigate about the homepage associated with the apparatus 100 or select any menu option(s) in order to perform any task or tasks and/or to attend to any cue or cues.

In a preferred embodiment, the apparatus 100 and method of the present invention can also be utilized to control user or individual access to any of the messages, tasks, projects, project tasks, and/or project talk, and/or files or folders containing or relating to same, which are described herein.

As noted herein, users or individuals may need to have access to other common sharable information. The apparatus 100 and method of the present invention can be utilized in conjunction with security features which can include utilizing authorized access levels and/or privileges which can be used to allow a user or individual to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with the apparatus 100 and method of the present invention.

These security features can also define an ability of a user or individual having a certain authorized access level or certain privileges, to be able to control the access levels and/or privileges of others in the enterprise, company, group, or association. These herein-described security features, and any other features or functionality relating thereto, of the present invention, can also be referred to herein as “Tagged Authorized Chain Link Privileges” or “TACL”. Further, this “Tagged Authorized Chain Link Privileges” or “TACL” can be defined herein to be features, functionality, or privileges, which pertain to or define a user's or individual's ability to have access to, to read, to read only, to read and/or modify, to store information regarding a control level provided to another user or individual for controlling an access level(s), privilege(s), or controls level(s) of other users or individuals, and/or to otherwise act in any appropriate manner, regarding any shared information of any kind or type which is utilized in connection with the apparatus 100 and method of the present invention and can define the ability of a user or individual having a certain authorized access level or certain privileges, to be able to control the access levels and/or privileges of others in the enterprise, company, group, or association.

A user or individual can access and perform tasks relating to the TACL functionality via the homepage described herein as being provided in connection with the embodiment of FIGS. 16A and 16B. In this regard, the user or individual can initiate the TACL functionality via the homepage by selecting, for example, a TACL File/Folders option on the homepage, such as, for example, during any one or more of steps 1604 through 1607 in the preferred embodiment of FIGS. 16A and 16B.

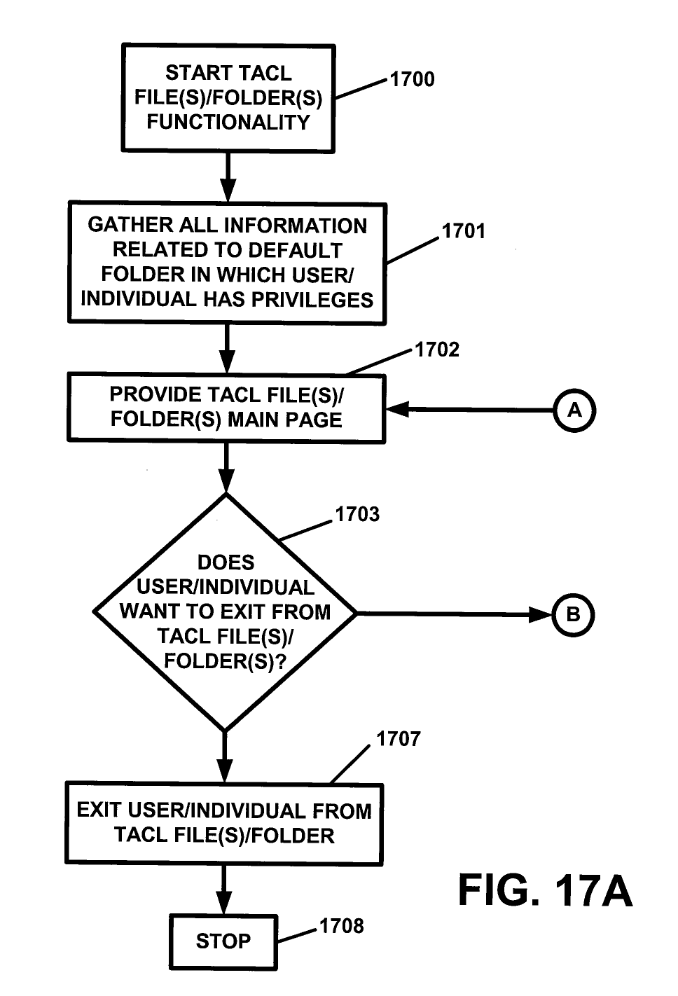

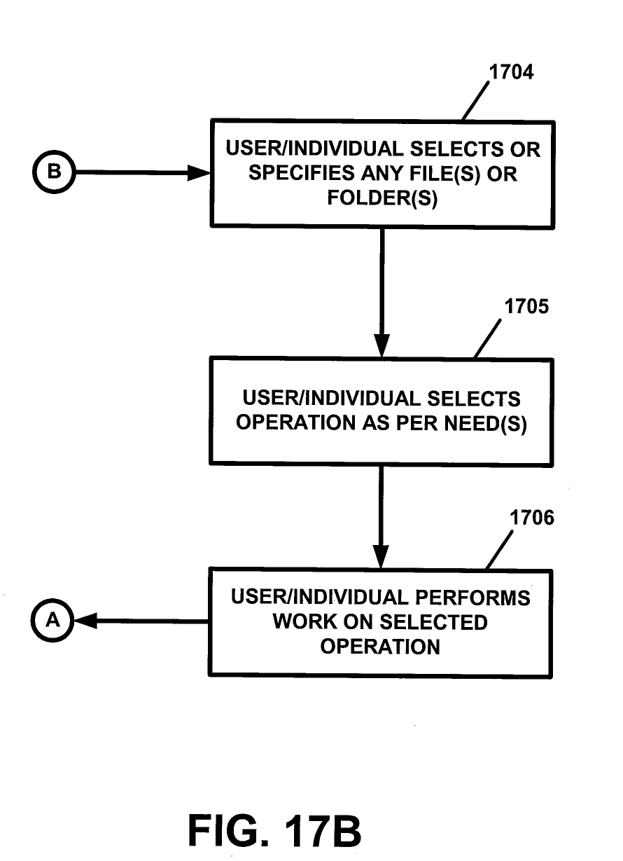

FIGS. 17A and 17B illustrate a preferred embodiment method of utilizing the apparatus 100 and method of the present invention to allow a user or individual to perform a task or tasks using the TACL functionality, in flow diagram form. The TACL functionality, in a preferred embodiment, can be utilized to provide the user or individual with access to files and/or folders (hereinafter also referred to as “objects”) of any of the information and/or messages described herein as being provided by the apparatus 100 of the present invention. In a preferred embodiment, the user or individual can also be provided with options and/or with the ability to move from folder to folder, to grant access to same, to create and/or modify a folder or folders, to grant access to a folder or folders to other users or individuals, such as, for example, by assigning privileges, and/or to perform any other operations on or with any of the files, folders, or objects, described herein.

With reference to FIGS. 17A and 17B, the operation of the apparatus 100 will commence at step 1700 with the user or individual selecting or initiating the TACL functionality via the homepage. At step 1701, the server 10 can gather any and all information related to a Default Folder or Directory in or for which the user or individual has been assigned privileges. Thereafter, at step 1702, the user or individual will be provided with the TACL File(s)/Folder(s) Main Page on his or her user computer 20. The user or individual can then perform any TACL related tasks via the TACL File(s)/Folder(s) Main Page. The TACL File(s)/Folder(s) Main Page can list all content of one or more folders on which the user or individual can work or perform a task. Upon completing all desired tasks, the user or individual can select to exit the TACL File(s)/Folder(s) Main Page.

At step 1703, the server 10 will determine whether or not the user or individual has selected to exit the TACL File(s)/Folder(s) Main Page. If, at step 1703, it is determined that the user or individual has not selected to exit the TACL File(s)/Folder(s) Main Page, then the operation of the apparatus 100 will proceed to step 1704 and the user or individual can select and/or can specify any file(s) or folder(s) on which he or she desires to work. Thereafter, at step 1705, the user or individual can select an operation(s) that he or she desires to perform with or in connection with the selected and/or specified file(s) or folder(s). Thereafter, the user or individual, at step 1706, can perform the actual tasks or work on these selected and/or specified file(s) or folder(s) and, upon completing the tasks or work, the operation of the apparatus 100 will proceed back to step 1702.

If, however, at step 1703, it is determined that the user or individual has selected to exit the TACL File(s)/Folder(s) Main Page, then the server 10 will exit the user or individual from same at step 1707. Thereafter, the operation of the apparatus 100 will cease at step 1708.

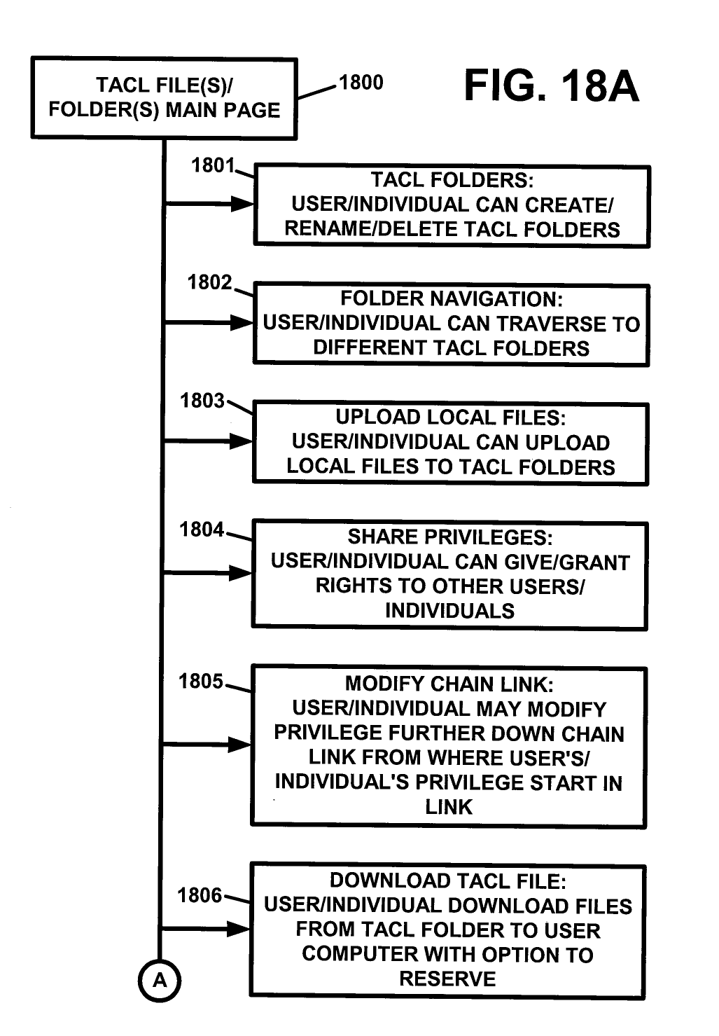

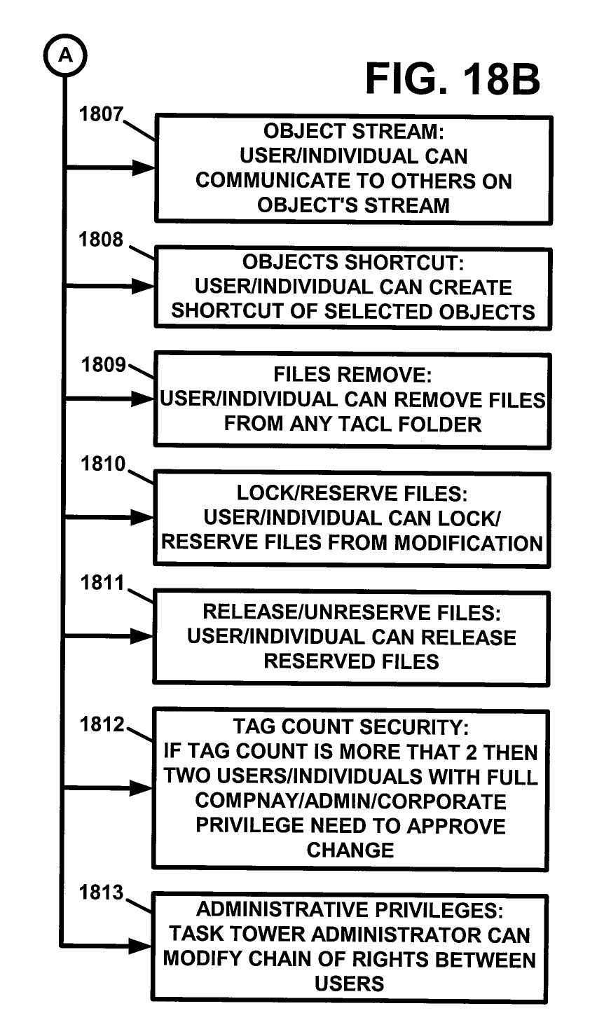

In a preferred embodiment, the TACL File(s)/Folder(s) Main Page can provide the user or individual with access to numerous features and functionality of the apparatus 100 and method of the present invention. FIGS. 18A and 18B illustrate the features and functionality of the apparatus 100 and method of the present invention which can be accessed via the TACL File(s)/Folder(s) Main Page. With reference to FIGS. 18A and 18B, the TACL File(s)/Folder(s) Main Page, which is designated by the reference numeral 1800, can be linked to, and can provide the user or individual with access to, a TACL Folders Page 1801, a Folder Navigation Page 1802, an Upload Local Files Page 1803, a Share Privileges Page 1804, a Modify Chain Link Page 1805, a Download TACL File Page 1806, an Object Stream Page 1807, an Objects Shortcut Page 1808, a Files Remove Page 1809, a Lock/Reserve Files Page 1810, a Release/Unreserve Files Page 1811, a Tag Count Security Page 1812, and an Administrative Privileges Page 1813.

The TACL Folders Page 1801 can be used by the user or individual to create, rename, or delete, a TACL folder or TACL folders. The Folder Navigation Page 1802 can be used by the user or individual to navigate to different or various TACL folders. The Upload Local Files Page 1803 can be used by the user or individual to upload a local file or files to a TACL folder or TACL folders. The Share Privileges Page 1804 can be used by the user or individual to give, grant, or set, privileges, to other users or individuals depending upon the user's or individual's own privileges. The Share Privileges Page can also be used by the user or individual to add a link for or corresponding to another user or individual.

The Modify Chain Link Page 1805 can be used by the user or individual to modify a privilege or privileges further down a chain link from where the user's or individual's privileges start or originate. The Download TACL File Page 1806 can be used by the user or individual to download a file or files from a TACL folder or TACL folders to a private area or any other area specified by the user or individual. The Object Stream Page 1807 can be used by the user or individual to communicate with other users or individuals who are using the object's stream. The Objects Shortcut Page 1808 can be used by the user or individual to create a shortcut to a selected file or files. A shortcut is a link which can allow a user or individual to navigate to a folder or file more quickly and easily.

The Files Remove Page 1809 can be used by the user or individual to remove a file or files from any privileged TACL folder or folders. The Lock/Reserve Files Page 1810 can be used by the user or individual to lock a file or files from modification or deletion. The Release/Unreserve Files Page 1811 can be used by the user or individual to release reserved objects. The Tag Count Security Page 1812 can be used by the user or individual to place, or assign, a greater amount of security on a file or files or on a folder or folders such as by marking an object or objects as being accessible only through an approval of more than one users or individuals. Lastly, the Administrative Privileges Page 1813 can be used by an administrator of the apparatus 100 to modify a chain of rights between a user(s) or individual(s) and an object or objects.

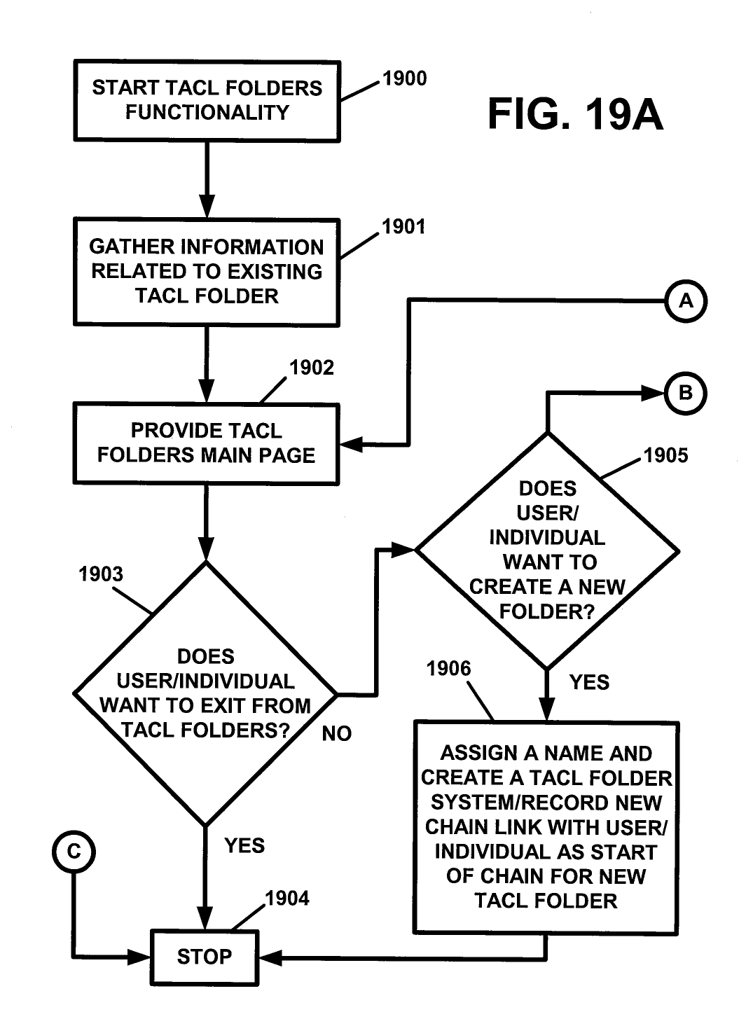

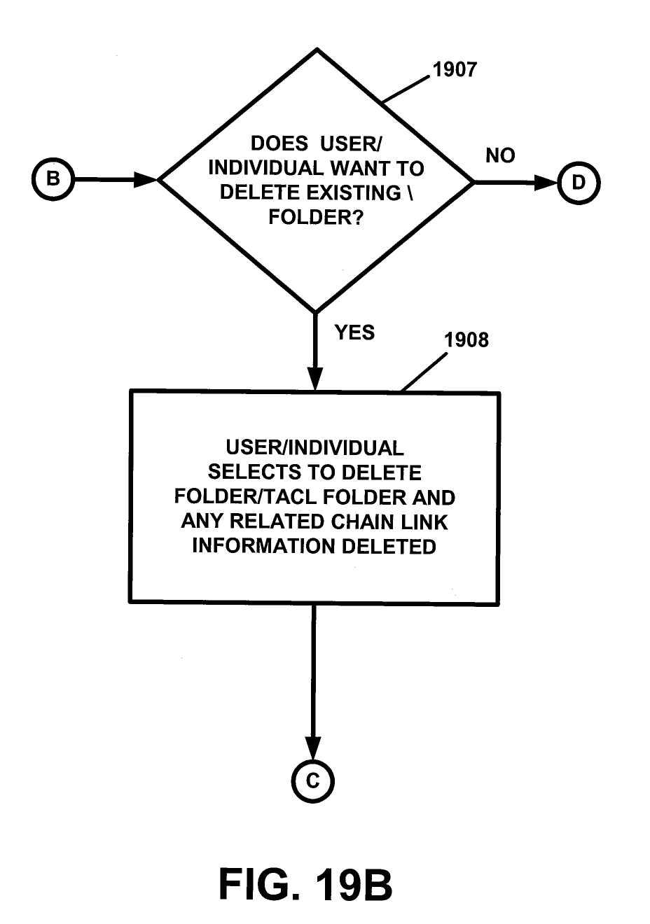

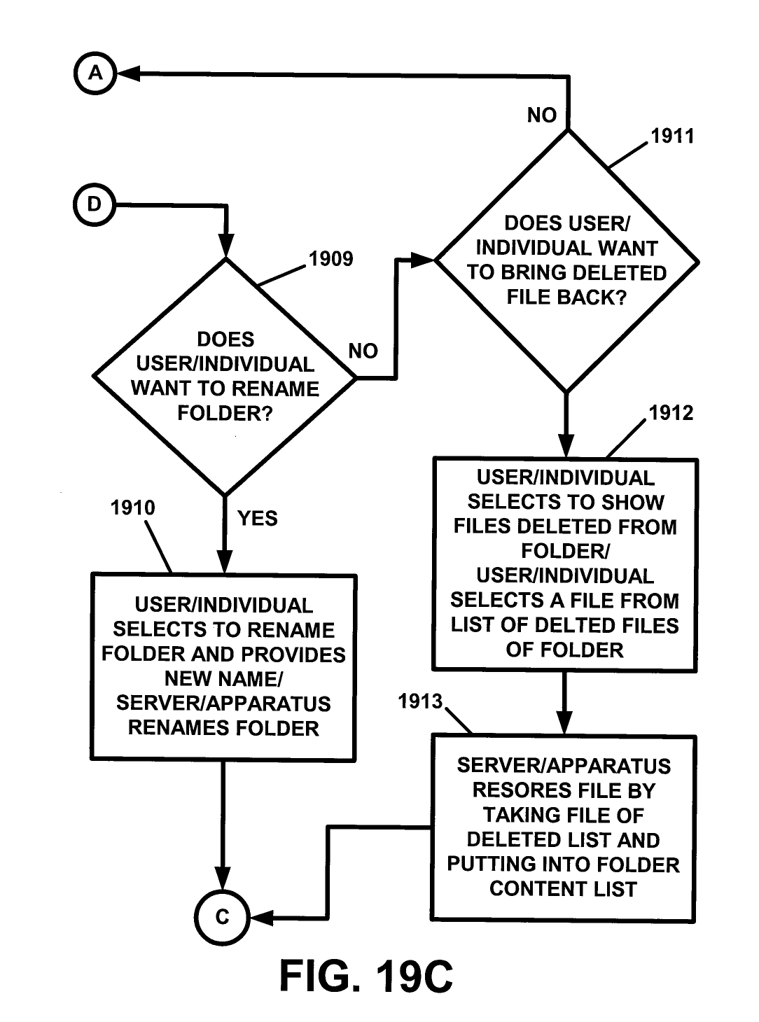

FIGS. 19A, 19B, and 19C illustrate a preferred embodiment operation of the TACL Folders functionality of the apparatus 100 and method of the present invention, in flow diagram form. In a preferred embodiment, a user or individual can be assigned or granted the appropriate and/or proper privileges to perform any task(s), and/or to make any change(s), to or regarding any folder. With reference to FIGS. 19A, 19B, and 19C, the operation of the apparatus 100 commences at step 1900 with the user or individual selecting to work with the TACL Folders functionality from the TACL File(s)/Folder(s) Main Page. At step 1901, the server 10 will gather any and all information relating to the user or individual regarding existing privileges the user or individual has regarding any existing TACL folders. At step 1902, the TACL Folders Main Page is provided to the user's or individual's user computer 20. Once at the TACL Folders Main Page, the user or individual can select to either exit from the TACL Folders Main Page or to create, rename, or delete, a folder.

At step 1903, the server 10 will determine whether or not the user or individual has selected to exit the TACL Folders Main Page. If, at step 1903, it is determined that the user or individual has selected to exit the TACL Folders Main Page, then the operation of the apparatus 100 will proceed to step 1904, and the apparatus 100 will cease at step 1904. If, however, at step 1903, it is determined that the user or individual did not select to exit the TACL Folders Main page, then the operation of the apparatus 100 will proceed to step 1905 and the server 10 will determine whether or not the user or individual has selected to create a new folder. If, at step 1905, it is determined that the user or individual has selected to create a new folder, then the operation of the apparatus 100 will proceed to step 1906 and a new TACL folder will be created by the server 10, the user or individual can assign a name to the TACL folder, and the server 10 will record and store information regarding a new chain link associating the user or individual with the newly created TACL folder indicating that the user or individual is the start or origination of the chain for the TACL folder. Thereafter, the operation of the apparatus 100 will cease at step 1904.

If, however, at step 1905, it is determined that the user or individual did not select to create a new TACL folder, then the operation of the apparatus 100 will proceed to step 1907 and the server 10 will determine whether or not the user or individual has selected to delete the TACL folder and, assuming that the user or individual is authorized to do so, then the operation of the apparatus 100 will proceed to step 1908 and the server 10 will delete the TACL folder and any chain link information related to the TACL folder. Thereafter, the operation of the apparatus 100 will cease at step 1904.

If, however, at step 1907, it is determined that the user or individual has not selected to delete a TACL folder, then the operation of the apparatus 100 will proceed to step 1909 and the server 10 will determine whether or not the user of individual has selected to rename a TACL folder. If, at step 1909, it is determined that the user or individual has selected to rename a TACL folder, then the operation of the apparatus 100 will proceed to step 1910, and the user or individual can rename the TACL folder and the server 10 will process the information for renaming the TACL folder. Thereafter, the operation of the apparatus 100 will cease at step 1904.

If, however, at step 1909, it is determined that the user or individual did not select to rename a TACL folder, then the operation of the apparatus 100 will proceed to step 1911 and the server 10 will determine whether or not the user or individual has selected to re-activate, or bring back, a previously deleted TACL folder. If, at step 1911, it is determined that the user or individual did not select to re-activate, or bring back, a previously deleted TACL folder, then the operation of the apparatus 100 will proceed back to step 1902 and the TACL Folders Main Page will again be provided to the user's or individual's user computer 20.

If, however, at step 1911, it is determined that the user or individual has selected to re-activate, or bring back, a previously deleted TACL folder, then the operation of the apparatus 100 will proceed to step 1912 and user or individual can enter information regarding the previously deleted TACL folder which the user or individual wants to re-activate or bring back. At step 1912, the user or individual can request, and can be provided with a list of previously deleted TACL folders from which the user or individual can make a selection, or the user or individual can simply specify and enter the name of the TACL folder. At step 1913, the server 10 will process the information regarding the selected TACL folder, will re-activate, or bring back, the TACL folder, and will remove the TACL folder from a list of deleted TACL folders. The name of the TACL folder can also be inserted into a folder content list. Thereafter, the operation of the apparatus 100 will cease at step 1904.

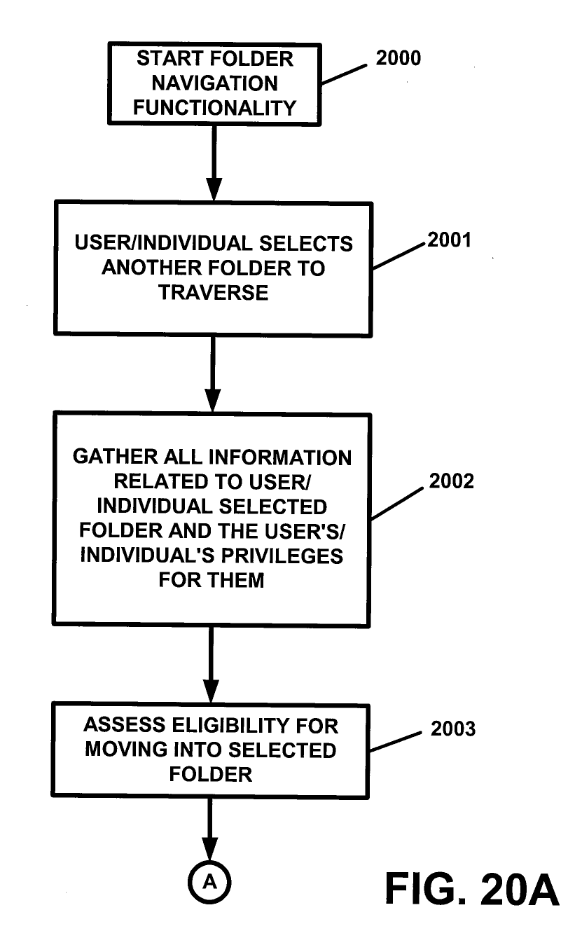

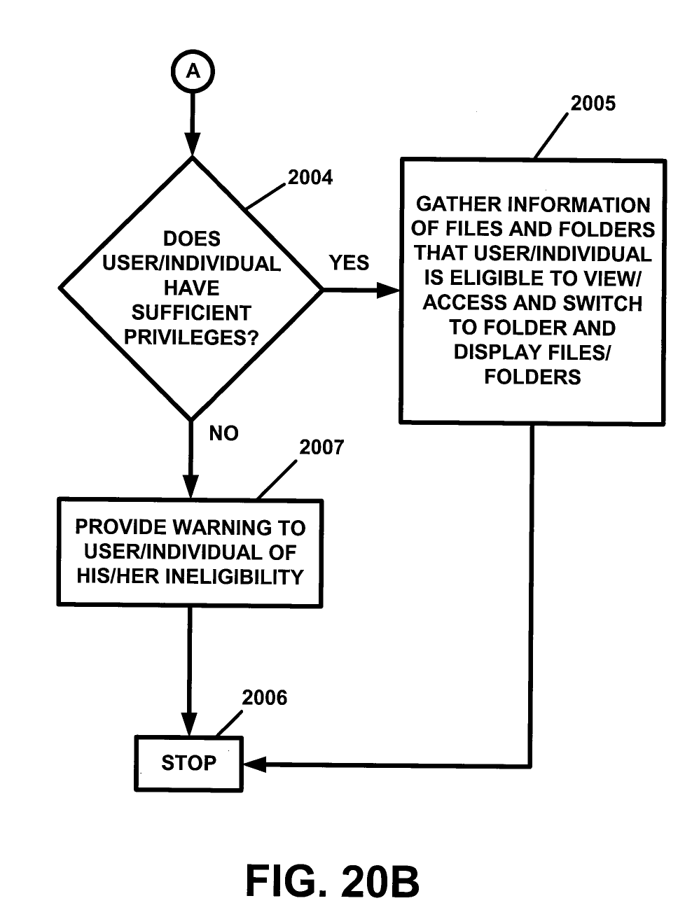

FIGS. 20A and 20B illustrate a preferred embodiment operation of the Folder Navigation functionality of the apparatus 100 and method of the present invention, in flow diagram form. The Folder Navigation functionality enables a user or individual to navigate from folder to folder in the apparatus 100. In a preferred embodiment, a user or individual can be assigned or can be granted the appropriate and/or proper privilege(s) to perform any of the folder navigation tasks described herein. With reference to FIGS. 20A and 20B, the operation of the apparatus 100 commences at step 2000 with user or individual selecting to work with the Folder Navigation functionality from the TACL File(s)/Folder(s) Main Page. At step 2001, the user or individual can select to navigate from the folder in which he or she is working to another specified folder. The user or individual can navigate from one folder to another folder within a current folder or can navigate from one folder to another folder.

At step 2002, the server 10 will gather all information related to the folder to which the user or individual desires to move or navigate and any relevant and/or all of the privileges associated with the user or individual. At step 2003, the server 10 will assess the user's or individual's eligibility to move to or to navigate to the selected folder. At step 2004, the server 10 will determine whether or not the user or individual is eligible, or has the sufficient privileges, to move to or to navigate to the selected folder. If, at step 2004, it is determined that the user or individual is eligible, or has the sufficient privilege(s), to move to or to navigate to the selected folder, then the operation of the apparatus 100 will proceed to step 2005 and the server 10 will gather information regarding the folders, files, or objects, which the user or individual is eligible to view or to access and the server 10 can provide the user or individual with the link(s) for accessing each folder. Thereafter, at step 2005, the user or individual can also access the folder and perform any desired task. Thereafter, the operation of the apparatus 100 will cease at step 2006.

If, however, at step 2004, the server 10 determines that the user or individual is ineligible, or lacks the required privilege(s), to access the selected folder, the server 10 will, at step 2007, transmit a warning message to the user computer 20 of the user or individual warning him or her that they are ineligible, or lack the privilege(s), to access the selected folder. Thereafter, the operation of the apparatus 100 will cease at step 2006.

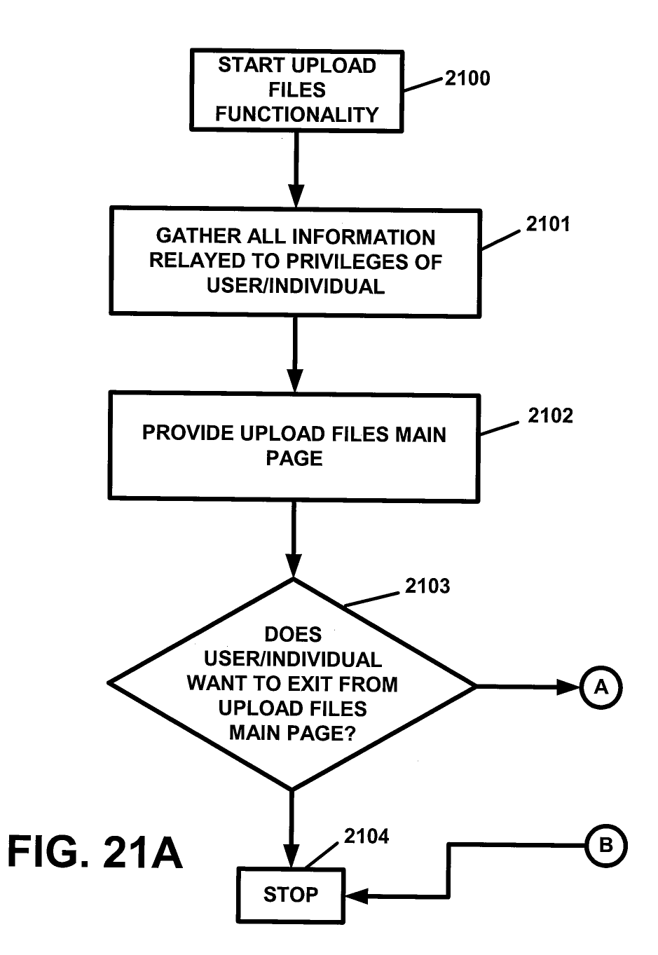

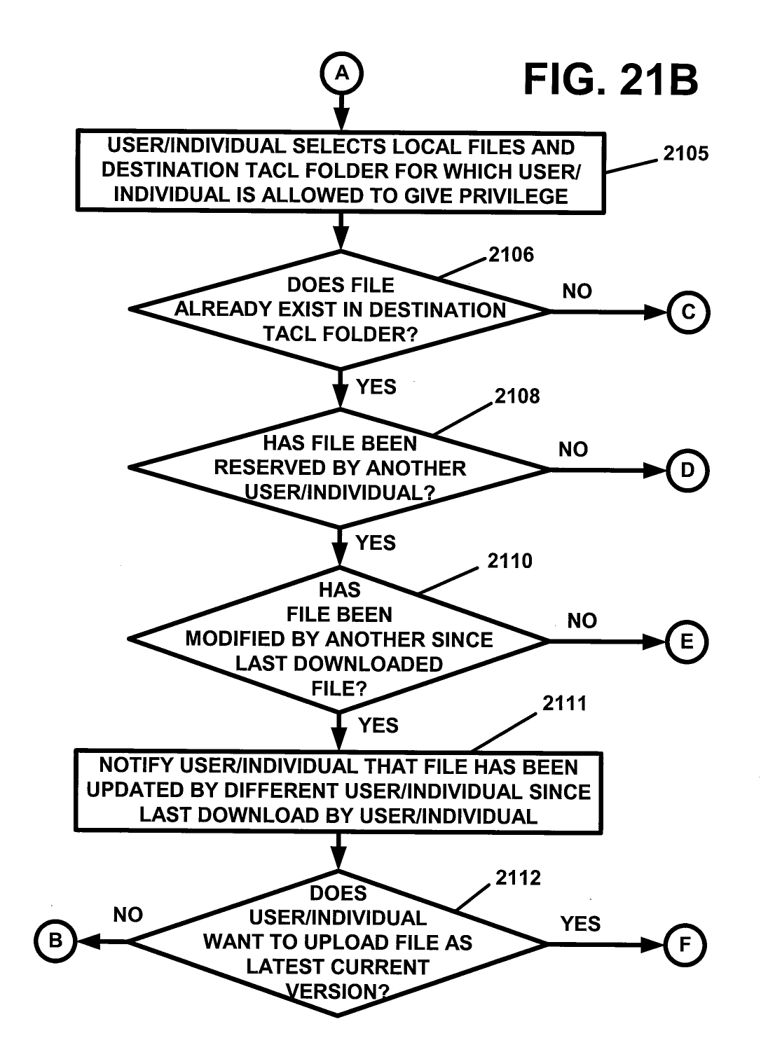

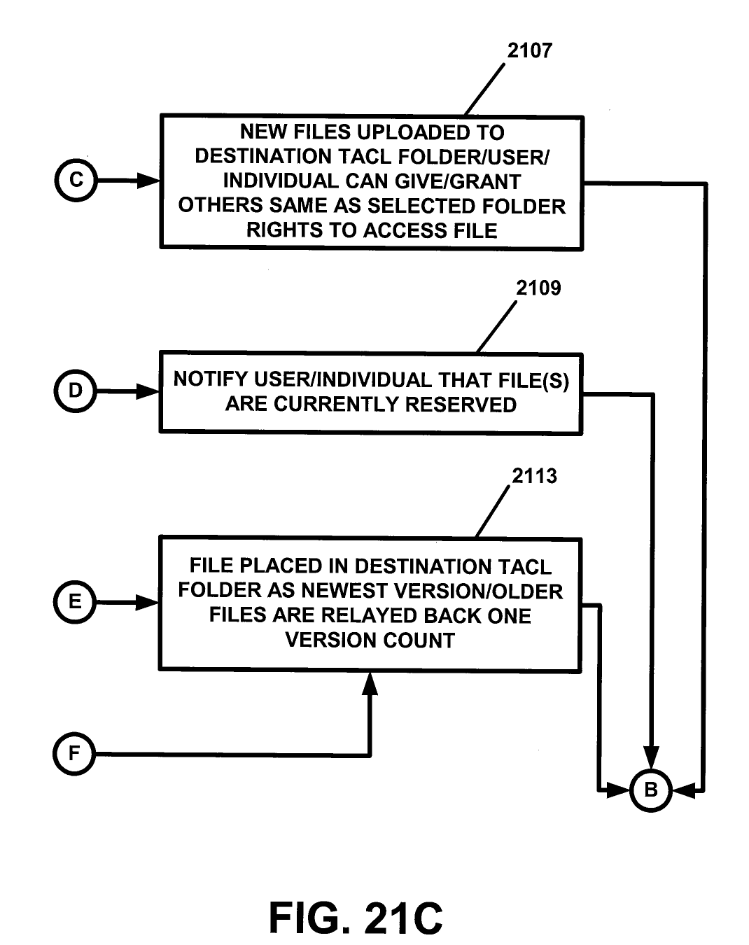

FIGS. 21A, 21B, and 21C illustrate a preferred embodiment operation of the Upload Files functionality of the apparatus 100 and method of the present invention, in flow diagram form. In a preferred embodiment, a user or individual can be assigned or granted the appropriate and/or proper privilege(s) to perform any of the upload files tasks described herein. With reference to FIGS. 21A, 21B, and 21C, the operation of the apparatus 100 commences at step 2100 with user or individual selecting to work with the Upload Files functionality from the TACL File(s)/Folder(s) Main Page. At step 2101, the server 10 will gather all information related to the user's or individual's privilege(s) relating to the Upload Files functionality.

At step 2102, the server 10 will provide the user or individual with the Upload Files Main Page on the user's or individual's user computer 20. At step 2102, the user or individual can select to exit from the Upload Files Main Page. At step 2103, the server 10 will determine whether or not the user or individual has selected to exit from the Upload Files main Page. If, at step 2103, it is determined that the user or individual has selected to exit the Upload Files Main Page, then the operation of the apparatus 100 will cease at step 2104. If, however, at step 2103, it is determined that the user or individual has not selected to exit the Upload Files Main page, then the operation of the apparatus 100 will proceed to step 2105.

At step 2105, the user or individual, assuming that the user or individual has sufficient privilege(s), can select a file or files and a destination TACL folder to which the file or files are to be uploaded. The file or files which the user or individual selects for uploading to the TACL folder can be local files on the user's or individual's user computer 20 or can be stored on an external device which is accessible to the user or individual. The ability or privilege of the user or individual to upload a file or files to the TACL folder can be referred to herein as a “write-to” privilege.

At step 2106, the server 10 will determine whether or not the file or files to be uploaded is a new file(s) or if it or they already exist in the destination TACL folder. If, at step 2106, it is determined that the file or files to be uploaded do not already exist in the destination TACL folder, then the operation of the apparatus 100 will proceed to step 2107 and the new file or files are uploaded to the destination TACL folder. At step 2107, the user or individual also has the option to give or assign any other user(s) or individual(s), with access rights to the destination TACL folder, the same folder file access rights to the uploaded file or files. Thereafter, the operation of the apparatus 100 will cease at step 2104.

If, at step 2106, it is determined that the file or files already exists in the destination TACL folder, then the operation of the apparatus 100 will proceed to step 2108 and the server 10 will determine whether or not the file or files have been reserved by another user of individual. If, at step 2108, it is determined that the file or files have been reserved by another user or individual, then the operation of the apparatus 100 will proceed to step 2109 and the server 10 will send the user or individual a message indicating that the file or files are currently reserved by another user or individual and that the user or individual is not allowed to upload the file or files at that particular time. Thereafter, the operation of the apparatus 100 will cease at step 2104.

If, however, at step 2108, it is determined that the file or files have not been reserved by another user or individual, then the operation of the apparatus 100 will proceed to step 2110 and the server 10 will determine whether or not the file or files have been modified by another user or individual since a last download of the file or files by the user or individual. If, at step 2110, it is determined that the file or files have been modified by another user or individual, then the operation of the apparatus 100 will proceed to step 2111, and the user or individual is provided with a notification message notifying him or her that a file or files has or have been updated by a different user or individual since it was last updated by the user or individual. At step 2111, the user or individual can also be notified or instructed to investigate any potential problem(s) with the file or files, such as, for example, a modification which has been made by a last user or individual.

At step 2111, the user or individual can also select to upload the file or files to the TACL folder as the latest current version(s) of the file or files. Thereafter, the operation of the apparatus 100 will proceed to step 2112 and the server 10 will determine whether or not the user or individual has selected to upload the file or files to the TACL folder as the latest current version of the file or files. If, at step 2112, it is determined that the user or individual has not selected to upload the file or files to the TACL folder as the latest current version of the file or files, then the operation of the apparatus 100 will cease at step 2104.

If, however, at step 2112, it is determined that the user or individual has selected to upload the file or files to the TACL folder as the latest current version of the file or files, then the operation of the apparatus 100 will proceed to step 2113 and the file or files will be uploaded to, and stored in, the destination TACL folder as the latest or newest version of the file of files. At step 2113, any older version(s) of the file or files will be relayed back one version count.

Thereafter, the operation of the apparatus 100 will cease at step 2104.

If, however, at step 2110, it is determined that the file or files have not been modified by another user or individual, then the operation of the apparatus 100 will proceed to step 2113 and the file or files will be uploaded to, and stored in, the destination TACL folder as the latest or newest version of the file or files. At step 2113, any older version(s) of the file or files will then be relayed back one version count. Thereafter, the operation of the apparatus 100 will cease at step 2104.

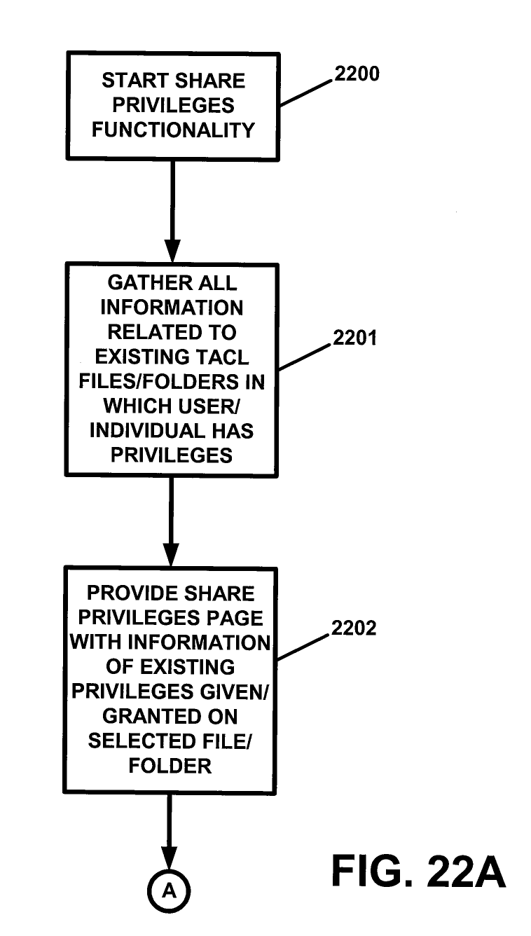

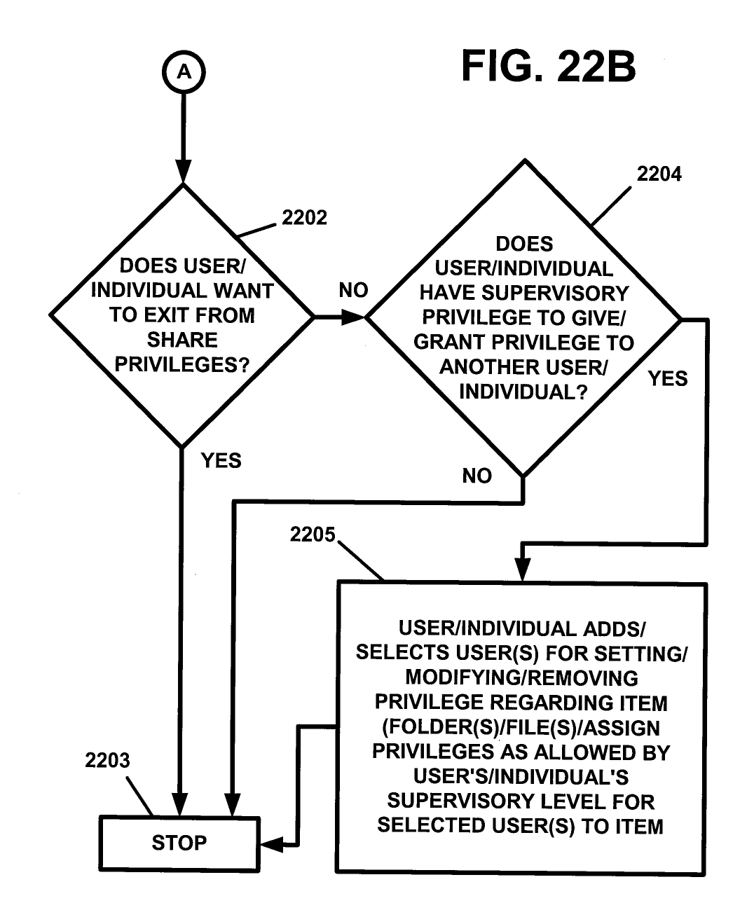

FIGS. 22A and 22B illustrate a preferred embodiment operation of the Shared Privileges functionality of the apparatus 100 and method of the present invention, in flow diagram form. In a preferred embodiment, the Shared Privileges functionality pertains to allowing a user or individual access to a file(s) or folder(s), which can also be referred to as an object(s). Depending upon whether or not a user or individual has supervisory privileges, the user or individual may be able to grant certain rights regarding an object(s) to another user or individual and/or to grant rights to the privilege to grant rights and/or privileges to other users or individuals.

In a preferred embodiment, a user or individual can be assigned or granted the appropriate and proper privilege(s) to perform any of the Shared Privileges tasks described herein. With reference to FIGS. 22A and 22B, the operation of the apparatus 100 commences at step 2200 with the user or individual selecting to work with the Shared Privileges functionality from the TACL File(s)/Folder(s) Main Page and the user or individual selecting the TACL file/folder/object.

At step 2201, the server 10 will gather all information related to the user's or individual's Shared Privileges functionality privileges relating to a selected TACL file/folder/object and can gather all information relating to the selected TACL file/folder/object's access information, such as, for example, chain link information on all the users or individuals currently privileged for the selected TACL file/folder/object, and the user's or individual's supervisory position, if any, regarding the selected TACL file/folder/object.

At step 2202, the user or individual will be provided with a Shared Privileges Main Page which will be displayed on the user's or individual's user computer 20. The Shared Privileges page can provide information to the user or individual regarding existing privileges of the user or individual regarding the selected TACL file/folder/object. The Shared Privileges Main Page can contain information for allowing the user or individual to set, establish, or remove, privileges for the selected TACL file/folder/object for or regarding other users or individuals. The Shared Privileges Main page can also provide information such as information regarding an item or privilege to be set or established, current users or individuals who have a privilege or privileges regarding the selected TACL file/folder/object, each user's or individual's privilege(s) origin (such as chain link information regarding who granted the link, the privilege level, or when it was granted, etc.) and a level of privilege for each user or individual.

At step 2201, the user or individual can also select to exit the Shared Privileges Main Page and/or to select to end the Shared Privileges functionality session. At step 2202, the server 10 will determine whether or not the user wants to exit the Shared Privileges Main Page. If, at step 2202, it is determined that the user or individual has selected to exit the Shared Privileges Main Page, then the operation of the apparatus 100 will cease at step 2203. If, however, at step 2202, it is determined that the user or individual has not selected to exit the Shared Privileges Main Page, then the operation of the apparatus 100 will proceed to step 2204 and the server 10 will determine whether or not the user or individual has any supervisory privilege(s) to grant another user or individual a privilege or privileges to or regarding the selected TACL file/folder/object.

If, at step 2204, it is determined that the user or individual does not have any supervisory privilege(s) to grant another user or individual a privilege or privileges to or regarding the selected TACL file/folder/object, then the operation of the apparatus 100 will cease at step 2203. If, however, at step 2204, it is determined that the user or individual does have supervisory privilege(s) to grant another user or individual a privilege or privileges to or regarding the selected TACL file/folder/object, then the operation of the apparatus 100 will proceed to step 2205 and the user or individual can add and/or select another user(s) or individual(s) to a list of privileged users or individuals for the selected TACL file/folder/object, can set, establish, grant, change, modify, or remove, a privilege or privileges of another user(s) or individual(s) regarding the TACL file/folder/object, or can grant a user(s) or individual(s) with the ability to grant access privileges to the selected TACL file/folder/object.

At step 2205, any privilege(s) granted, established, changed, modified, or removed, will or can be dictated by the user's or individual's supervisory level and/or by any privileges pertaining thereto. In a preferred embodiment, the apparatus 100 can be programmed such that, if a privilege is taken away from a particular user or individual, then any other users or individuals (the linked users or individuals) who were previously granted privileges to access the selected TACL file/folder/object by that user or individual will also lose that privilege, which can be referred to as “linked privileges”. As a result, where applicable, those linked users or individuals could conceivably lose all access (because of the chain link being broken) unless another user or individual has granted access privileges to the linked users or individuals. Thereafter, the operation of the apparatus 100 will cease at step 2203.

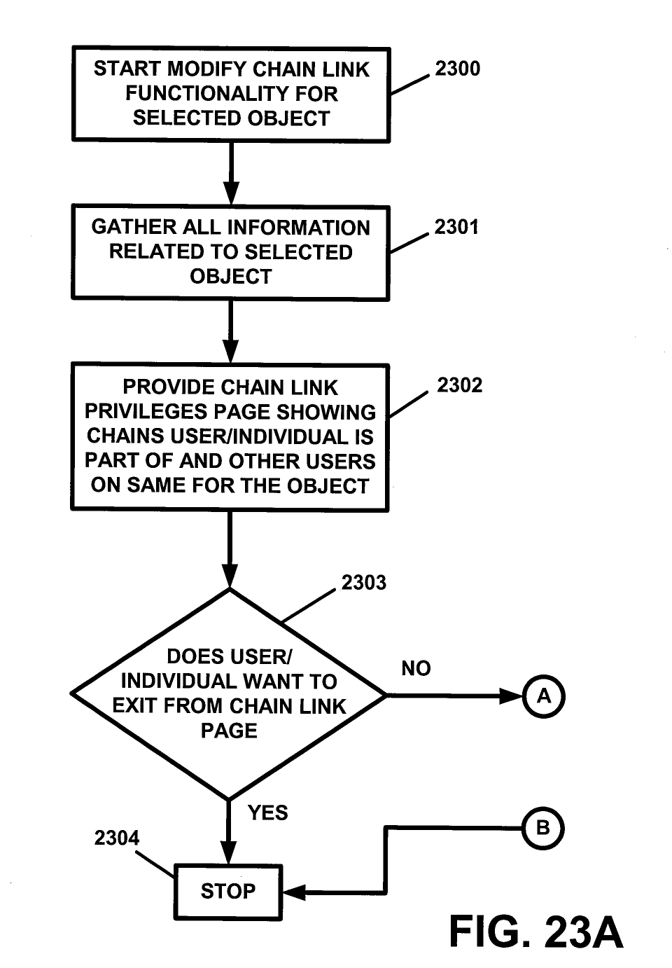

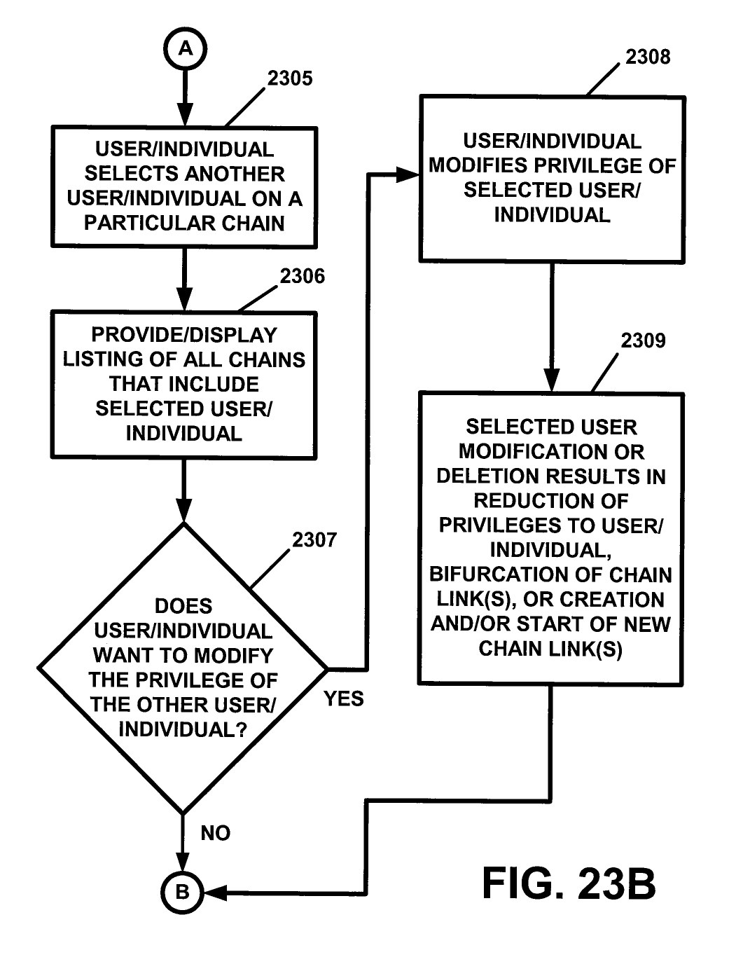

FIGS. 23A and 23B illustrate a preferred embodiment operation of the Modify Chain Link functionality of the apparatus 100 and method of the present invention, in flow diagram form. The Modify Chain Link functionality enables a user or individual to modify chain link information or privileges regarding another user or individual on a select file or object. In a preferred embodiment, only chain link information of a user or individual, whose chain link is authorized for modification by a user or individual authorized for performing such a modification (hereinafter “the modifying user or individual), or whose chain link is downlink from the modifying user or individual, may be modified or deleted, with deletion being understood to be a form of modification as that term is used herein.

With reference to FIGS. 23A and 23B, the operation of the apparatus 100 commences at step 2300 with the modifying user or individual selecting the file or object and selecting the Modify Chain Link functionality from the TACL File(s)/Folder(s) Main Page.

At step 2301, the server 10 gathers information regarding all users or individuals and chain link information related to the selected file or object. At step 2302, a Chain Link Privileges Page is provided to the modifying user or individual via the user computer 20. The Chain Link Privileges Page provides information regarding all chains that the modifying user or individual is part of, or involved in, and all other users or individuals on those chains for the file or object. In a preferred embodiment, if the modifying user or individual has company, corporate, or full, privileges, then all chains can be listed on the Chain Link Privileges Page regardless of whether or not the modifying user or individual is part of a chain or chains. At step 2302, the modifying user or individual can select to exit the Modify Chain Link Page.

At step 2303, the server 10 will determine whether or not the modifying user or individual has selected to exit the Modify Chain Link Page. If, at step 2303, it is determined that the modifying user or individual has selected to exit the Modify Chain Link Page, then the operation of the apparatus 100 will cease at step 2304. If, however, at step 2303, it is determined that the modifying user or individual has not selected to exit the Modify Chain Link Page, then the operation of the apparatus 100 will proceed to step 2305.

At step 2305, the modifying user or individual can select another user or individual (not himself of herself) on a particular chain. At step 2306, the server 10 will provide to the user computer 20 a listing of all chains that include the selected user or individual, provided that the selected user or individual is down the chain link from the modifying user or individual. The listing can be displayed on or via the user computer 20. At step 2306, the modifying user or individual can select to modify the selected user's or individual's privileges on the chain.

At step 2307, the server 10 will determine whether or not the modifying user or individual has selected to modify the selected user's or individual's privileges on the chain for the user or individual who is either found down chain from the modifying user's or individual's own link or for which user or individual the modifying user or individual is authorized to, or has a privilege(s), to perform such modification. If, at step 2307, it is determined that the modifying user or individual has not selected to modify the selected user's or individual's privileges on the chain, then the operation of the apparatus 100 will cease at step 2304. If, however, at step 2307, it is determined that the modifying user or individual has selected to modify the selected user's or individual's privileges on the chain, then the operation of the apparatus 100 will proceed to step 2308.

At step 2308, the modifying user or individual can modify a privilege or privileges of the selected user or individual on the chain. If the privilege or privileges is or are less than previously provided to the selected user or individual, then all of the other user(s) of individual(s) following the selected user or individual in the link will have his or her privilege or privileges on the chain modified or set to be equal to or less than the new privilege or privileges established for the selected user or individual. In a preferred embodiment, a deletion of the user or individual from the chain is also a form of modification as that term is used herein. At step 2308, therefore, the user or individual can also be deleted or removed from the chain. Thereafter, the operation of the apparatus 100 will proceed to step 2309.

At step 2309, the selected user's or individual's modification or deletion can result in either an appropriate reduction of privileges to the user or individual who is the subject of the modification or deletion, a bifurcation of a chain link or chain links from the modifying user's or individual's own chain link, or the creation and/or start of a new chain link or new chain links.

Thereafter, the operation of the apparatus 100 will cease at step 2304.

It is important to note that, in a preferred embodiment, chain links can be designed such that it does not matter whether or not a user or individual is listed on two different chains or is listed on a single chain more than once. If and when a privilege change is made regarding a selected user or individual, the modifying user or individual can be provided with information regarding all of the selected user's or individual's chain link occurrences and can modify a privilege or privileges regarding any one or more of these chain link occurrences. In a preferred embodiment, if there is more than one occurrence of the selected user or individual for a file of object, then all work performed by the modifying user or individual can follow any access protocol of the chain link having the most privilege or privileges for the selected user or individual. In a case where there exists a tie for access, such as when each of two occurrences have a same level of access privilege, then the oldest level of access privilege can be deemed to be the de facto level of access privilege.

In another preferred embodiment, if a selected user or individual is tagged (or added) to a chain link(s) on a file or object, and if the selected user or individual is already on some chain link somewhere else for the selected file or object, then the server 10 or the apparatus 100 can provide a warning message to the modifying user or individual that the selected user or individual already exists having a specified access privilege. If the modifying user or individual is not satisfied with the selected user's or individual's privilege and wants to increase same, then the modifying user or individual can add a second occurrence from his or her own chain link. Further, if the modifying user or individual tags another selected user or individual, then the added link associated therewith will be to that chain link next to or adjacent the modifying user or individual. In another preferred embodiment, an old link, although remaining intact, may not be used as de facto link. In another preferred embodiment, a new higher privilege can be dictated to be what controls in the Modify Chain Link functionality.

In another preferred embodiment, a modifying user or individual will be prevented from, or be prohibited from, decreasing a privilege level or an access level of a user or individual who is not managed by the modifying user or individual or if the modifying user or individual does not have sufficient privileges for doing so in the first place.

Instead, only a manager or some other user or individual located up the chain from the selected user or individual may be able to effect such a modification.

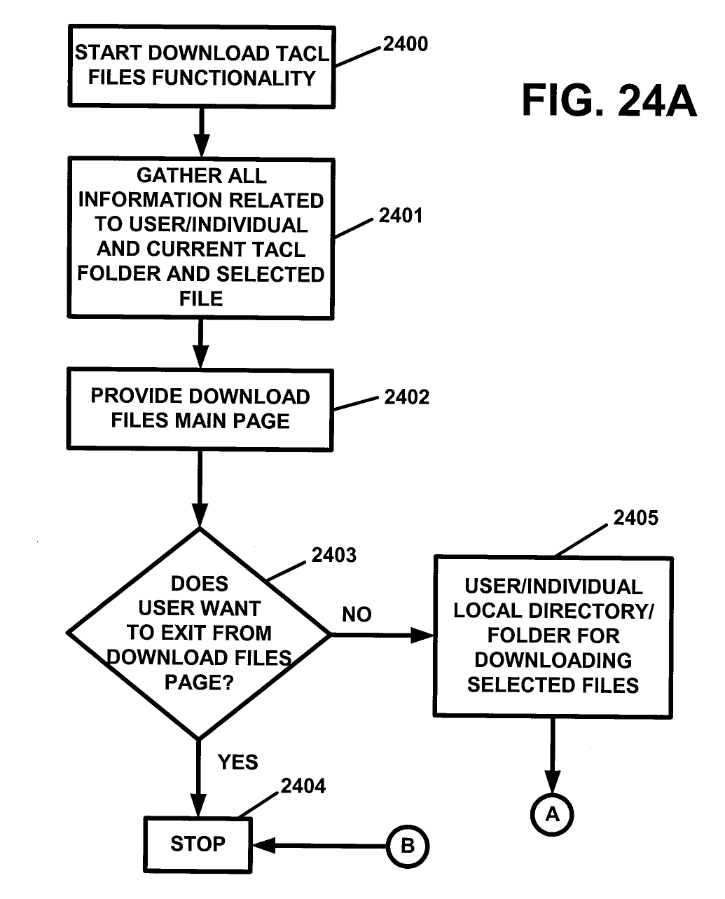

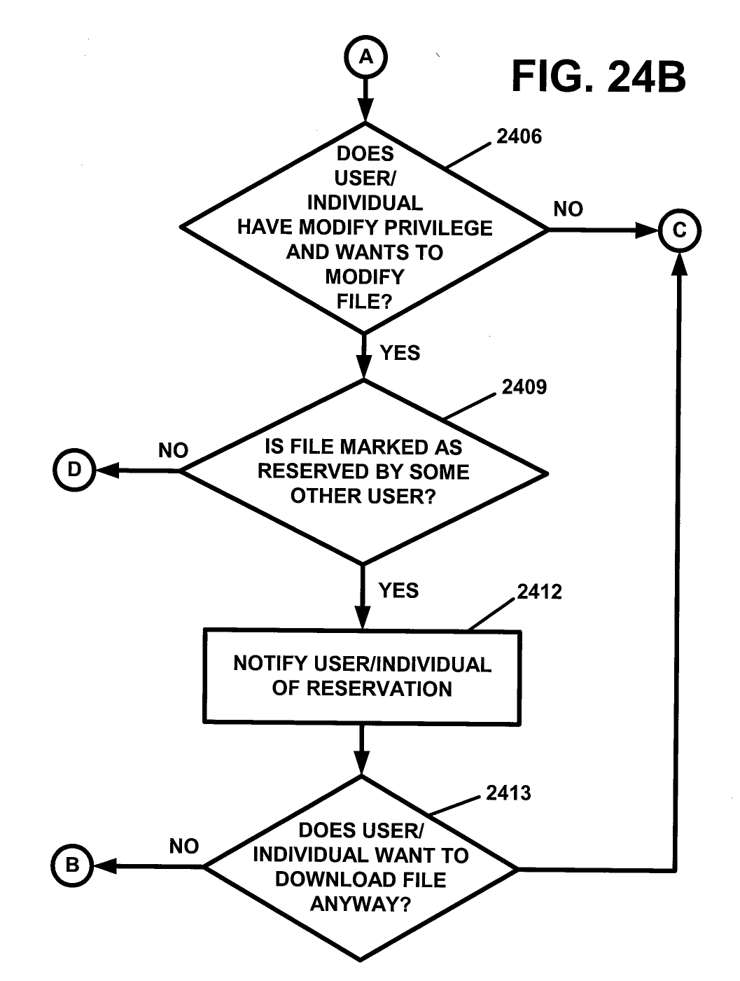

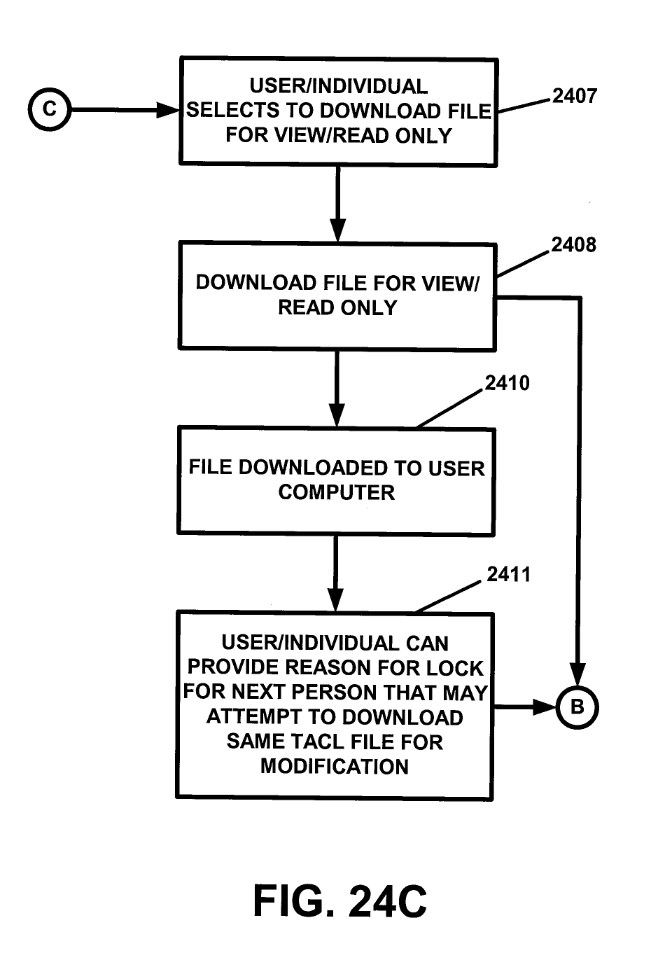

FIGS. 24A, 24B, and 24C illustrate a preferred embodiment operation of the Download TACL Files functionality of the apparatus 100 and method of the present invention, in flow diagram form. In a preferred embodiment, the Download TACL files functionality can be used by the user or individual to download a TACL file into the user's or individual's private or local directory or work area. With reference to FIGS. 24A, 24B, and 24C, the operation of the apparatus 100 commences at step 2400 with the user or individual selecting the Download TACL Files functionality from the TACL File(s)/Folder(s) Main Page and selecting the file (“the selected file”) for downloading into his of her private or local directory or work area. At step 2401, the server 10 will gather all information related to the selected file. At step 2402, the server 10 will also provide the Download TACL Files Main Page to the user's or individual's user computer 20. At step 2402, the user or individual can select to exit the Download TACL Files Main Page.

At step 2403, the server 10 will determine whether or not the user or individual has selected to exit the Download TACL Files Main Page. If, at step 2403, it is determined that the user or individual has selected to exit the Download TACL Files Main Page, then the operation of the apparatus 100 will cease at step 2404. If, however, at step 2403, it is determined that the user or individual has not selected to exit the Download TACL Files Main Page, then the operation of the apparatus 100 will proceed to step 2405. At step 2405, the user or individual can select the local directory/folder for downloading the selected TACL file(s). At step 2405, the user or individual can also select to modify the selected TACL file(s).

At step 2406, the server 10 will determine whether or not the user or individual has the necessary privilege or privileges to modify the selected TACL file(s). If, step 2406, it is determined that the user or individual does not have the necessary privilege or privileges to modify the selected TACL file(s), then the operation of the apparatus 100 will proceed to step 2407 and the user or individual will be so notified and will be prompted to select to download the selected TACL file(s) for read-only viewing via the user computer 20. At step 2408, the selected TACL file(s) will be downloaded, for read-only viewing, to the user computer 20. Thereafter, the operation of the apparatus 100 will cease at step 2404.

If, however, at step 2406, it is determined that the user or individual does have the necessary privilege or privileges to modify the selected TACL file(s), then the operation of the apparatus 100 will proceed to step 2409. At step 2409, the server 10 will determine whether or not the selected TACL file(s) is/are marked as being reserved by some other user or individual. If, at step 2409, it is determined that the selected TACL file(s) is not marked as being reserved by some other user or individual, then the operation of the apparatus 100 will proceed to step 2410. At step 2410, the server 10 will mark the selected TACL file(s) as Locked/Reserved and the selected TACL file(s) is downloaded to the user computer 20 and/or the local directory in the user computer 20.

At step 2411, the user or individual can provide a reason for locking/reserving the selected TACL file(s) which can be stored by the server 10 and which can be provided to a next user or individual who attempts to download the selected TACL file(s) for modification. Thereafter, the operation of the apparatus 100 will cease at step 2404.

If, however, at step 2409, it is determined that the selected TACL file(s) is marked as being reserved by some other user or individual, then the operation of the apparatus 100 will proceed to step 2412 and a notification of the reservation is provided to the user or individual via the user computer 20. At step 2412, the user or individual can also investigate why the selected TACL file(s) is reserved and make a request to the reserving user or individual to make the selected TACL file(s) available to the user or individual for modification or to notify the reserving user or individual of a need for modifying the selected TACL file(s). The reserving user or individual can also be requested to unlock or release the selected TACL file(s).

At step 2412, the user or individual can also select to download the selected TACL file(s) by receiving same as a read-only download. At step 2413, the server 10 will determine whether or not the user or individual wants to download the selected TACL file(s) for read-only download viewing. If, at step 2413, it is determined that the user or individual wants to download the selected TACL file(s) for read-only download viewing, then the operation of the apparatus 100 will proceed to step 2407 and the user or individual will be notified and will be prompted to select to download the selected TACL file(s) for read-only download viewing via the user computer 20. Thereafter, the operation of the apparatus 100 will proceed as described herein. If, however, at step 2413, it is determined that the user or individual does not want to download the selected TACL file(s) for read-only download viewing, then the operation of the apparatus 100 will cease at step 2404.

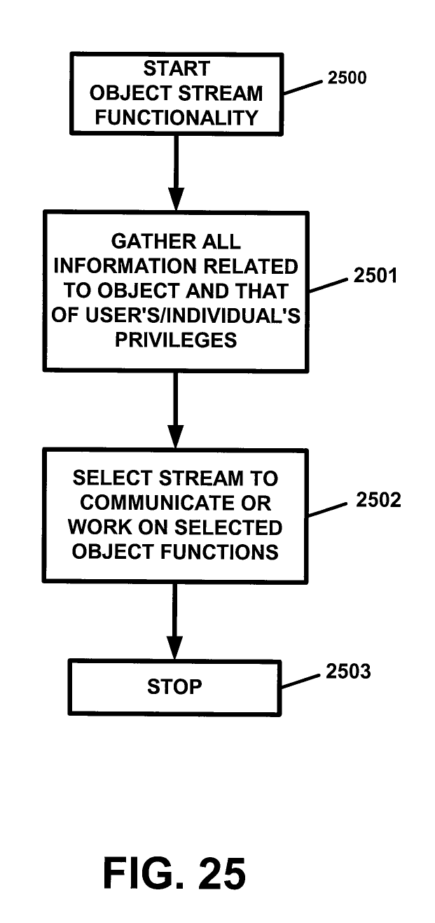

FIG. 25 illustrates a preferred embodiment operation of the Object Stream functionality of the apparatus 100 and method of the present invention, in flow diagram form. The Object Stream functionality pertains to a user or individual access flow for a file/folder/object stream that allows communication with other users or individual's regarding that file/folder/object. With reference to FIG. 25, the operation of the apparatus 100 commences at step 2500 with the user or individual selecting the Object Stream functionality from the TACL File(s)/Folder(s) Main Page. At step 2501, the server 10 gathers all information regarding the user or individual and the files/folders/objects the user or individual has privileges to or for, or access to or for. At step 2502, the user or individual can select the object stream which he or she desires to access or on which he or she desires to work. Thereafter, the operation of the apparatus 100 will cease at step 2503.

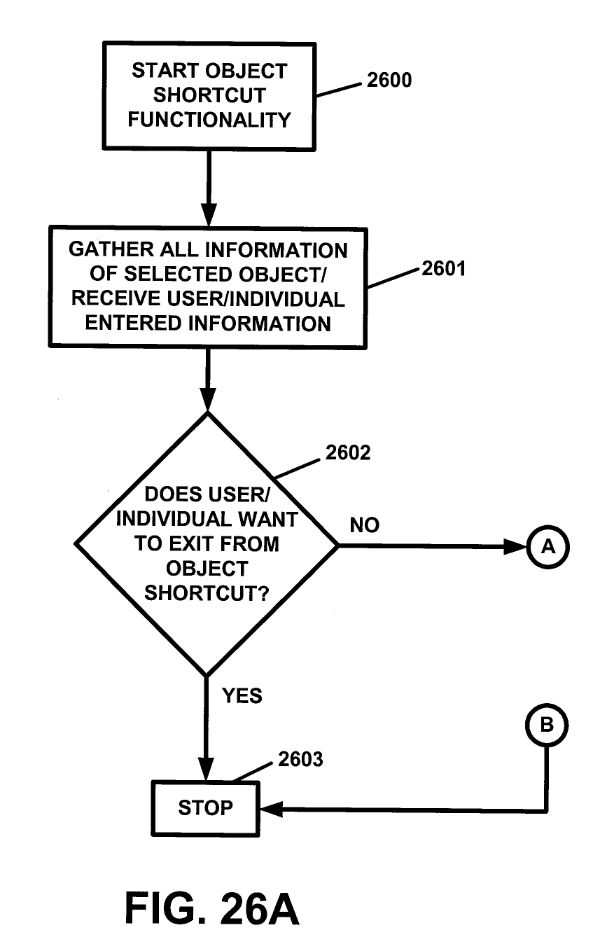

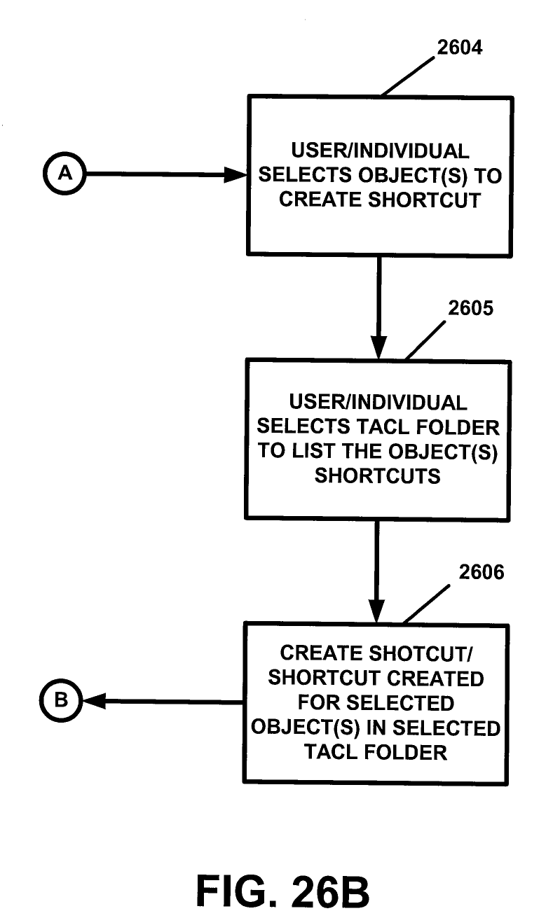

FIGS. 26A and 26B illustrate a preferred embodiment operation of the Object Shortcut functionality of the apparatus 100 and method of the present invention, in flow diagram form. The Object Shortcut functionality allows a user or individual to create a shortcut to a TACL folder. With reference to FIGS. 26A and 26B, the operation of the apparatus 100 commences at step 2600 upon the user selecting the Object Shortcut functionality from the TACL File(s)/Folder(s) Main Page and selecting the file or object for which the user or individual wants to utilize the Object Shortcut functionality. At step 2601, the server 10 gathers all information related to the selected file or object. At step 2601, the user or individual can also select to exit the Object Shortcut functionality. At step 2602, the server 10 will determine whether or not the user or individual has selected to exit the Object Shortcut functionality. If, at step 2602, it is determined that the user or individual has selected to exit the Object Shortcut functionality, then the operation of the apparatus 100 will cease at step 2603.

If, however, at step 2602, it is determined that the user or individual has not selected to exit the Object Shortcut functionality, then the operation of the apparatus 100 will proceed to step 2604. At step 2604, the user or individual can select the file(s) or object(s) for which he or she wants to create a shortcut to a TACL folder. At step 2605, the user or individual can select the TACL folder into which the shortcut reference will be put for the selected file(s) or object(s). At step 2606, the shortcut is created in the TACL folder for the selected file(s) or object(s). Thereafter, the operation of the apparatus 100 will cease at step 2603.

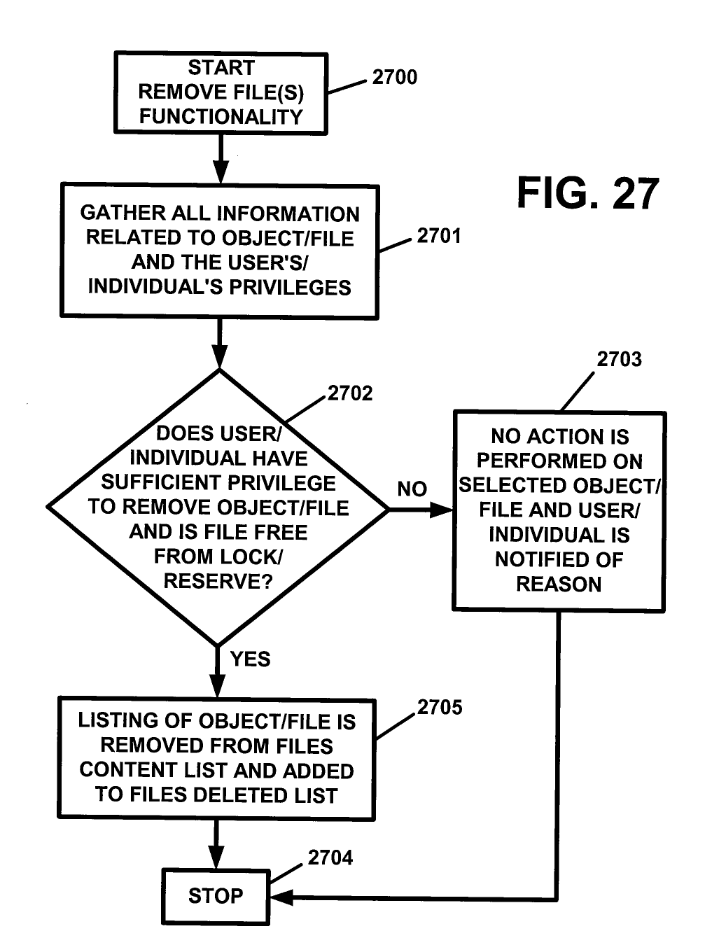

FIG. 27 illustrates a preferred embodiment operation of the Remove File(s) functionality of the apparatus 100 and method of the present invention, in flow diagram form. The Remove File(s) functionality allows a user or individual to remove a file(s) from a TACL folder. With reference to FIG. 27, the operation of the apparatus 100 commences at step 2700 upon the user or individual selecting a file(s) for removal from a TACL folder and selecting to work with the Remove File(s) functionality from the TACL File(s)/Folder(s) Main Page. At step 2701, the server 10 will gather all information related to the file(s) and to the privileges of the user or individual seeking to work with and/or to remove same.

At step 2702, the server 10 will determine whether or not the user or individual has sufficient privilege(s) to remove the file(s) and/or the server 10 will determine whether or not the file(s) is locked. If, at step 2702, it is determined that either the user or individual does not have sufficient privilege(s) to remove the file(s), or if it is determined that the file(s) is locked, then the operation of the apparatus 100 will proceed to step 2703, nothing is done with respect to the file(s), and the user or individual is notified of the reason, such as, for example, that the user or individual lacks sufficient privilege(s) to remove the file(s) or that the file is locked and, therefore, cannot be removed. Thereafter, the operation of the apparatus 100 will cease at step 2704.

If, however, at step 2702, it is determined that the user or individual does have sufficient privilege(s) to remove the file(s) and that the file(s) is not locked, then the operation of the apparatus 100 will proceed to step 2705. At step 2705, the file(s) is removed from the TACL folder. In a preferred embodiment, this file removal is effectuated by the listing of the file(s) being removed from the file content list for the TACL folder and by the listing of the file being added to a files deleted list or a deleted files list. In this regard, in a preferred embodiment, the removed or deleted file is not entirely deleted or expunged from the apparatus 100, but rather, it is deleted from the file content list and placed on the files deleted list or the deleted files list, for the TACL folder. In this manner, the removed or deleted file(s) is available to be re-activated, or be brought back into, use at any time.

If it is be desired to undelete the deleted file(s), the file(s) can be accessed from the files deleted list or the deleted files list and can be transferred back into the TACL folder by adding the file(s) to the file content list for the TACL folder or for another TACL folder. The user or individual seeking to undelete a file(s), in a preferred embodiment, can have to be provided with the privilege(s) needed to undelete the file(s) and the user or individual must be included in the chain link associated with the file(s). After the file(s) is removed or deleted at step 2705, the operation of the apparatus 100 will cease at step 2704.

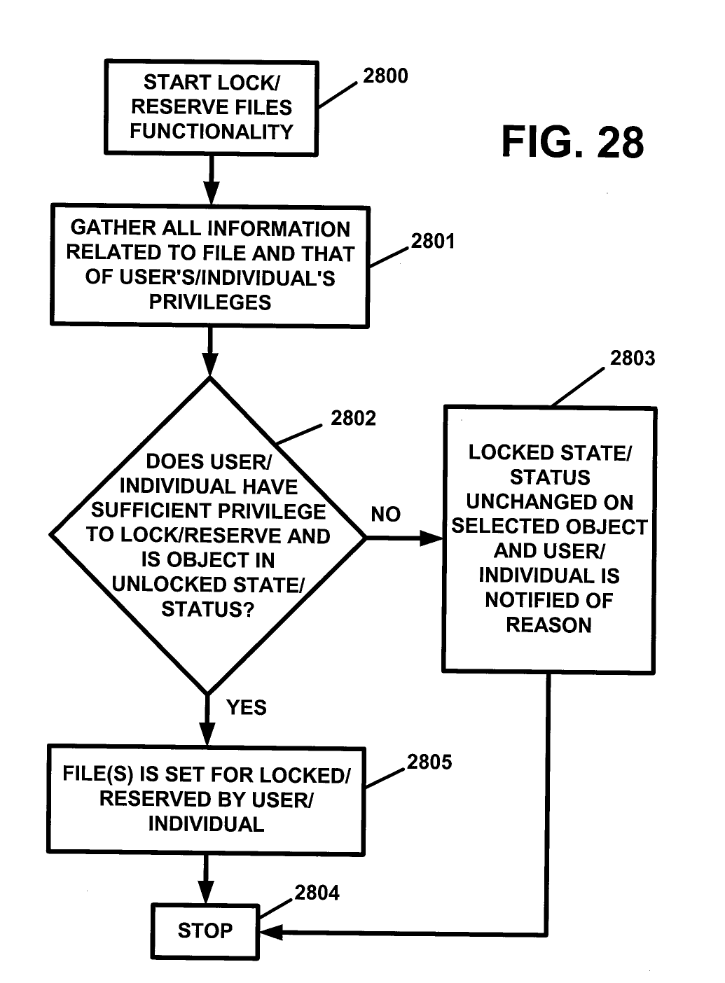

FIG. 28 illustrates a preferred embodiment operation of the Lock/Reserve Files functionality of the apparatus 100 and method of the present invention, in flow diagram form. The Lock/Reserve Files functionality allows a user or individual to lock or reserve a file(s) from being changed or modified by any other user or individual. A user or individual can also utilize the Lock/Reserve Files functionality when downloading or uploading a file or the user or individual can simply decide to lock-up the file. With reference to FIG. 28, the operation of the apparatus 100 commences at step 2800 upon the user or individual selecting a file for lock or reserving and selecting to work with the Lock/Reserve Files functionality from the TACL File(s)/Folder(s) Main Page. At step 2801, the server 10 will gather all information related to the file and to the privileges of the user or individual seeking to work with same. At step 2802, the server 10 will determine whether or not the file is in an unlocked state and, if so, whether or not the user or individual has the privilege(s) or the sufficient privilege(s) to lock or reserve the file. If, at step 2802, it is determined that the file is not in an unlocked state, so that the file is determined to be in a locked state, or that the user or individual does not have the privilege(s) or the sufficient privilege(s) to lock or reserve the file, then the operation of the apparatus 100 will proceed to step 2803 and either the locked state of file will remain unchanged and the user or individual will be notified via the user computer 20 that the file is in a locked state, or the user or individual will be notified via the user computer 20 that he or she lacks the privilege or privilege(s) to lock or reserve the file. Thereafter, the operation of the apparatus 100 will cease at step 2804.

If, however, at step 2802, it is determined that the file is in an unlocked state and that the user or individual has the privilege(s) or the sufficient privilege(s) to lock or reserve the file, then the operation of the apparatus 100 will proceed to step 2805 and the user or individual can set the file for Lock or Reserve so as to prevent access by others to the file. Thereafter, the operation of the apparatus 100 will cease at step 2804.

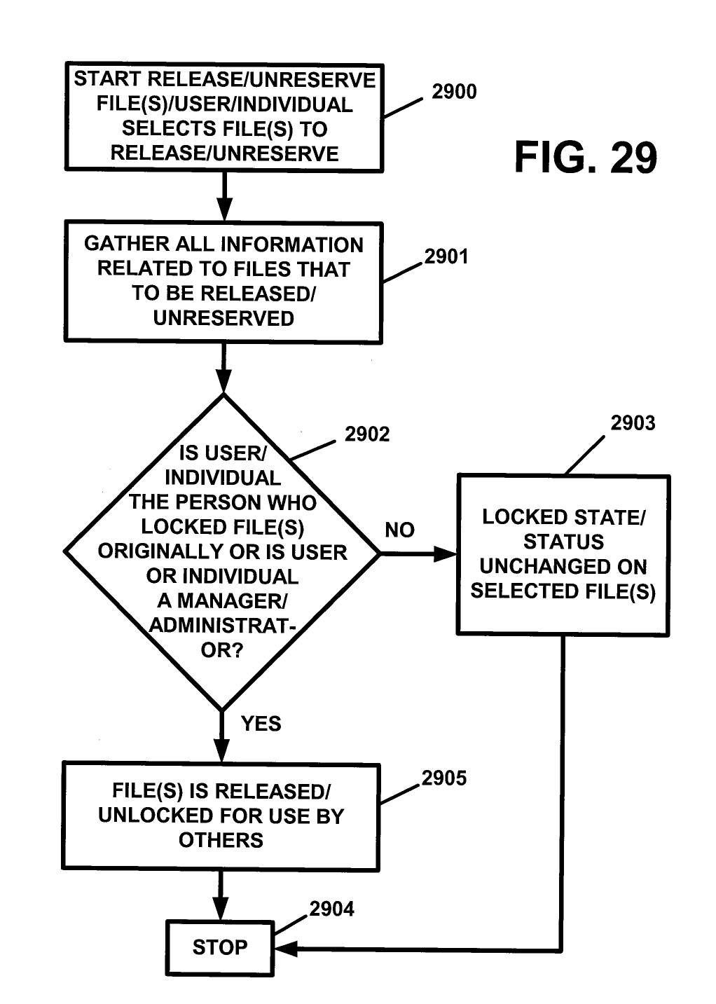

FIG. 29 illustrates a preferred embodiment operation of the Release/Unreserve Files functionality of the apparatus 100 and method of the present invention, in flow diagram form. The Release/Unreserve Files functionality allows a user or individual to release or unreserve a file(s) from being locked or reserved, thereby allowing a user or individual with privileges to access the file(s) to be able to do so. With reference to FIG. 29, the operation of the apparatus 100 commences at step 2900 upon the user or individual selecting a file for release or unreserving and selecting to work with the Release/Unreserve Files functionality from the TACL File(s)/Folder(s) Main Page.

At step 2901, the server 10 will gather all information related to the file and to the privileges of the user or individual seeking to work with same. At step 2902, the server 10 will determine whether or not the user or individual is the person who locked or reserved the file in the first instance, the manager of the user or individual, or an administrator. If, at step 2902, it is determined that the user or individual is not the person who locked or reserved the file in the first instance, is not the manager of the user or individual, or is not an administrator, then the operation of the apparatus 100 will proceed to step 2903 and the file will remain locked with its locked status remaining unchanged. Thereafter, the operation of the apparatus 100 will cease at step 2904.

If, however, at step 2903, it is determined that the user or individual is the person who locked or reserved the file in the first instance, is the manager of the user or individual, or is an administrator, then the operation of the apparatus 100 will proceed to step 2905 and the user or individual can unlock, release, or unreserved, the file, thereby making the file available for others to access or use. Thereafter, the operation of the apparatus 100 will cease at step 2904.

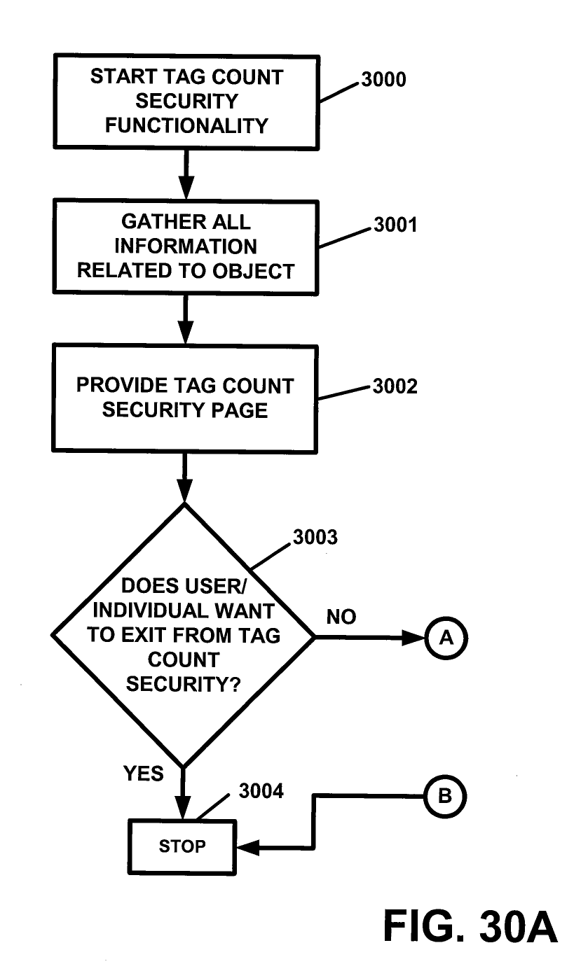

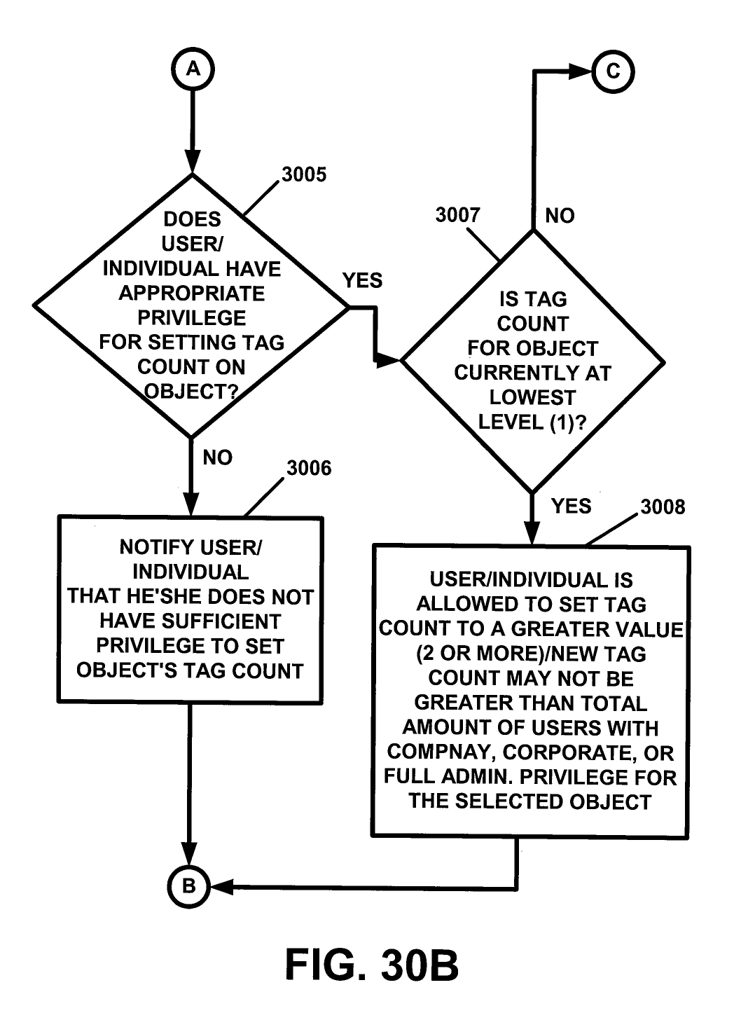

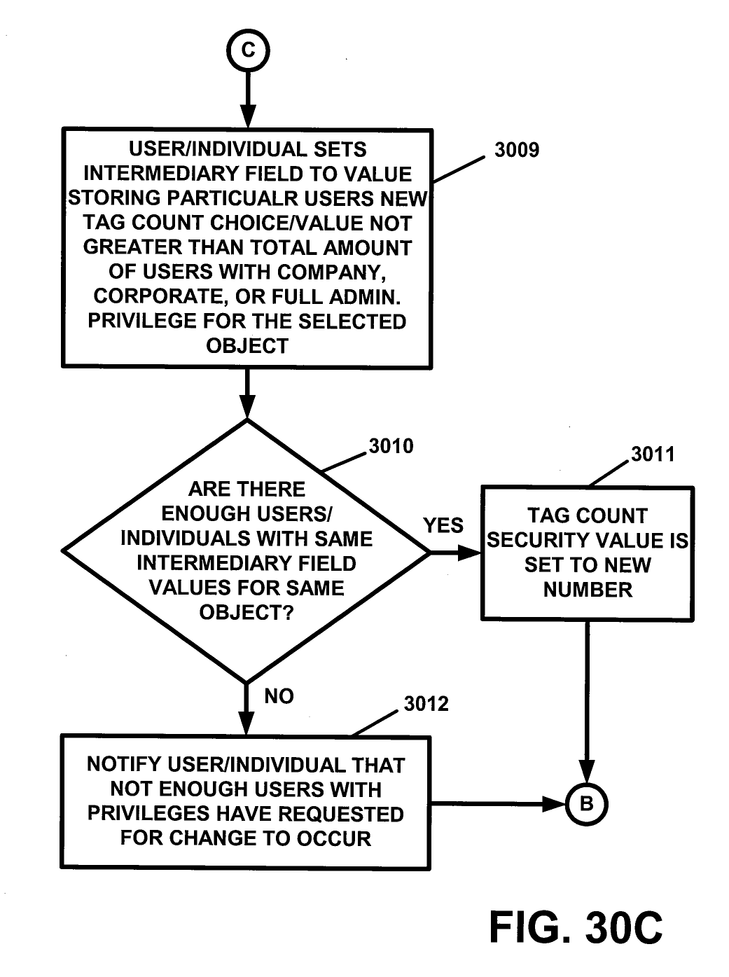

FIGS. 30A, 30B, and 30C illustrate a preferred embodiment operation of the Tag Count Security functionality of the apparatus 100 and method of the present invention, in flow diagram form. In a preferred embodiment, the Tag Count Security functionality allows a user or individual to establish or set up a greater Tag Count Security on a file, folder, or object, so as to provide more security in providing or granting access, to the file, folder, or object, by other users or individuals. A tag count quantity, in a preferred embodiment, can signify or represent the amount of appropriately privileged users or individuals, including company, corporate, or administrative, users or individuals which would be necessary or desired to allow, or to give or grant permission to another user or individual to have or gain access to the file, folder, or object.

With reference to FIGS. 30A, 30B, and 30C, the operation of the apparatus 100 commences at step 3000 with the user or individual selecting the Tag Count Security functionality from the TACL File(s)/Folder(s) Main Page and the file, folder, or object, the user or individual selects (“the selected file, folder, or object”) for performing a Tag Count Security operation. At step 3001, the server 10 will gather all information related to the selected file, folder, or object. At step 3002, the server 10 will provide the Tag Count Security Page to the user's or individual's user computer 20. At step 3002, the user or individual can select to exit the Tag Count Security Page.

At step 3003, the server 10 will determine whether or not the user or individual has selected to exit the Tag Count Security Page. If, at step 3003, it is determined that the user or individual has selected to exit the Tag Count Security Page, then the operation of the apparatus 100 will cease at step 3004. If, however, at step 3003, it is determined that the user or individual has not selected to exit the Tag Count Security Page, then the operation of the apparatus 100 will proceed to step 3005. At step 3005, the server 10 will determine whether or not the user or individual has the appropriate privilege or privileges to set a tag count on or regarding the selected file, folder, or object. If, at step 3005, it is determined that the user or individual does not have the appropriate privilege or privileges to set a tag count on or regarding the selected file, folder, or object, then the operation of the apparatus 100 will proceed to step 3006 and the server 10 will provide a message to the user computer 20 notifying the user or individual that he or she does not have the appropriate privilege or privileges to set a tag count on or regarding the selected file, folder, or object. Thereafter, the operation of the apparatus 100 will cease at step 3004.

If, however, at step 3005, it is determined that the user or individual does have the appropriate privilege or privileges to set a tag count on or regarding the selected file, folder, or object, then the operation of the apparatus 100 will proceed to step 3007 and the server 10 will determine whether or not the tag count for the selected file, folder, or object, is currently set at the lowest level, which, in a preferred embodiment is a Tag Count of “1”. If, at step 3007, it is determined that the tag count for the selected file, folder, or object, is currently set at the lowest level, taken to be “1” in the preferred embodiment, then the operation of the apparatus 100 will proceed to step 3008 and the user or individual is allowed to, and can, set the Tag Count for the selected file, folder, or object, to a greater value which, in a preferred embodiment, can be a “2” or a higher number. In a preferred embodiment, the new Tag Count should be selected so that it is not greater than the total amount or total number of users of individuals with company, corporate, or full administrative, privileges for the selected file, folder, or object. Thereafter, the operation of the apparatus 100 will cease at step 3004.

If, however, at step 3007, it is determined that the Tag Count for the selected file, folder, or object, is not currently set at the lowest level, taken to be “1” in the preferred embodiment, then the operation of the apparatus 100 will proceed to step 3009. At step 3009, the user or individual can set an intermediary field to a new Tag Count value. In a preferred embodiment, the new Tag Count value should not be greater than the total amount or total number of users or individuals having company, corporate, or full administrative, privileges for the selected file, folder, or object. At step 3010, the server 10 will determine whether or not there are enough users or individuals having the same intermediary field value for the selected file, folder, or object. If, at step 3010, it is determined that there are enough users or individuals with the same intermediary field value for the selected file, folder, or object, then the operation of the apparatus 100 will proceed to step 3011 and the Tag Count Security value for the selected file, folder, or object, will be set to the value which was set by the user or individual at step 3008. Thereafter, the operation of the apparatus 100 will cease at step 3004.

If, however, at step 3010, it is determined that there are not enough users or individuals with the same intermediary field value for the selected file, folder, or object, then the operation of the apparatus 100 will proceed to step 3012 and the user or individual will be notified, via a message provided to his or her user computer 20, that there are not enough users or individuals with sufficient privileges who have requested that a change be made to the Tag Count value. Thereafter, the operation of the apparatus 100 will cease at step 3004.

In a preferred embodiment, the Tag Count for a selected file, folder, or object, can be for reading and/or for modifying the selected file, folder, or object. There can also be a Tag Count for reading, and a separate Tag Count for modifying, the selected file, folder, or object, as there may be a need or desire to approve a user's or individual's ability to modify the selected file, folder, or object, but not necessarily a need or desire for the user or individual to read the selected file, folder, or object. In such an instance, if the reading Tag Count is higher than the modifying Tag Count, then the modifying Tag Count will be set to the higher value of the two.

In another preferred embodiment, the user or individual can utilize the apparatus 100 and method of the present invention to a add a link for or corresponding to another user or individual. In this preferred embodiment, the user or individual will access the server 10 via the user computer 20 and transmit information to the server 10 for adding a link for or corresponding to the other user or individual. The server 10 will receive, process, and store, the information for adding the link for the other user individual. The server 10 will then add the link for the user or individual, and the added link will allow the other user or individual to have access to or to access a file, folder, or object.

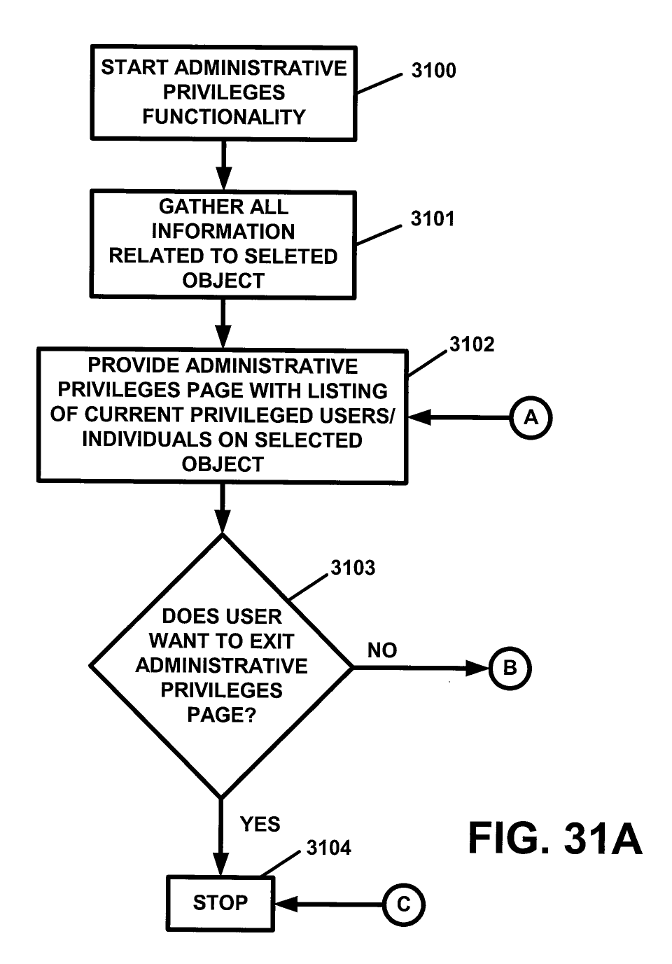

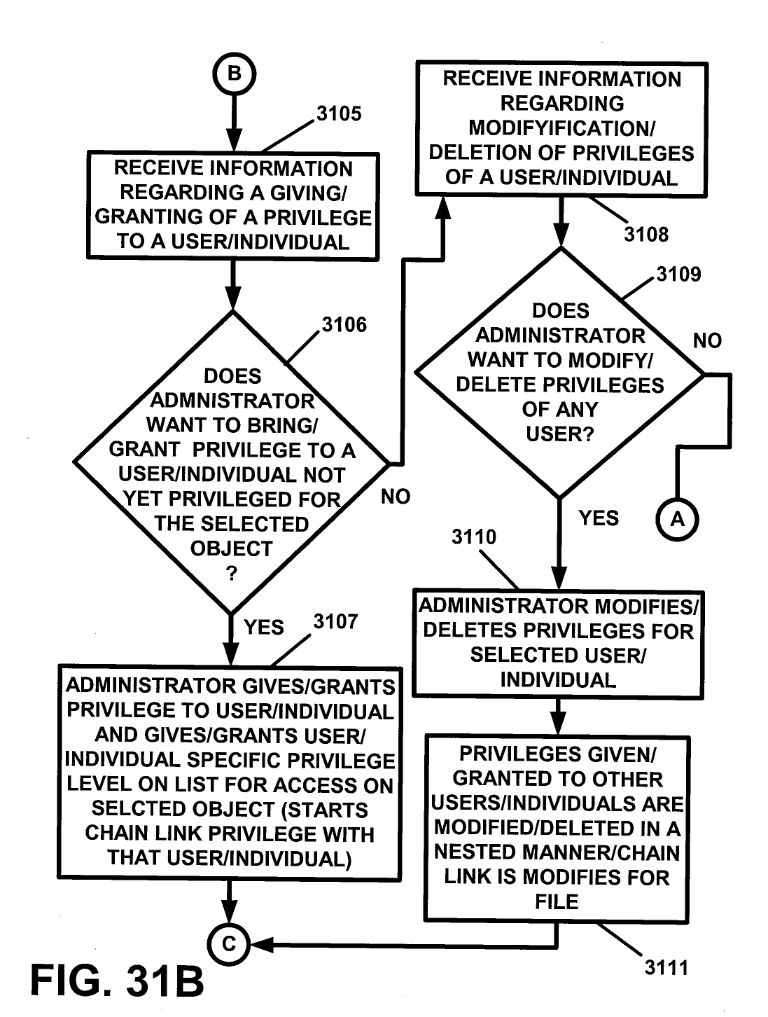

FIGS. 31A and 31B illustrate a preferred embodiment operation of the Administrative TACL Privileges functionality of the apparatus 100 and method of the present invention, in flow diagram form. In a preferred embodiment, the Administrative TACL Privileges functionality can be used by a user or individual to give or grant, or to modify, privileges of or for a user(s) or individual(s) for a selected file, folder, or object. In a preferred embodiment, the user or individual utilizing the Administrative TACL Privileges functionality can be an administrator who is authorized to give or grant, or to modify, any privilege to or of any user or individual regarding a selected file, older, or object.

With reference to FIGS. 31A and 31B, the operation of the apparatus 100 commences at step 3100 upon the user or individual, who is preferably an administrator in the preferred embodiment, selecting to work with the Administrative TACL Privileges functionality from the TACL File(s)/Folder(s) Main Page and selecting the file, folder, or object, which the administrator user or individual selects (“the selected file, folder, or object”) to administer a privilege change.

At step 3101, the server 10 will gather all information related to the selected file, folder, or object. At step 3102, the server 10 will also provide the Administrative TACL Privileges Page to the administrator user's or individual's user computer 20. The Administrative TACL Privileges Page can provide a listing of the current privileged users or individuals of the selected file, folder, or object. At step 3102, the administrator user or individual can select to exit the Administrative TACL Privileges Page.

At step 3103, the server 10 will determine whether or not the administrator user or individual has selected to exit the Administrative TACL Privileges Page. If, at step 3103, it is determined that the administrator user or individual has selected to exit the Administrative TACL Privileges Page, then the operation of the apparatus 100 will cease at step 3104. If, however, at step 3103, it is determined that the administrator user or individual has not selected to exit the Administrative TACL Privileges Page, then the operation of the apparatus 100 will proceed to step 3105. At step 3105, the server 10 will provide a message to the administrator user or individual which will seek to ascertain whether the administrator user or individual desires to give or grant a privilege to another user or individual, not yet so privileged, for the selected file, folder, or object. At step 3106, the server 10 will determine whether or not the administrator user or individual has indicated that he or she desires to give or grant a privilege to another user or individual, not yet so privileged, for the selected file, folder, or object.

If, at step 3106, it is determined that the administrator user or individual has indicated that he or she desires to give or grant a privilege to another user or individual, not yet so privileged, for the selected file, folder, or object, then the operation of the apparatus 100 will proceed to step 3107 and the administrator user or individual can give, grant, or provide, a privilege or privileges to the user or individual by adding the user's or individual's username to the list of privileged users or individuals for the selected file, folder, or object, and by specifying and adding information regarding the privilege level for the added user or individual on the list of privileged users or individuals for the selected file, folder, or object. This addition of the added user or individual gives rise to, or starts or originates, a chain link privilege for the added user or individual.

In a preferred embodiment, any time an administrator user or individual adds a user or individual to the list of usernames privileged for a selected file, folder, or object, the addition gives rise to or starts or originates a chain link privilege, with that user or individual being the first user or individual on the chain link. It is important to note that, in a preferred embodiment, a selected file, folder, or object, can have many chain links, as an administrator user or individual can give or grant privileges to more than one user or individual for that selected file, folder, or object. Thereafter, the operation of the apparatus 100 will cease at step 3104.

If, at step 3106, it is determined that the administrator user or individual does not want to give or grant a privilege to another user or individual, not yet so privileged, for the selected file, folder, or object, then the operation of the apparatus 100 will proceed to step 3108 and the administrator user or individual can select to modify, remove, or delete, a user's or individual's privilege or privileges regarding the selected file, folder, or object.

In a preferred embodiment, a modification, removal, or deletion, of a user's or individual's privilege or privileges regarding a selected file, folder, or object, can effect some or all user's or individuals down the chain link from the user or individual, or the administrator user or individual can sever the chain link and start another chain with a next user or individual on the chain being a first person on the chain without affecting the next user's or individual's privilege or privileges. It is also possible, in a preferred embodiment, that there may be more that one such next user or individual as the user or individual whose privilege was modified, removed, or deleted, may have given or provided privileges to more than one other user or individual, thereby bifurcating the chain, in which case the administrator user or individual would be starting a separate chain for each bifurcation.

At step 3109, the server 10 will determine whether or not the administrator user or individual selected to modify, remove, or delete, a user's or individual's privilege or privileges regarding the selected file, folder, or object. If, at step 3109, it is determined that the administrator user or individual did not select to modify, remove, or delete, a user's or individual's privilege or privileges regarding the selected file, folder, or object, then the operation of the apparatus 100 will proceed to step 3102 and the operation of the apparatus 100 will continue in the manner described herein.

If, however, at step 3109, it is determined that the administrator user or individual selected to modify, remove, or delete, a user's or individual's privilege or privileges regarding the selected file, folder, or object, then the operation of the apparatus 100 will proceed to step 3110 and the administrator user or individual can modify, remove, or delete, any privilege or privileges of the user or individual with regard to the selected file, folder, or object. Thereafter, at step 3111, the server 10 will modify, remove, or delete, any privilege or privileges given or granted by the user or individual to any other users or individuals in a nested manner, or otherwise, and either the chain link will be modified for the selected file, folder, or object, or the server 10 will create new chains keeping users or individuals down the chain intact so that the resulting privileges and chains are consistent with the modifications, removals, or deletions, made by the authorized user or individual. Thereafter, the operation of the apparatus 100 will cease at step 3104.

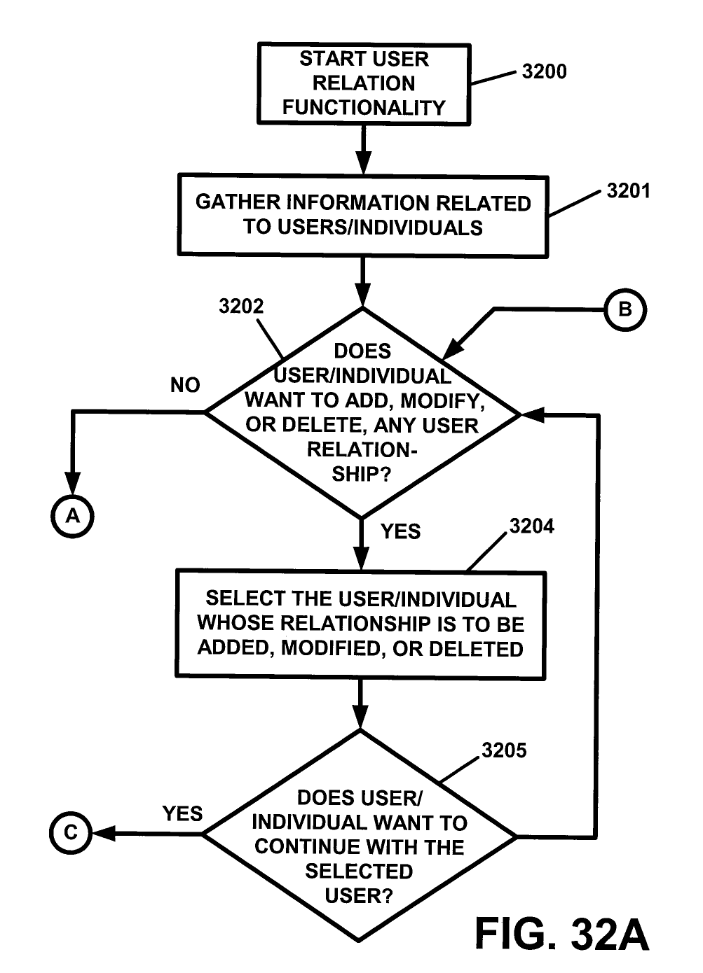

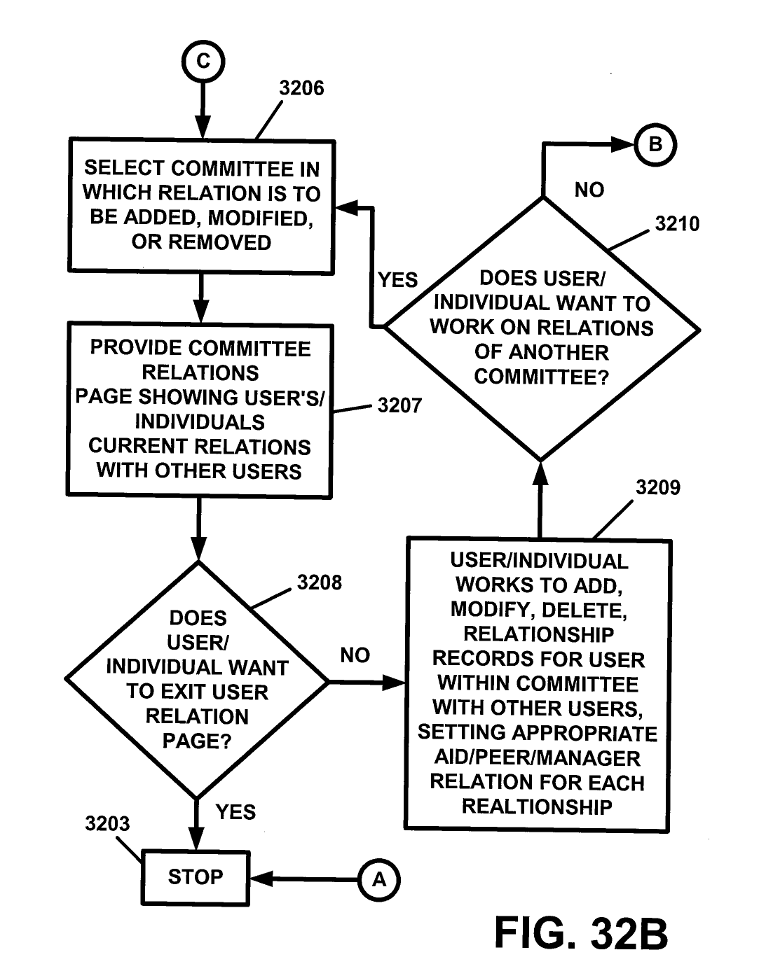

FIGS. 32A and 32B illustrate a preferred embodiment operation of the User Relation Module functionality of the apparatus 100 and method of the present invention, in flow diagram form. In a preferred embodiment, the User Relation Module functionality can be used by an administrator or other authorized individual in order to configure or define a user's or individual's relation(s) with another user(s) or individual(s). With reference to FIGS. 32A and 32B, the operation of the apparatus 100 commences at step 3200 upon the user or individual selecting to work with the User Relation Module functionality from the TACL File(s)/Folder(s) Main Page. At step 3201, the administrator or authorized individual will be provided with the User Relation Page on his or her user computer 20. At step 3201, the server 10 will gather all information regarding any users or individuals who are authorized to utilize the apparatus 100. At step 3201, the administrator or other authorized individual can also select to add, modify, or delete, any user relationship or individual relationship.

At step 3202, the server 10 will determine whether or not the administrator or authorized individual has selected to add, modify, or delete, any user relationship or individual relationship. If, at step 3202, it is determined that the administrator or authorized individual has not selected to add, modify, or delete any user relationship or individual relationship, then the operation of the apparatus 100 will cease at step 3203. If, however, at step 3202, it is determined that the administrator or authorized individual has selected to add, modify, or delete, any user relationship or individual relationship, then the operation of the apparatus 100 will proceed to step 3204.

At step 3204, the administrator or authorized individual can select the user or individual relationship which is to be added, modified, or deleted. At step 3204, the administrator or authorized individual can also select the user or individual and can be provided with information regarding that user's or individual's relationship(s) in the committee.

At step 3205, the server 10 will determine whether or not the administrator or authorized individual has selected to exit the user's or individual's relationship information. If, at step 3205, it is determined that the administrator or authorized individual has selected to exit the user's or individual's relationship information, then the operation of the apparatus 100 will proceed to step 3202. If, however, at step 3205, it is determined that the administrator or authorized individual has not selected to exit the user's or individual's relationship information, then the operation of the apparatus 100 will proceed to step 3206.

At step 3206, the administrator or authorized individual can select another committee in or with which the user's or individual's relations or relationships are to be added, modified, or deleted. At step 3206, the administrator or authorized individual can also select a different user or individual for whom he or she wants to add, modify, or delete, a relationship or relationships. At step 3207, the administrator or authorized individual can be provided with the Committee Relations Page for that committee which provides information showing the users or individuals on that committee and, for each user or individual, that user's or individual's relations with other users of individuals in that committee. Then, at step 3207, the administrator or authorized individual can select the user or individual and can be provided with information regarding that user's or individual's relationships in that committee.

The administrator or authorized individual, after viewing the user's or individual's relationships, can then add, modify, or delete, any of the user's or individual's relationships in that committee. Thereafter, the administrator or authorized individual can either select to exit the User Relation Page or to add, modify, or delete, the user's or individual's relationship information in yet another committee.

At step 3208, the server 10 will determine whether or not the administrator or authorized individual has selected to exit the User Relation Page. If, at step 3208, it is determined that the administrator or authorized individual has selected to exit the User Relation Page, then the operation of the apparatus 100 will cease at step 3203. If, at step 3208, it is determined that the administrator or authorized individual has not selected to exit the User Relation Page, then the operation of the apparatus 100 will proceed to step 3209 and the administrator or authorized individual can continue to add, modify, or delete, relationships for the user or individual in the committee, add, modify, or delete, the relationships of any other user(s) or individual(s) within the committee, or set or define any aid, peer, or manager, relationships for any user(s) or individual(s) in the committee. At step 3209, the administrator or authorized individual can also select to perform tasks for adding, modifying, or deleting, any relationships for any other committee.

At step 3210, the server 10 will determine whether or not the administrator or authorized individual has selected to perform tasks for adding, modifying, or deleting, any relationships for any other committee for that user or individual. If, at step 3210, it is determined that the administrator or authorized individual has selected to perform tasks for adding, modifying, or deleting, any relationships for any other committee, then the operation of the apparatus 100 will proceed to step 3206. If, however, at step 3210, it is determined that the administrator or authorized individual has not selected to perform tasks for adding, modifying, or deleting, any relationships for any other committee, then the operation of the apparatus 100 will proceed to step 3202.

It is important to note that any additions, modification, or deletions, made with regard to any user or individual will also effect, and the apparatus 100 can be programmed to correspondingly change and store, any relations of any user(s) or individual(s) who have a relationship with that user or individual. For example, in a hypothetical situation with two individuals, namely Mary and John, if Mary was the selected user or individual and John was made to be Mary's aide then a corresponding change to John's relations would be made indicating that Mary is John's manager.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A computer-implemented method, comprising:
transmitting a message to a first user computer or a first user communication device;
receiving a reply to the message, wherein the reply contains information for creating a task, a project, a project task, or a message stream, in response to subject matter contained in the message;
determining, using a processing device or a computer, whether the reply to the message contains a request to create a task, a project, or a project task, in response to the subject matter contained in the message;
creating a communication record for the message and the reply to the message if the reply to the message does not contain a request to create a task, a project, or a project task, in response to the subject matter contained in the message, or creating a communication record for a task, a project, or a project task, if the reply to the message contains a request to create a task, a project, or a project task;
storing the communication record in a database or a memory device;
processing a request transmitted from the first user computer or the first user communication device or processing a request transmitted from a second user computer or a second user communication device, wherein the request contains a request by a user to access the communication record or to access information contained in the communication record, or a request by the user to perform an operation or function on or regarding information contained in the communication record; and
if the user is an authorized user, providing the user with access to the communication record or with access to information contained in the communication record, or allowing the user to perform the operation or function on or regarding the information contained in the communication record.

2. The computer-implemented method of claim 1, further comprising:
transmitting information regarding an instruction or an action item which the user must follow or address, wherein the information regarding an instruction or an action item which the user must follow or address is transmitted to the first computer or first communication device.

3. The computer-implemented method of claim 1, further comprising:
providing a homepage or a menu page to the user via the first computer or first communication device or to the second computer or the second communication device, wherein the homepage or the menu page provides information or a link to information for allowing the user to perform the operation or function on or regarding the information contained in the communication record.

4. The computer-implemented method of claim 1, further comprising:
storing information regarding an authorized access level assigned to the user or to a second user, wherein the authorized access level corresponds to an ability of the user or the second user to access, read, read only, read and/or modify, or act regarding, the communication record or information contained in the communication record.

5. The computer-implemented method of claim 1, further comprising:
storing information for controlling an access level or a privilege assigned to or granted to the user or assigned to or granted to a second user, wherein the authorized access level corresponds to an ability of the user or the second user to access, read, read only, read and/or modify, store information regarding a control level provided to a third user for controlling an access level, a privilege, or a control level of a fourth user, or act or perform an operation or function regarding the communication record or information contained in the communication record.

6. The computer-implemented method of claim 5, wherein the communication record contains a file, a folder, an object, a chain link, or information regarding a chain link.

7. The computer-implemented method of claim 5, further comprising:
processing and storing information for creating the communication record or for creating a second communication record.

8. The computer-implemented method of claim 5, further comprising:
processing and storing information for deleting the communication record or for deleting a second communication record.

9. The computer-implemented method of claim 5, further comprising:
processing information for allowing the user to navigate from the communication record or from a file, folder, or object, contained in the communication record to a second communication record or to a second file, a second folder, or a second object, contained in the second communication record.

10. The computer-implemented method of claim 5, further comprising:
uploading or storing a second file in the communication record.

11. The computer-implemented method of claim 5, further comprising:
storing information regarding a privilege to be set, established, granted, changed, modified, or removed, for or regarding the user or for or regarding the second user.

12. The computer-implemented method of claim 5, further comprising:
storing information for modifying or deleting a privilege or privileges of the user, the second user, or a third user, in or associated with a chain of users for the communication record or a second communication record or a file, folder, or object, in or associated with the communication record or in or associated with the second communication record.

13. The computer-implemented method of claim 5, further comprising:
transmitting information contained in the communication record or contained in a second communication record to the first user computer or first user communication device or to the second user computer or the second user communication device.

14. The computer-implemented method of claim 5, further comprising:
processing information for allowing the first user to communicate with the second user regarding information contained in the communication record or regarding information contained in a second communication record.

15. The computer-implemented method of claim 5, further comprising:
processing information for creating a shortcut to information contained in the communication record or to information contained in a second communication record.

16. The computer-implemented method of claim 5, further comprising:
deleting or removing a file from the communication record or from a second communication record.

17. The computer-implemented method of claim 5, further comprising:
re-activating a previously deleted or a previously removed file, wherein the previously deleted or the previously removed file is placed into the communication record or placed into a second communication record.

18. The computer-implemented method of claim 5, further comprising:
processing information for locking or reserving a file in the communication record or for locking or reserving a file in a second communication record from being changed or modified by the user or the second user.

19. The computer-implemented method of claim 5, further comprising:
processing information for unlocking or unreserving a file in the communication record or for unlocking or unreserving a file in a second communication record.

20. The computer-implemented method of claim 5, further comprising:
processing and storing information or allowing the user or the second user to grant a third user access to a file in the communication record or access to a file in the second communication record.

21. The computer-implemented method of claim 5, further comprising:
processing and storing information for allowing an administrator to grant, modify, or delete, a privilege of the user, the second user, or a third user, regarding a file, folder, or object, in the communication record or regarding a file, folder, or object, in the second communication record.

22. The computer-implemented method of claim 5, further comprising:
processing and storing information for changing a relationship or relations between the user or the second user and a third user.
